(19) United States
(12) Patent Application Publication
(10) Pub. No.: US 2021/0273215 A1
(43) Pub. Date: Sep. 2, 2021

(54) METAL - HALIDE OXYANION BATTERY ELECTRODE CHEMISTRY

(71) Applicants: MASSACHUSETTS INSTITUTE OF TECHNOLOGY, Cambridge, MA (US); TOYOTA MOTORS EUROPE R&D, Zaventem (BE)

(72) Inventors: Yang SHAO-HORN, Newton, MA (US); Graham LEVERICK, Somerville, MA (US); Fanny BARDE, Zaventem (BE)

(73) Assignees: MASSACHUSETTS INSTITUTE OF TECHNOLOGY, Cambridge, MA (US); TOYOTA MOTORS EUROPE R&D, Zaventem (BE)

(21) Appl. No.: 17/253,285

(22) PCT Filed: Jun. 20, 2019
(86) PCT No.: PCT/US2019/038336

§ 371 Date: Dec. 17, 2020

Related U.S. Application Data
(60) Provisional application No. 62/687,654, filed on Jun. 20, 2018.

(51) Int. Cl. H01M 4/136; H01M 4/62; H01M 4/38; H01M 4/58; H01M 10/0525

(52) U.S. Cl. CPC H01M 4/136; H01M 4/625; H01M 10/0525; H01M 4/5825; H01M 4/388

(57) ABSTRACT

A metal-halo oxyanion electrode and battery including the metal-halo oxyanion electrode is described.

### CLAIM OF PRIORITY

This application claims priority to U.S. Provisional Patent Application No. 62/687,654, filed Jun. 20, 2018, which is incorporated by reference in its entirety.

### TECHNICAL FIELD

This invention relates to metal halide oxyanion electrodes and batteries including the electrodes.

### BACKGROUND

The improvement of the positive electrode remains a significant challenge for improving the gravimetric and volumetric energy density of batteries. The current state-of-art positive electrodes are based on the intercalation of lithium ions into and out of transition metal oxides during discharge and charge, respectively. Efforts to improve lithium ion positive electrode materials have been based on trying to increase the amount of mobile lithium per given amount of stationary transition metal oxide. This approach is proving difficult as removing more and more of the cations in the structure during charge results in a structure which is weakly held together this can lead to the irreversible release of oxygen gas from the lattice and a subsequent loss of the electrode's capacity. This requirement to maintain a stable structure in both the fully lithiated and delithiated states imposes some form of upper limit on the maximum achievable capacity for conventional intercalation based electrode materials (although how close we are to this fundamental limit is unclear).

### SUMMARY

In one aspect, an electrode can include a halogen oxyanion salt and a conductive material.

In another aspect, a battery can include a metal electrode, a halogen oxyanion electrode, and a separator between the metal electrode and the halogen oxyanion electrode. In certain circumstances, the halogen oxyanion electrode can include a halogen oxyanion salt and a conductive material.

In certain circumstances, the halogen can be chlorine, bromine or iodine. For example, the halogen can be iodine.

In certain circumstances, the halogen oxyanion salt can be an alkali metal salt. For example, the alkali metal salt can be a lithium salt, a sodium salt or a potassium salt. In certain circumstances, the halogen oxyanion salt can be a lithium iodate, a sodium iodate or a potassium iodate.

In certain circumstances, the halogen oxyanion salt can be formed by oxidation of a metal hydroxide salt in the presence of a halogen or halide. For example, the halogen oxyanion salt can be formed by oxidation of a metal hydroxide salt by a halogen, such as iodine, or a halide, such as iodide.

In certain circumstances, the conductive material can be a conductive carbon material. For example, the conductive carbon material can include carbon black, graphene, carbon nanotubes, or graphite.

In certain circumstances, the electrode can further include a binder.

In certain circumstances, the halogen oxyanion can be iodate.

In certain circumstances, the metal electrode can include an alkali metal or metal ion negative electrode. For example, the alkali metal can include lithium, sodium or potassium. In specific examples, the metal electrode can include lithium. Alternatively, the metal ion negative electrode can be lithiated graphite or silicon.

In another aspect, a method of generating electricity can include creating an electronic connection to a battery described herein.

Other aspects, embodiments, and features will be apparent from the following description, the drawings, and the claims.

### BRIEF DESCRIPTION OF THE DRAWINGS

FIG. 1A is a schematic depiction of an alkali metal halogen oxide electrochemical system.

FIG. 1B is a graph depicting cyclic voltammograms of solutions of 0.5M LiTFSI+10 mM LiI collected at 100 mVps under argon environment in each of the considered solvents with a Pt working electrode, either Li metal (DME, DMSO) or lithium titanium oxide (DMA) counter electrode and Ag/Ag⁺ reference electrode. Currents were normalized based on the maximum current observed. Potentials were converted to a Me₁₀Fc scale based on its half-wave potential measured at the end of the experiment by adding 2 mM Me₁₀Fc to the electrolyte (as detailed in FIG. 18).

FIG. 2 is a set of graphs depicting (panel a) Color changes when solutions of 50 mM I₃⁻ (0.2 M LiI+50 mM 12) are added to 0.1 M synthetic Li₂O₂ (panel b) UV-vis spectra of the liquid phase before and after the reaction with Li₂O₂ confirm the consumption of I₃⁻ in DMSO, but that I₃⁻ remains in DME (panel c) The change in concentration of I₃⁻ when adding a 50 mM I₃⁻ solution to a two times excess of synthetic Li₂O₂ (left axis, black filled symbols). I₃⁻ concentrations were determined through UV-Vis Spectroscopy. Full consumption of I₃⁻ was found in DMA, DMSO and Me-Im with differences in the plot stemming from different initial concentrations. Error bars were estimated based on the accuracy of the mass balance used during preparation of diluted samples of +/−0.5 mg. Calibration curves for each solvent can be found in FIG. 12-14. The difference between the I₃⁻/I⁻ and Li⁺, O₂/Li₂O₂ redox potentials (right axis, open grey symbols).

FIG. 3 is a graph depicting gas chromatography of the gaseous products during the reaction between 50 mM I₃⁻ (0.2 M LiI+50 mM 12) and synthetic Li₂O₂. (panel a) the change in O₂ concentration in the Argon carrier gas stream at 2, 22, 42 and 62 minutes following the injection of the I₃⁻ solution; (panel b) The GC sensor outputs for each of the four measurements. N₂ and O₂ signals were calibrated using a 2500 ppm O₂+17000 ppm N₂ in Argon gas mixture. The absence of N₂ indicates O₂ came from the reaction and not a leak in the cell.

FIG. 4 is a graph depicting a voltage profile and corresponding O₂ (filled symbols) and CO₂ (open symbols) evolution during charge at 0.1 mA/cm² in 0.5 M LiTFSI in G2 (panel a, panel c) or DMSO (panel b, panel d), both with 0.1 M LiI (lighter colors) and with an additional 0.1 M LiTFSI (darker colors) to keep the overall [Li⁺] constant. Cells constructed with a Li metal counter electrode and a solid Li-conducting separator to prevent shuttling of oxidized iodide species from the positive electrode to the Li metal electrode where they can be chemically reduced and diffuse back to the positive electrode. See, for example, Burke, C. M. et al. Implications of 4e⁻ Oxygen Reduction via Iodide Redox Mediation in Li—O₂ Batteries. ACS Energy Lett 1, 747-756 (2016), which is incorporated by reference in its entirety. Potentials referenced against lithium metal counter electrode. Cells were first discharged for 20 hours at 0.05 mA/cm² under O₂ environment, and then the cell headspace was evacuated and purged with Argon gas five times. The added 0.1 M LiI could provide a theoretical maximum of 33 mM I₃⁻ and 50 mM I₂, accounting for a maximum of 0.25 mAhr/cm² of capacity.

FIG. 5A is a set of drawings showing a graph depicting (panel a) The change in concentration of I₃⁻ when adding a 50 mM I₃⁻ (0.2 M LiI+50 mM I₂) solution to a two times excess of LiOH (left axis, black filled symbols). I₃⁻ concentrations were determined through UV-Vis Spectroscopy. Full consumption of I₃⁻ was found in DMA, DMSO and Me-Im with differences in the plot stemming from different initial concentrations. Error bars were estimated based on the accuracy of the mass balance used during preparation of diluted samples of +/−0.5 mg. Calibration curves for each solvent can be found in FIGS. 12-14. The difference between the I₃⁻/I⁻ and Li⁺,O₂,H₂O/LiOH redox potentials (right axis, open grey symbols) and Li⁺,IO₃⁻,H₂O/LiOH,I⁻ redox potentials (right axis, filled grey symbols); (panel b) The change in concentration of 12 when adding a 50 mM I₂ solution to a two times excess of LiOH (left axis, black filled symbols). The difference between the I₂/I₃⁻ and Li⁺, O₂, H₂O/LiOH redox potentials (right axis, open grey symbols) and Li⁺,IO₃⁻, H₂O/LiOH, I⁻ redox potentials (right axis, filled grey symbols; (panel c) Raman spectra of the solid participate which was separated and washed after reacting an excess of 12 with LiOH in DMSO and three reference spectra (LiIO₃, LiOH and LiOH—H₂O). The solid precipitate has only peaks consistent with LiIO₃ and no erroneous peaks; measurement is representative of three separate locations in the solid.

FIG. 5B is a set of drawings showing a graph (panel a) showing the consumption of I₃⁻ when adding 200 μmol of commercial LiOH to 1 mL of 50 mM I₃⁻ solution (50 μmol I₃⁻, LiOH:I₃⁻=4:1)) (left axis, black filled symbols) measured after 48 hours. I₃⁻ concentrations were determine through UV-Vis Spectroscopy. Full consumption of I₃⁻ was found in DMA, DMSO and Me-Im with differences in the plot stemming from different initial concentrations. Error bars were estimated based on the accuracy of the mass balance used during preparation of diluted samples of +/−0.5 mg. Calibration curves for each solvent can be found in FIGS. 12-14. The difference between the I₃⁻/I⁻ and Li⁺,O₂,H₂O/LiOH redox potentials (right axis, open grey symbols) and Li⁺,IO₃⁻,H₂O/LiOH,I⁻ redox potentials (right axis, open black symbols). Panel b shows the consumption of 12 when adding 200 μmol of commercial LiOH to 1 mL of 50 mM I₂ solution (50 μmol 12, LiOH:I₃⁻=4:1)) (left axis, black filled symbols) measured after 48 hours. The difference between the I₂/I₃⁻ and Li⁺,O₂,H₂O/LiOH redox potentials (right axis, open grey symbols) and Li⁺,IO₃⁻,H₂O/LiOH,I⁻ redox potentials (right axis, open black symbols). Panel c shows Raman spectra of the solid participate which was separated and washed after reacting an excess of I₂ with LiOH in DMSO and three reference spectra (LiIO₃, LiOH and LiOH—H₂O). The solid precipitate has only peaks consistent with LiIO₃ and no erroneous peaks; measurement is representative of three separate locations in the solid.

FIG. 6 is a graph depicting (panel a)¹H NMR spectrum of pure DMSO, DMSO after exposure to LiOH, and DMSO after the reaction between 50 mM I₂/I₃⁻ and 0.2 M commercial LiOH. After the reactions between I₂/I₃⁻ and LiOH, two new peaks appear; one at ˜2.95 ppm (based on the DMSO peak being assigned to 2.5 ppm) corresponding to DMSO₂ and one at ˜3.3 ppm corresponding to H₂O. All ¹H NMR samples were prepared by mixing 0.5 mL of the sample+0.1 mL of DMSO-D6 (for NMR locking)+10 μL of 1,4-dioxane internal reference (for quantification) and (panel b) full quantification of detected liquid and solid products after reactions between I₂/I₃⁻ and LiOH. LiIO₃ was quantified using iodometric titration, DMSO₂ and H₂O were quantified using ¹H NMR with an internal standard of 1,4-dioxane.

FIG. 7 is a graph depicting voltage profile and corresponding O₂ (filled symbols) and CO₂ (open symbols) evolution during charge of LiOH preloaded electrodes at 0.1 mA/cm2 in 0.5 M LiTFSI in G2 (panel a, panel c) or DMSO (panel b, panel d), both with 0.1 M LiI (lighter colors) and with an additional 0.1 M LiTFSI (darker colors) to keep the overall [Li+] constant. Cells constructed with a Li metal counter electrode and a solid Li-conducting separator to prevent shuttling of oxidized iodide species from the positive electrode to the Li metal electrode where they can be chemically reduced and diffuse back to the positive electrode. See, for example, Burke, C. M. et al. Implications of 4e⁻ Oxygen Reduction via Iodide Redox Mediation in Li—O₂ Batteries. ACS Energy Lett. 1, 747-756 (2016), which is incorporated by reference in its entirety. Potentials referenced against lithium metal counter electrode. The added 0.1 M LiI could provide a theoretical maximum of 33 mM I₃⁻ and 50 mM I₂, accounting for a maximum of 0.25 mAhr/cm² of capacity.

FIG. 8 is a drawing depicting a battery.

FIG. 9 is a graph depicting Raman spectroscopy of commercial Li₂O₂, anhydrous LiOH after additional drying at 170° C. under vacuum for 24 hrs, LiOH—H₂O and LiIO₃.

FIG. 10 is a graph depicting cyclic voltammograms of solutions of 0.5M LiTFSI+10 mM LiI collected at 100 mVps under argon environment in each of the considered solvents with a Pt working electrode, either Li metal (G4, DME, DMSO) or lithium titanium oxide (pyridine, DMA, Me-Im) counter electrode and Ag/Ag⁺ reference electrode. Currents were normalized based on the maximum current observed. Potentials were converted to a Me₁₀Fc scale based on its half-wave potential measured at the end of the experiment by adding 2 mM Me₁₀Fc to the electrolyte (as per FIG. 18).

FIG. 11 is a graph depicting calibration curves relating UV-vis absorbance at (panel a) 364 nm and (panel b) 293 nm to the concentration of I₃⁻ in prepared DME solutions.

FIG. 12 is a graph depicting calibration curves relating UV-vis absorbance at 366 nm and 297 nm to the concentration of I₃⁻ in prepared DMSO solutions.

FIG. 13 is a graph depicting calibration curves relating UV-vis absorbance at 367 nm and 296 nm to the concentration of I₃⁻ in prepared G4 solutions.

FIG. 14 is a graph depicting a calibration curve relating UV-vis absorbance at 368 nm to the concentration of I₃⁻ in prepared pyridine solution.

FIG. 15 is a graph depicting UV-vis absorbance of pure solvents, with I₃⁻ peaks marked. The solvent's inherent absorbance interferes with the observation of 293 nm I₃⁻ peak in pyridine and Me-Im.

FIG. 16 is a graph depicting XRD reference spectra of commercial Li₂O₂, LiOH, LiOH—H₂O, LiI, LiIO₃ and DMSO₂.

FIG. 17 is a photograph depicting observed corrosion of 316 stainless steel current collector following cycling of a cell with 0.1M LiI in DMSO.

FIG. 18 is a graph depicting details on how the Ag⁺/Ag reference electrode scale was converted to a Me₁₀Fc scale. All measurements were made on the potentiostat against the Ag⁺/Ag reference electrode. The Me₁₀Fc half-wave potential was obtained by adding 2 mM Me₁₀Fc to the electrolyte at the end of the experiment and measuring its CV at 100 mVps. The half-wave potential of Me₁₀Fc was determined based on taking the average potential of the anodic and cathodic peaks. The position of this Me₁₀Fc potential on the Ag⁺/Ag scale was then used to determine the positions of other redox transitions on the Me₁₀Fc scale.

FIG. 19 is a graph depicting possible correlations between solvent DN and measured half-wave potentials for I⁻/I₃⁻ (squares), I₃⁻/I₂ (Xs) and Li/Li⁺ (open circles).

FIG. 20 is a graph depicting possible correlations between solvent AN and measured half-wave potentials for I⁻/I₃⁻ (squares), I₃⁻/I₂ (Xs) and Li/Li⁺ (open circles).

FIG. 21 is a graph depicting possible correlations between solvent dielectric constant and measured half-wave potentials for I⁻/I₃⁻ (squares), I₃⁻/I₂ (Xs) and Li/Li⁺ (open circles).

FIG. 22 is a graph depicting: (panel a) color changes when solutions of 50 mM I₃⁻ are added to 0.1 M synthetic Li₂O₂; (panel b) UV-vis spectra of the liquid phase before and after the reaction with Li₂O₂ confirm the consumption of I₃⁻; and (panel c) the concentrations of I₃⁻ before and after adding the solution to a two times excess of Li₂O₂. I₃⁻ concentrations were determined through UV-Vis Spectroscopy. Error bars were estimated based on the accuracy of the mass balance used during preparation of diluted samples of +/−0.5 mg. Calibration curves for each solvent can be found in FIG. 11-14.

FIG. 23 is a graph depicting full, unscaled adsorption spectra of the liquid phase retrieved after the reaction between I₃⁻ and Li₂O₂ in DMA, DMSO and Me-Im.

FIG. 24 is a graph depicting Raman spectra of commercial Li₂O₂ and LiTFSI for reference, as well as the solid recovered after the reaction between synthesized Li₂O₂ and I₃⁻ in G4, DME, Pyridine, DMA, DMSO and Me-Im.

FIG. 25 is a graph depicting details of GC experiments measuring the O₂ generation due to the reaction between I₃⁻ and Li₂O₂ in DMSO.

FIG. 26 is a graph depicting the concentration of I₂ present before and after the reaction between I₂ and Li₂O₂ in DME, DMA and DMSO.

FIG. 27 is a graph depicting measured extent of reaction determined by UV-Vis of solutions of I₂ in DME with different starting concentrations of LiI with both commercial Li₂O₂ and Li₂O₂ formed through disproportionation. Calculated values based on the reaction stopping when only I₃⁻ remains are shown as dashed gray lines.

FIG. 28 is a graph depicting Raman of solutions of mixtures of I₂ and LiI in DME taken before and after reaction with Li₂O₂.

FIG. 29 is a graph depicting ¹H NMR spectra of pure solvent as well as the liquid phase recovered following the reaction with Li₂O₂ and LiOH. All ¹H NMR samples were prepared by mixing 0.5 mL of the sample+0.1 mL of DMSO-D6 (for NMR locking)+10 μL of MeCN internal reference (for quantification).

FIG. 30 is a graph depicting reference ¹H NMR spectra of commercial dimethyl sulfone (DMSO₂) added to DMSO-D6 with contaminate water.

FIG. 31 is a graph depicting ¹HNMR spectra showing the change in proton exchange dynamics of Me-Im after creating a solution with 50 mM I₂ and 0.2M LiI.

FIG. 32 is a graph depicting iodination of Me-Im led to loss of the I₃⁻ peak in UV-vis.

FIG. 33 is a graph depicting XRD of electrodes discharged in 0.1M LiI+0.5M LiTFSI solutions in G2 and DMSO. G2 electrode was discharged for 20 hours at 0.05 mA/cm² which corresponded to its total capacity before sudden death, DMSO electrode was discharged for 40 hours at 0.05 mA/cm² to allow more easy identification of the discharge product.

FIG. 34 is a graph depicting I₃⁻ concentration of solutions of 50 mM I₃⁻ (0.2 M LiI+50 mM I₂) in a range of solvents before and after reaction with 0.2 M LiOH.

FIG. 35 is a graph depicting UV-vis spectra of solutions of I₃⁻ in DME (left) and DMSO (right) before and after reaction with 0.2 M LiOH, confirming the consumption of I₃⁻ in DMSO, but that I₃⁻ remains in DME.

FIG. 36 is a graph depicting Raman spectra of LiOH and LiOH—H₂O powder compared with the solid recovered after the reaction between I₃⁻ and a two times excess of LiOH in G4, DME, pyridine, DMA, DMSO and Me-Im.

FIG. 37 is a graph depicting GC measurements during the reaction between LiOH and I₃⁻ in DMSO show no detectable quantity of O₂ generated.

FIG. 38 is a graph depicting XRD of solid recovered after the reaction between LiOH and a two times excess of I₃⁻ in DMSO.

FIG. 39 is a graph depicting Raman spectra collected before and during the reaction between I₃⁻ and LiOH in DMSO. Measurements were taken by directly measuring the solution phase of a 50 mM I₃⁻ DMSO solution in a vial either with (red) or without (blue) LiOH present (during the initial stages of the reaction.

FIG. 40 is a graph depicting XRD patterns of preloaded electrodes following charging in G2 and DMSO compared with references for LiOH, LiOH—H₂O and LiIO₃. Electrodes show only peaks present on XRD taken on the pristine carbon paper (CP) and LiOH.

FIG. 41 is a graph depicting (panel a) Calculated thermodynamics of the oxidation of Li₂O₂(black) and LiOH(blue) to O₂ (solid) and LiIO₃ (dotted). These values are overlayed with the measured half-wave potentials of the I⁻/I₃⁻ and I₃⁻/I₂ redox couples in DME, DMA and DMSO. (panel b) Predicted selectivity towards O₂ and LiIO₃ formation based on the minimum O—O distance in the crystal lattice.

FIG. 42 is a graph depicting DEMS from cells with and without KO₂ in between glass fiber separators in 0.1M KI in G2. I₃⁻/I₂ is formed at the positive carbon paper electrode can diffuse towards the negative electrode where it can be chemically reduced by the K metal plated onto the Cu film creating shuttling between the electrodes as has been shown previously. If KO₂ is present between the separators (electronically isolated from both electrodes), it can also be oxidized by the I₃⁻/I₂ in the electrolyte and give off O₂ gas and enhance capacity.

FIG. 43 is a graph depicting solid phase after the reaction between Li₂O and I₃⁻ in DMSO shows clear evidence of LiIO₃ through Raman (top) and XRD (bottom).

FIG. 44 is a graph depicting comparison of the color of 12 solutions in hexane (left) and DME (right). The purple color indicates the absence of I₃⁻ and therefore no Solvent-I⁺ complexes.

FIG. 45 is a graph depicting the liquid phase (left) and solid phase (right) following the reaction between hexane and commercial Li₂O₂.

FIG. 46 is a graph depicting Raman spectra of the solid recovered after the reaction between Li₂O₂ and I₂ in hexane. Peaks are consistent with Li₂O₂ and solid LiI₃ (which may have a slightly shifted peak compared with I₃⁻ in solution.

FIG. 47 is a graph depicting Raman spectra of the solution recovered after the reaction between I₂ and LiOH in DME compared to reference spectra for solutions of I₃⁻ and I₂ in DME. Spectra show on I₃⁻ remains after the reaction.

FIG. 48 is a graph depicting Raman spectra of LiOH synthesized via the disproportionation of KO₂ in a two times excess of LiTFSI in MeCN with added water. Spectra indicates the anhydrous phase of LiOH was formed.

FIG. 49 is an image of vials following the reaction between 200 μmol of synthetic LiOH and 1 mL of 50 mM I₃⁻ solution (50 μmol I₃⁻, LiOH:I₃⁻=4:1)) after 96 hours. Similar to the commercial LiOH, the DMSO solution became colorless after ˜1 hour, the DMA solution became colorless after ˜96 hours and the DME solution did not change color.

FIG. 50 is a graph depicting XRD and SEM of the commercial LiIO₃ used to construct LiIO₃ battery electrodes.

FIG. 51 is a drawing depicting a schematic of cell used to test discharge process.

FIG. 52 is a graph depicting sample discharge profile (discharged at C/40) of composite electrodes constructed with commercial LiIO₃, carbon and a PvDF binder.

FIG. 53 is a graph depicting sample discharge profile (discharged at 0.1 mA/cm2) of electrodes prepared by drop casting LiIO₃ and Vulcan carbon onto carbon paper substrate.

FIG. 54 is a graph depicting Raman spectra on electrodes after discharge show the clear formation of anhydrous LiOH.

FIG. 55 is a graph depicting XRD on electrodes after discharge show the clear formation of anhydrous LiOH.

FIG. 56 is a micrograph depicting SEM of a pristine composite electrode made from LiIO₃, carbon and PvDF binder.

FIG. 57 is a micrograph depicting SEM of a discharged composite electrode made from LiIO₃ shows clear morphological changes.

FIG. 58 is a graph depicting discharge profile (bottom) and results of titrations to quantify the amount of formed LiOH and LiIO₃ (top) for cells discharged in different solvents with O⁰V % added H₂O.

FIG. 59 is a. graph depicting (left) XRD and (right) Raman characterization on the discharged electrodes demonstrate the consumption of LiIO₃ and formation of LiOH on discharge

FIG. 60 is a graph depicting discharge profile (bottom) and results of titrations to quantify the amount of formed LiOH and LiIO₃ (top) for cells discharged in DME with different amounts of added H₂O.

FIG. 61 is a graph depicting (left) XRD and (right) Raman characterization on the discharged electrodes demonstrate the consumption of LiIO₃ and formation of LiOH on discharge.

FIG. 62 is a set of micrographs depicting SEM images of pristine (left) and discharged (right) electrodes demonstrate substantial morphological changes during discharge, consistent with dissolution of reactants and precipitation of reaction products.

FIG. 63 is a graph depicting solubilities of LiOH and LiIO₃ measured with inductively coupled plasma (ICP) indicate solubility in the mM region with added H₂O in the electrolyte. Viscodensity measurements indicate high viscosity and a linear relationship between the volume of added water and its resulting concentration in the mixed electrolyte.

FIG. 64 is a graph depicting overpotentials during discharge are consistent with mass transport limitations as evidenced by the linear relationship between overpotential and log(viscosity/LiIO₃ solubility).

FIG. 65 is a graph depicting discharge process is proposed to go through a three step process of 1) dissolution of LiIO₃ 2) electrochemical reduction of IO₃⁻ to OH⁻ and 3) precipitation of LiOH.

### DETAILED DESCRIPTION

Lithium oxygen batteries (a potential alternate positive electrode chemistry) work by reacting oxygen in its gaseous form with lithium ions to form lithium peroxide on discharge and then reforming oxygen gas and lithium ions on charge. The lithium oxygen approach can be thought of as the opposite approach to lithium ion as the entire solid structure of lithium peroxide formed on discharge is decomposed into ions and gaseous oxygen on charge. While this approach leads to a significantly higher theoretical energy density, it poses significant challenges such as the reactivity of reaction intermediate and the challenges associated with such an extreme state change between the discharged and charged forms.

The positive electrode chemistry developed herein takes an intermediate approach to those of lithium ion and lithium oxygen batteries. During discharge (reaction 1), solid lithium iodate reacts with water in the electrolyte to form solid lithium hydroxide. On charge, the process is reversed (reaction 2 and 3) and lithium iodate is regenerated. This is achieved by exploiting the fact that the soluble lithium iodide forms on discharge acts as a soluble redox mediator, allowing the process to happen in solution. Since the solid structure is different between the charged and discharged states, the fundamental concern of structural stability in both the lithiated and delithiated states is potentially circumvented. Additionally, since the phase transition is not as extreme as lithium oxygen batteries, some of these challenges may also be mitigated.

### Discharge:

LiHO₃+3H₂O+5Li⁺+6e⁻→I⁻+6LiOH (1)

### Charge:

2I⁻→I₂+2e⁻ (2)

6LiOH+3I₂→5Li⁺+5I⁻+3H₂O+LiO₃ (3)

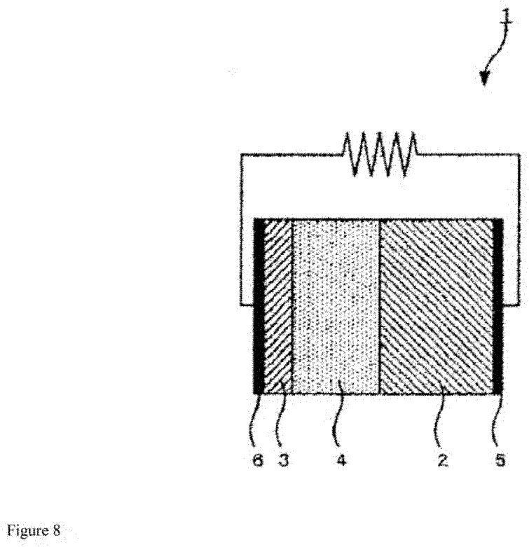

FIG. 8 schematically illustrates a rechargeable battery 1, which includes anode 2, cathode 3, electrolyte 4, anode collector 5, and cathode collector 6. The battery can include a housing including an electrolyte (not shown). The battery can be a lithium battery, for example, a lithium-halogen oxyanion battery.

The electrolyte can include an aprotic solvent. The aprotic solvent can be 1,2-dimethoxyethane (DME), pyridine, DMA, Me-Im, G2 or G4. The electrolyte can include a salt, such as, both lithium bis(trifluromethane sulfonyl)-imide (LiTFSI) or lithium iodide (LiI).

The halogen oxyanion electrode, or positive electrode, can be a mixture of a halogen oxyanion salt and a conductive material. The conductive material can include carbon black, graphene, carbon nanotubes, or graphite. A binder, such as a polymer, can be applied hold the components of the electrode together, for example, a poly(carboxylic acid), poly(carboxylic acid), poly(acrylic acid) (PAA), poly-(methacrylic acid) (PMAA), poly(ethylene oxide) (PEO), poly(vinyl alcohol), or poly(vinylpyrrolidone).

The active material of the electrode is the halogen oxyanion salt. The halogen oxyanion salt can be a lithium salt, a sodium salt or a potassium salt. The halogen oxyanion salt can be a chlorate salt, a bromate salt or an iodate salt. Alternatively, the halogen oxyanion salt can be formed during a charging cycle by reaction of a metal hydroxide and a metal halide salt, for example, lithium hydroxide in the presence of lithium iodide.

The negative electrode can include lithium, sodium or potassium. In specific examples, the metal electrode can include lithium metal or a lithium compound, such as a lithium metal oxide (e.g., a lithium cobalt oxide or a lithium manganese oxide), lithiated graphite or silicon, or other metal ion complex. The term “battery” as used herein includes primary and secondary (rechargeable) batteries.

The separators that directly contact on the electrode can include porous organic polymers or porous glass separators. The separator permits ionic conduction but not electrical conduction between the electrodes.

In one implementation of this chemistry, an electrode resembling a conventional lithium ion composite electrode (active material+carbon+binder) is made using either lithium iodate or lithium hydroxide as the active material (depending on if the battery is assembled in its charged or discharged state). This chemistry is found to be highly sensitive to the electrolyte composition. In initial studies, an electrolyte based on 1,2-dimethoxyethane (DME) with both lithium bis(trifluromethane sulfonyl)-imide (LiTFSI) and lithium iodide (LiI) salts as well as added water (5-10 weight percent) has been used. The combined effect of a weakly interacting aprotic solvent (DME) and strong water-iodide interactions has been found to enhance the protonation of water (necessary for improving the discharge process (reaction 1)). The charge process has already been identified as a parasitic process on charging on lithium hydroxide based battery chemistries with lithium iodide present. It is unclear whether this occurs based on forming iodine (I₂) as shown in reaction 2, or whether a triiodide (I₃⁻) or pentaiodide (I₅⁻) intermediate is instead formed.

A cell based on this chemistry would need sufficient electrode porosity to allow water and iodide to reach all active material in the positive electrode, however, since both discharged and charged states are either solid/insoluble in the electrolyte, or soluble in the electrolyte, an open, gas positive electrode (such as those used in lithium oxygen batteries) is not needed—improving volumetric energy density. The cell would likely have to be kept free of molecular oxygen to avoid parasitic reactions. This positive electrode could be paired with any negative electrode which is based on lithium ions (lithiated graphite/silicon, lithium metal, etc). Some protection of the negative electrode from water in the electrolyte is likely necessary.

While the above chemistry is based on lithium and iodide oxyanions, similar chemistries may be possible based on substituting lithium for other alkali metals such as sodium and potassium or substituting iodine for other halides such as bromine, chlorine or fluorine.

### Calculated Theoretical Gravimetric Energy Density (Positive Electrode Active Material Only)

| | |
|---|---|
| Lithium ion (LCO) | 875-1000 Whr/kg |
| Lithium oxygen | 3250-3450 Whr/kg |
| Lithium iodate/hydroxide | 1550-1750 Whr/kg |

Lithium iodide (LiI) has been extensively studied as a soluble redox mediator in Li—O₂ batteries in order to catalyze the charging process. Despite some promising initial results, serious ambiguities exist in the literature regarding the reactivity between oxidized iodide species (I₃⁻/I₂) and the products formed during discharge (Li₂O₂/LiOH). In this work, we systematically examined the solvent-dependence of the oxidizing power of I₃⁻/I⁻ and I₂/I₃⁻ towards Li₂O₂/LiOH through the use of ex-situ chemical reactions where the liquid reaction products were examined using UV-vis spectroscopy and ¹H NMR, the solid reaction products were studied by Raman spectroscopy and XRD and the gaseous products were assessed using gas chromatography. In addition, the role of I⁻ on the charging of Li—O₂ batteries and LiOH pre-loaded cells was examined using DEMS, where the amount of oxygen release was quantified. Stronger solvation of Li⁺ and I⁻ ions can lead to an increase in the oxidizing power of I₃⁻, which allowed I₃⁻ to oxidize Li₂O₂/LiOH in stronger solvents, such as DMA, DMSO and Me-Im, whereas in weaker solvents (G4, DME), the more oxidizing I₂ was needed before a reaction could occur. It was observed that Li₂O₂ was oxidized to O₂, whereas LiOH was oxidized to an IO⁻ intermediate, which could either disproportionate to LiIO₃ or attack solvent molecules. Based on observed reactions with KO₂/Li₂O, we propose that while LiIO₃ formation is thermodynamically favored, O₂ gas evolution dominates in the oxidation of Li₂O₂ due to a kinetic barrier to O—O bond dissociation in the formation of LiIO₃.

In general, lithium-oxygen batteries offer considerably higher gravimetric energy density than commercial Li-ion batteries (up to three times). Despite this promise, rechargeable nonaqueous Li—O₂ batteries suffer from considerable fundamental issues relating to cycle life, parasitic reactions and poor round trip efficiency. Some of the most significant issues stem from the poor kinetics of Li₂O₂ oxidation on charge, which leads to high overpotential and considerable parasitic reactions. Soluble redox mediators, such as LiI, have been proposed as a potential solution to this problem, however, despite a number of promising initial results, there exists considerable discrepancy in the literature regarding the oxidizing power of I₃⁻/I₂ (the oxidized species formed during charge) against both Li₂O₂ and LiOH (potential discharge products of the Li—O₂ chemistry), as well as the product formed by their oxidation. Some studies have suggested that I₃⁻ can oxidize Li₂O₂/LiOH, while others suggest the more oxidizing I₂ is needed to react with Li₂O₂/LiOH and others still have claimed that LiOH is inactive in the presence of I₃⁻/I₂. There are studies that claim LiOH is oxidized reversibly to O₂, whereas others claim it is irreversibly oxidized to LiIO₃. In this study, we use detailed quantifications, a wide range of characterization techniques and cells constructed with a solid Li-conducting separator to eliminate shuttling in order to resolve these ambiguities. We show that the oxidizing power of I₃⁻ is solvent-dependent and can oxidize Li₂O₂/LiOH in stronger solvents (DMA, DMSO and Me-Im), but the more oxidizing I₂ is required in weaker solvents like DME and G4. Furthermore, we show that Li₂O₂ is oxidized to O₂, whereas LiOH is irreversibly oxidized to IO⁻ which can either disproportionate to form LiIO₃ or attack solvent molecules.

There has been considerable interest in nonaqueous Li—O₂ batteries in the past decade due to their high theoretical gravimetric energy density (potentially up to 3 times that of commercial lithium ion batteries). See, for example, Aurbach, D., McCloskey, B. D., Nazar, L. F. & Bruce, P. G. Advances in understanding mechanisms underpinning lithium-air batteries. Nat. Energy 1, 16128 (2016); Bruce, P. G., Freunberger, S. A., Hardwick, L. J. & Tarascon, J.-M. Li—O2 and Li—S batteries with high energy storage. Nat. Mater. 11, 19-29 (2011); and Kwabi, D. G. et al. Materials challenges in rechargeable lithium-air batteries. MRS Bull. 39, 443-452 (2014), each of which is incorporated by reference in its entirety. This large theoretical improvement in gravimetric energy density stems from the fundamentally different reactions of the Li—O₂ battery chemistry, which relies on reducing gaseous oxygen to form solid lithium peroxide (2Li+O₂═Li₂O₂, E⁰=2.96 V_{Li}) or lithium oxide (2Li⁺O₂═Li₂O, E⁰=2.91 V_{Li}). Previous work shows that the discharge of nonaqueous Li—O₂ batteries can produce Li₂O₂ with low overpotential, the morphology of which is dependent on the solvent, counter anion and potential/rate. See, for example, Lu, Y.-C. et al. Lithium-oxygen batteries: bridging mechanistic understanding and battery performance. Energy Environ. Sci. 6, 750 (2013); Viswanathan, V. et al. Li—O₂ Kinetic Overpotentials: Tafel Plots from Experiment and First-Principles Theory. J. Phys. Chem. Lett. 4, 556-560 (2013); Kwabi, D. G. et al. Experimental and Computational Analysis of the Solvent-Dependent O₂/Li⁺—O₂⁻ Redox Couple: Standard Potentials, Coupling Strength, and Implications for Lithium-Oxygen Batteries. Angew. Chem. Int. Ed. 55, 3129-3134 (2016); Johnson, L. et al. The role of LiO2 solubility in O2 reduction in aprotic solvents and its consequences for Li—O₂ batteries. Nat. Chem. 6, 1091-1099 (2014); Sharon, D. et al. Mechanistic Role of Li⁺ Dissociation Level in Aprotic Li—O₂ Battery. ACS Appl. Mater. Interfaces 8, 5300-5307 (2016); Burke, C. M., Pande, V., Khetan, A., Viswanathan, V. & McCloskey, B. D. Enhancing electrochemical intermediate solvation through electrolyte anion selection to increase nonaqueous Li—O₂ battery capacity. Proc. Natl. Acad. Sci. 112, 9293-9298 (2015); Kwabi, D. G. et al. Controlling Solution-Mediated Reaction Mechanisms of Oxygen Reduction Using Potential and Solvent for Aprotic Lithium-Oxygen Batteries. J. Phys. Chem. Lett. 7, 1204-1212 (2016); and Mitchell, R. R., Gallant, B. M., Shao-Hom, Y. & Thompson, C. V. Mechanisms of Morphological Evolution of Li₂O₂ Particles during Electrochemical Growth. J. Phys. Chem. Lett. 4, 1060-1064 (2013), each of which is incorporated by reference in its entirety. Unfortunately, charging rechargeable Li—O₂ batteries with nonaqeuous electrolytes requires a high overpotential to liberate molecular oxygen and this reaction is considerably more irreversible at high potentials as shown by McCloskey et al., leading to poor round-trip efficiency and cycle life resulting from parasitic side reactions. See, for example, McCloskey, B. D. et al. Combining Accurate O₂ and Li₂O₂ Assays to Separate Discharge and Charge Stability Limitations in Nonaqueous Li—O₂ Batteries. J. Phys. Chem. Lett. 4, 2989-2993 (2013); Aurbach, D., McCloskey, B. D., Nazar, L. F. & Bruce, P. G. Advances in understanding mechanisms underpinning lithium-air batteries. Nat. Energy 1, 16128 (2016); Bruce, P. G., Freunberger, S. A., Hardwick, L. J. & Tarascon, J.-M. Li—O₂ and Li—S batteries with high energy storage. Nat. Mater. 11, 19-29 (2011); and Kwabi, D. G. et al. Materials challenges in rechargeable lithium-air batteries. MRS Bull. 39, 443-452 (2014), each of which is incorporated by reference in its entirety. Therefore, considerable efforts have been placed on attempting to catalyze the charging process in Li—O₂ batteries. See, for example, Lim, H.-D. et al. Rational design of redox mediators for advanced Li—O₂ batteries. Nat. Energy 1, 16066 (2016); Lim, H.-D. et al. Superior Rechargeability and Efficiency of Lithium-Oxygen Batteries: Hierarchical Air Electrode Architecture Combined with a Soluble Catalyst. Angew. Chem. Int. Ed. 53, 3926-3931 (2014); Liu, T. et al. Cycling Li—O₂ batteries via LiOH formation and decomposition. Science 350, 530-533 (2015); Bergner, B. J., Schurmann, A., Peppler, K., Garsuch, A. & Janek, J. TEMPO: A Mobile Catalyst for Rechargeable Li—O₂ Batteries. J. Am. Chem. Soc. 136, 15054-15064 (2014); Kwak, W.-J. et al. Li—O₂ cells with LiBr as an electrolyte and a redox mediator. Energy Env. Sci 9, 2334-2345 (2016); Kwak, W.-J. et al. Understanding the behavior of Li-oxygen cells containing LiI. J Mater Chem A 3, 8855-8864 (2015); Chen, Y., Freunberger, S. A., Peng, Z., Fontaine, O. & Bruce, P. G. Charging a Li—O₂ battery using a redox mediator. Nat. Chem. 5, 489-494 (2013); Sun, D. et al. A Solution-Phase Bifunctional Catalyst for Lithium-Oxygen Batteries. J. Am. Chem. Soc. 136, 8941-8946 (2014); Feng, N., He, P. & Zhou, H. Enabling Catalytic Oxidation of Li₂O₂ at the Liquid-Solid Interface: The Evolution of an Aprotic Li—O₂ Battery. ChemSusChem 8, 600-602 (2015); Kundu, D., Black, R., Adams, B. & Nazar, L. F. A Highly Active Low Voltage Redox Mediator for Enhanced Rechargeability of Lithium-Oxygen Batteries. ACS Cent. Sci. 1, 510-515 (2015); Torres, W. R., Herrera, S. E., Tesio, A. Y., Pozo, M. del & Calvo, E. J. Soluble TTF catalyst for the oxidation of cathode products in Li—Oxygen battery: A chemical scavenger. Electrochimica Acta 182, 1118-1123 (2015); Wu, S., Tang, J., Li, F., Liu, X. & Zhou, H. Low charge overpotentials in lithium-oxygen batteries based on tetraglyme electrolytes with a limited amount of water. Chem Commun 51, 16860-16863 (2015); Zhu, Y. G. et al. Dual redox catalysts for oxygen reduction and evolution reactions: towards a redox flow Li—O₂ battery. Chem Commun 51, 9451-9454 (2015); Pande, V. & Viswanathan, V. Criteria and Considerations for the Selection of Redox Mediators in Nonaqueous Li—O₂ Batteries. ACS Energy Lett. 2, 60-63 (2016); Yao, K. P. C. et al. Utilization of Cobalt Bis(terpyridine) Metal Complex as Soluble Redox Mediator in Li—O₂ Batteries. J. Phys. Chem. C 120, 16290-16297 (2016); Zeng, X. et al. Enhanced Li—O 2 battery performance, using graphene-like nori-derived carbon as the cathode and adding LiI in the electrolyte as a promoter. Electrochimica Acta 200, 231-238 (2016); Zhang, W. et al. Promoting Li2O2 oxidation via solvent-assisted redox shuttle process for low overpotential Li—O 2 battery. Nano Energy 30, 43-51 (2016); and Zhang, T., Liao, K., He, P. & Zhou, H. A self-defense redox mediator for efficient lithium-O₂ batteries. Energy Env. Sci 9, 1024-1030 (2016), each of which is incorporated by reference in its entirety.

While solid-state catalysts have been employed to reduce the overpotential during charge, including metal oxides, modified carbon and metals/metal alloys, these catalysts rely on good electrical contact between Li₂O₂ and the catalyst throughout the entire charging process and do not suppress side reactions during charging. See, for example, Xu, J.-J. et al. Synthesis of Perovskite-Based Porous La_{0.75}Sr_{0.25}MnO₃ Nanotubes as a Highly Efficient Electrocatalyst for Rechargeable Lithium-Oxygen Batteries. Angew. Chem. Int. Ed. 52, 3887-3890 (2013); Yao, K. P. C. et al. Solid-state activation of Li₂O₂ oxidation kinetics and implications for Li—O₂ batteries. Energy Environ. Sci. 8, 2417-2426 (2015); Yin, Y.-B., Xu, J.-J., Liu, Q.-C. & Zhang, X.-B. Macroporous Interconnected Hollow Carbon Nanofibers Inspired by Golden-Toad Eggs toward a Binder-Free, High-Rate, and Flexible Electrode. Adv. Mater. 28, 7494-7500 (2016); Li, L. & Manthiram, A. O- and N-Doped Carbon Nanowebs as Metal-Free Catalysts for Hybrid Li-Air Batteries. Adv. Energy Mater. 4, 1301795 (2014); Shui, J. et al. Nitrogen-Doped Holey Graphene for High-Performance Rechargeable Li—O₂ Batteries. ACS Energy Lett. 1, 260-265 (2016); Xu, J.-J., Wang, Z.-L., Xu, D., Zhang, L.-L. & Zhang, X.-B. Tailoring deposition and morphology of discharge products towards high-rate and long-life lithium-oxygen batteries. Nat. Commun. 4, (2013); Kwon, H.-M. et al. Effect of Anion in Glyme-based Electrolyte for Li—O₂ Batteries: Stability/Solubility of Discharge Intermediate. Chem. Lett. 46, 573-576 (2017); and Wong, R. A. et al. Critically Examining the Role of Nanocatalysts in Li—O₂ Batteries: Viability toward Suppression of Recharge Overpotential, Rechargeability, and Cyclability. ACS Energy Lett. 3, 592-597 (2018), each of which is incorporated by reference in its entirety. An alternative approach is the use of soluble redox mediators to promote electron transfer to the surface of the electronically insulating Li₂O₂, where the redox mediator is first electrochemically oxidized at the electrode surface and then the oxidized form of the redox mediator chemically oxidizes Li₂O₂ to form Li⁺ ions and molecular oxygen and regenerate the reduced form of the redox mediator. See, for example, Radin, M. D. & Siegel, D. J. Charge transport in lithium peroxide: relevance for rechargeable metal-air batteries. Energy Environ. Sci. 6, 2370 (2013), which is incorporated by reference in its entirety. Many organic molecules like TEMPO, TDPA and TTF as well as inorganics like LiI and LiBr have been proposed as redox mediators. Lithium iodide (LiI) has received considerable attention owing to a number of studies suggesting high cycling performance^{14,15}. See, for example, Lim, H.-D. et al. Superior Rechargeability and Efficiency of Lithium-Oxygen Batteries: Hierarchical Air Electrode Architecture Combined with a Soluble Catalyst. Angew. Chem. Int. Ed. 53, 3926-3931 (2014); Liu, T. et al. Cycling Li—O₂ batteries via LiOH formation and decomposition. Science 350, 530-533 (2015); Bergner, B. J., Schurmann, A., Peppler, K., Garsuch, A. & Janek, J. TEMPO: A Mobile Catalyst for Rechargeable Li—O₂ Batteries. J. Am. Chem. Soc. 136, 15054-15064 (2014); Kwak, W.-J. et al. Li—O₂ cells with LiBr as an electrolyte and a redox mediator. Energy Env. Sci 9, 2334-2345 (2016); Kwak, W.-J. et al. Understanding the behavior of Li-oxygen cells containing LiI. J Mater Chem A 3, 8855-8864 (2015); Bergner, B. J. et al. Understanding the fundamentals of redox mediators in Li—O₂ batteries: a case study on nitroxides. Phys. Chem. Chem. Phys. 17, 31769-31779 (2015);

Bergner, B. J. et al. How To Improve Capacity and Cycling Stability for Next Generation Li—O₂ Batteries: Approach with a Solid Electrolyte and Elevated Redox Mediator Concentrations. ACS Appl. Mater. Interfaces 8, 7756-7765 (2016); Lee, D. J., Lee, H., Kim, Y.-J., Park, J.-K. & Kim, H.-T. Sustainable Redox Mediation for Lithium-Oxygen Batteries by a Composite Protective Layer on the Lithium-Metal Anode. Adv. Mater. 28, 857-863 (2016); Kundu, D., Black, R., Adams, B. & Nazar, L. F. A Highly Active Low Voltage Redox Mediator for Enhanced Rechargeability of Lithium-Oxygen Batteries. ACS Cent. Sci. 1, 510-515 (2015); and Torres, W. R., Herrera, S. E., Tesio, A. Y., Pozo, M. del & Calvo, E. J. Soluble TTF catalyst for the oxidation of cathode products in Li—Oxygen battery: A chemical scavenger. Electrochimica Acta 182, 1118-1123 (2015), each of which is incorporated by reference in its entirety. Lim et al. have suggested stable cycling with low overpotential over 900 cycles using LiI as a soluble redox mediator in a tetraglyme (G4) electrolyte with a CNT fibril electrode. In addition, Liu et al. have claimed to achieve 2000 cycles using LiI in a 1,2-dimethoxyethane (DME)-based electrolyte containing ˜5 v % H₂O with a reduced graphene oxide electrode and LiOH as the dominant discharge product. See, for example, Lim, H.-D. et al. Superior Rechargeability and Efficiency of Lithium-Oxygen Batteries: Hierarchical Air Electrode Architecture Combined with a Soluble Catalyst. Angew. Chem. Int. Ed. 53, 3926-3931 (2014); and Liu, T. et al. Cycling Li—O₂ batteries via LiOH formation and decomposition. Science 350, 530-533 (2015), each of which is incorporated by reference in its entirety. However, ambiguities exist in the influence of LiI on both the discharge and charge processes. See, for example, Kwak, W.-J. et al. Understanding the behavior of Li-oxygen cells containing LiI. J Mater Chem A 3, 8855-8864 (2015); Burke, C. M. et al. Implications of 4e⁻ Oxygen Reduction via Iodide Redox Mediation in Li—O₂ Batteries. ACS Energy Lett. 1, 747-756 (2016); Tulodziecki, M. et al. The role of iodide in the formation of lithium hydroxide in lithium-oxygen batteries. Energy Env. Sci (2017), Qiao, Y. et al. Unraveling the Complex Role of Iodide Additives in Li—O₂ Batteries. ACS Energy Lett. 1869-1878 (2017); and Li, Y. et al. Li—O₂ Cell with LiI (3-hydroxypropionitrile)₂ as a Redox Mediator: Insight into the Working Mechanism of I⁻ during Charge in Anhydrous Systems. J. Phys. Chem. Lett. 4218-4225 (2017), each of which is incorporated by reference in its entirety.

LiI addition in the electrolyte can change the dominant discharge product from Li₂O₂ to LiOH, LiOH.H₂O or LiOOH.H₂O by decreasing the pKₐ of water in the electrolyte. See, for example, Liu, T. et al. Cycling Li—O₂ batteries via LiOH formation and decomposition. Science 350, 530-533 (2015); Kwak, W.-J. et al. Understanding the behavior of Li-oxygen cells containing LiI. J Mater Chem A 3, 8855-8864 (2015); Burke, C. M. et al. Implications of 4e⁻ Oxygen Reduction via Iodide Redox Mediation in Li—O₂ Batteries. ACS Energy Lett. 1, 747-756 (2016); Tulodziecki, M. et al. The role of iodide in the formation of lithium hydroxide in lithium-oxygen batteries. Energy Env. Sci (2017); and iao, Y. et al. Unraveling the Complex Role of Iodide Additives in Li—O₂ Batteries. ACS Energy Lett. 1869-1878 (2017); and Zhu, Y. G. et al. Proton enhanced dynamic battery chemistry for aprotic lithium-oxygen batteries. Nat. Commun. 8, 14308 (2017), each of which is incorporated by reference in its entirety. Adding water to DME-based electrolytes up to 5000 ppm still results in Li₂O₂ on discharge when no LiI is present. On the other, while the discharge of a Li—O₂ battery forms Li₂O₂ in LiI-containing DME-based electrolytes without added water, the dominant discharge product can become LiOH (H₂O>˜500 ppm) or LiOOH (H₂O>˜5 v %) instead of Li₂O₂ with water addition in the electrolytes. See, for example, Burke, C. M. et al. Implications of 4e⁻ Oxygen Reduction via Iodide Redox Mediation in Li—O₂ Batteries. ACS Energy Lett. 1, 747-756 (2016); Tulodziecki, M. et al. The role of iodide in the formation of lithium hydroxide in lithium-oxygen batteries. Energy Env. Sci (2017); Qiao, Y. et al. Unraveling the Complex Role of Iodide Additives in Li—O2 Batteries. ACS Energy Lett. 1869-1878 (2017); Li, Y. et al. Li—O₂ Cell with LiI (3-hydroxypropionitrile)₂ as a Redox Mediator: Insight into the Working Mechanism of I⁻ during Charge in Anhydrous Systems. J. Phys. Chem. Lett. 4218-4225 (2017); Zhu, Y. G. et al. Proton enhanced dynamic battery chemistry for aprotic lithium-oxygen batteries. Nat. Commun. 8, 14308 (2017); and Kwabi, D. G. et al. The effect of water on discharge product growth and chemistry in Li—O₂ batteries. Phys Chem Chem Phys 18, 24944-24953 (2016), each of which is incorporated by reference in its entirety. Specifically, at low H₂O:LiI ratios (lower than 5), LiOH instead of Li₂O₂ has been observed, which is accompanied by the oxidation of iodide to triiodide, while at high H₂O:LiI ratios, a mixture of Li₂O₂, LiOOH—H₂O and LiOH—H₂O has been observed with no triiodide detected⁴⁴. The formation of LiOH and relevant products upon discharge is promoted by the lowered deprotonation energy of water due to the stronger solvation of water molecules by organic solvent molecules such as MeCN (Kwabi et al.) and the interactions between water molecules and anions such as I⁻. See, for example, Tulodziecki, M. et al. The role of iodide in the formation of lithium hydroxide in lithium-oxygen batteries. Energy Env. Sci (2017); and Kwabi, D. G. et al. The effect of water on discharge product growth and chemistry in Li—O₂ batteries. Phys Chem Chem Phys 18, 24944-24953 (2016), each of which is incorporated by reference in its entirety. These studies have shown that the major proton source for the formation of LiOH/LiOH—H₂O/LiOOH—H₂O is added water and not the decomposition of solvents such as DME, which is supported by a subsequent computational work showing water as a more energetically favorable proton source for the formation of LiOH than DME. On the other hand, Qiao et al. and Kwak et al. have suggested iodide-catalyzed decomposition of G4 to promote the formation of LiOH based on the observation of greater LiOH with increasing amounts of LiI added to the electrolyte. This apparent discrepancy can be explained by the addition of water associated with the LiI used (Qiao et al. with dried LiI having >98%, Sigma Aldrich under vacuum at 80° C. overnight and Kwak et al. with anhydrous LiI, Sigma-Aldrich with no mention of drying).

I₂ (which is more oxidizing than I₃⁻) is required to oxidize Li₂O₂ and generate molecular O₂ in anhydrous DME and G4. Ambiguities exist in what oxidized iodide species can oxidize Li₂O₂ and LiOH and what oxidation products, such as O₂, are formed. For example, Qiao et al. have reported that I₃⁻ can oxidize peroxide-like species (in part Li₂O₂) to form O₂ with water addition up to 30 v % in G4. See, for example, Qiao, Y. et al. Unraveling the Complex Role of Iodide Additives in Li—O₂ Batteries. ACS Energy Lett. 1869-1878 (2017), which is incorporated by reference in its entirety. On the other hand, Zhu et al. discuss that the oxidation of Li₂O₂ requires the formation of I₂ while LiOOH—H₂O formed in diglyme (G2) and DMSO with 9.1 v % water can be oxidized to form O₂ by I₃⁻. See, for example, Zhu, Y. G. et al. Proton enhanced dynamic battery chemistry for aprotic lithium-oxygen batteries. Nat. Commun. 8, 14308 (2017), which is incorporated by reference in its entirety. Moreover, Liu et al¹⁵ have suggested that I₃⁻ can oxidize LiOH formed in DME and G4 with the addition of ˜5 v % water to generate O₂. In addition, Zhu et al. have suggested that LiOH was oxidized to O2 by 12. See, for example, Zhu, Y. G. et al. Proton enhanced dynamic battery chemistry for aprotic lithium-oxygen batteries. Nat. Commun. 8, 14308 (2017), which is incorporated by reference in its entirety. However, the concept of LiOH oxidation to O₂ by I₃⁻ is rebutted by Viswanathan et al. arguing the oxidation of LiOH by I₃⁻ as thermodynamically uphill in DME and Shen et al. suggesting that observed charge capacity is from iodine redox and inactive LiOH is accumulated. See, for example, Viswanathan, V. et al. Comment on ‘Cycling Li—O₂ batteries via LiOH formation and decomposition’. Science 352, 667-667 (2016); and Shen, Y., Zhang, W., Chou, S.-L. & Dou, S.-X. Comment on ‘Cycling Li—O2 batteries via LiOH formation and decomposition’. Science 352, 667-667 (2016), each of which has been incorporated by reference in its entirety. Furthermore, Qiao et al. argued that LiOH was inactive in the presence of I₃⁻ and I₂, and Burke et al. have proposed that LiOH is oxidized irreversibly to lithium iodate (LiIO₃) by I₂ in DME, which is in agreement with Liu et al. noting LiIO₃ formation from LiOH formed in a 3 wt % water/DME solution. See, for example, Burke, C. M. et al. Implications of 4e⁻ Oxygen Reduction via Iodide Redox Mediation in Li—O₂ Batteries. ACS Energy Lett. 1, 747-756 (2016); Qiao, Y. et al. Unraveling the Complex Role of Iodide Additives in Li—O₂ Batteries. ACS Energy Lett. 1869-1878 (2017); and Liu, T. et al. Response to Comment on “Cycling Li—O₂ batteries via LiOH formation and decomposition”. Science 352, 667-667 (2016),

The discrepancies found for the oxidation of Li₂O₂ and LiOH by I₃⁻/I₂ in previous work may result from several factors. First, some previous claims of O₂ evolution have not been supported by quantification of reaction products to ensure the amount of oxygen detected as the dominant path of the reaction but not from cell leakage or H₂O₂ contamination of the solvents. Second, the oxidizing power of I₃⁻ and I₂ against Li₂O₂ or LiOH can be solvent-dependent. Generally speaking, I⁻ ions go through two distinct redox transitions during oxidation in aprotic electrolytes, having first iodide anions (I⁻) oxidized to form triiodide (I₃⁻) and I₃⁻ oxidized to form iodine (I₂), where the potentials of the I⁻/I₃⁻ and I₃⁻/I₂ redox transitions can be significantly influenced by solvent. While it has been previously suggested that changes in these redox potentials may be important for the performance of LiI as a redox mediator in Li—O₂ batteries, this effect has not been studied systematically. This concept is supported by a very recent study, where Nakanishi et al.⁵⁴ have shown that the thermodynamic shifts in the iodide redox on a lithium scale due to the effect of solvent and lithium concentration can change the oxidizing power of I₃⁻ against Li₂O₂ in 1 M and 2.8 M LiTFSI electrolytes in DMSO and G4 with 0.1 M LiI. See, for example, Nakanishi, A. et al. Electrolyte Composition in Li/O₂ Batteries with LiI Redox Mediators: Solvation Effects on Redox Potentials and Implications for Redox Shuttling. J. Phys. Chem. C (2018), which is incorporated by reference in its entirety.

The role of LiI on the charging process of Li—O₂ batteries can be examined by systematically studying the solvent-dependent oxidizing power of I₃⁻/I⁻ and I₂/I₃⁻ towards Li₂O₂ and LiOH. The oxidizing power of I₃⁻/I⁻ and I₂/I₃⁻ towards Li₂O₂ and LiOH was examined chemically by examining the consumption of I₃⁻ upon addition of synthetic Li₂O₂ (from disproportionation), where the liquid reaction product was examined using UV-vis spectroscopy and ¹H NMR, the solid reaction products were studied by Raman spectroscopy and XRD and the gaseous products were assessed using gas chromatography. In addition, the role of I⁻ on the charging of Li—O₂ batteries and LiOH-pre-loaded cells was examined using DEMS, where the amount of oxygen release was quantified. It is shown here that I₃⁻/I⁻ potentials increase with greater solvent AN, suggesting stronger solvation of I⁻ while I₂/I₃⁻ redox potentials are largely solvent independent. Therefore, stronger solvation of Li⁺ and I⁻ ions in solvents such as DMA, DMSO and Me-Im can increase the oxidizing power of I₃⁻/I⁻, allowing I₃⁻ to effectively oxidize Li₂O₂ to generate O₂, which was supported by chemical and electrochemical experiments. On the other hand, in solvents where both I⁻ and Li⁺ are weakly solvated such as glymes, I₃⁻/I⁻ redox potentials are not high enough to oxidize Li₂O₂ and the more oxidizing I₂ is required for the oxidation of Li₂O₂ to O2 to proceed. The oxidation of LiOH by I₃⁻ was also found to be solvent dependent, where no reaction was observed in G4, DME and pyridine while the reaction proceeded to completion in DMA, DMSO and Me-Im where the I₃⁻/I⁻ redox potential was above ˜3.1 V_{Li}. It is shown here that the reaction between LiOH and oxidized iodide species produced water and a hypoiodite (IO⁻) intermediate, which could either disproportionate to form LiIO₃ or attack solvent molecules and result in decomposition products such as dimethyl sulfone (DMSO₂). From GC of ex-situ reactions and DEMS during the charging of pre-loaded LiOH electrodes, no O₂ gas evolution was observed during the reaction between LiOH and oxidized iodide species. The selectivity between O₂ and the thermodynamically preferred LiIO₃ can be governed by a kinetic barrier relating to O—O bond dissociation and this kinetic barrier prevents IO⁻ formation, allowing for the evolution of gaseous O₂ when oxidizing Li₂O₂, which was supported by reactions between oxidized iodide species and KO₂/Li₂O.

### Experimental

### I. Chemicals

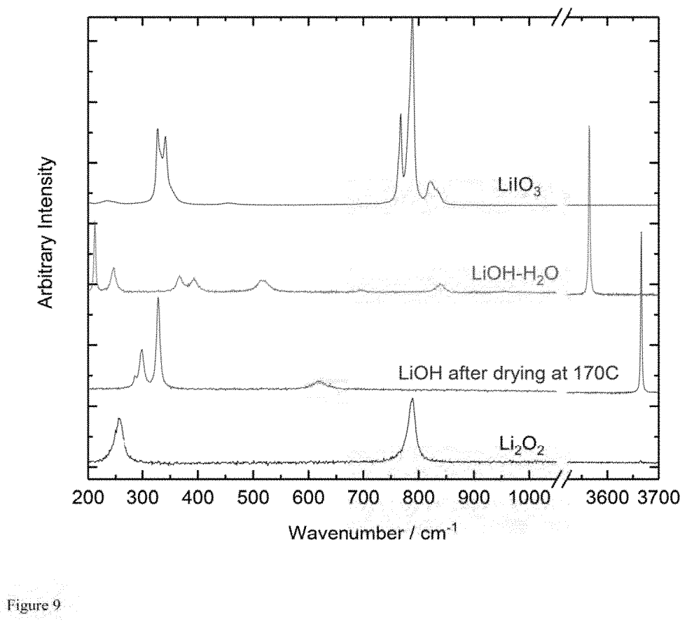

High purity dimethyl sulfoxide (“DMSO”, Sigma Aldrich, anhydrous, >99.9%), diethylene glycol dimethyl ether (“G2”, Sigma Aldrich, anhydrous, 99.5%), N,N-dimethylacetamide (“DMA”, Sigma Aldrich, anhydrous, 99.8%), 1-methylimidazole (“Me-Im”, Sigma Aldrich, 99%), pyridine (Sigma Aldrich, anhydrous, 99.8%) and tetraethylene glycol dimethyl ether (Sigma Aldrich, >99%) were purchased and dried over molecular sieves for at least a week before use. 1,2-dimethoxyethane (DME) was purchased from Acros and was degassed and dried using a Glass Contour Solvent Purification System built by SGWater USA, LLC. Lithium bis(trifluoromethanesulfonyl)imide (“LiTFSI”, 99.99% extra dry grade from Solvay) was used as received. High purity LiI (ultra dry, 99.999% pure), I₂ (99.9985% pure), Li₂O₂ (90%), Li₂O (99.5%) and decamethylferrocene (“Me₁₀Fc”, 99%) chemicals were ordered from Alfa Aesar and were used as received. LiOH (anhydrous, 99.995%) was purchased from Alfa Aesar and was further dried under vacuum for 24 hrs at 170° C. to ensure only the anhydrous phase remained (see FIG. 9). KO₂ (99% pure) powder was purchased from Sigma Aldrich and was used as received.

All chemicals were stored in an argon-filled glovebox (MBraun, USA) with H₂O and O₂ content of <0.1 ppm. Electrolytes were prepared by dissolution of a desired amount of salts in the solvent with molarity determined by the volume of solvent added. The total H₂O content in the solvents and electrolytes was checked using a C20 compact Karl Fisher coulometer from Mettler Toledo and for the dry solvent it was <20 ppm for ˜2 g of sample. A 20 wt % solution of LiTFSI in DME was found to have a slightly higher water content of 21 ppm (compared with 3.0 ppm for the pure DME solvent). Solutions of 0.2 M LiI in all solvents were clear, indicating the absence of H₂O₂ contamination, which can be of particular concern in glymes.

Due to the low purity of commercially available Li₂O₂ (90%), for most experiments, Li₂O₂ was first synthesized through the well-known disproportionation reaction between KO₂ and Li-containing salt⁴:

2LiTFSI+2KO₂→2KTFSI+Li₂O₂+O₂ (1)

In all experiments, a two times excess of LiTFSI was used, the reaction occurred in the solvent being studied and the reaction was allowed to proceed for one hour with stirring to ensure complete production of Li₂O₂. The resulting solution of unconsumed LiTFSI and produced KTFSI as well as the precipitated Li₂O₂ was used directly without additional processing/washing. The presence of LiTFSI/KTFSI was assumed to have a negligible influence on subsequent reactions.

II. Redox Potential Measurements of I₃⁻/I⁻ and I₂/I₃⁻ Redox Couples Using Cyclic Voltammograms

Cyclic voltammograms (CVs) were collected of solutions of 0.5M LiTFSI+10 mM LiI collected at 100 mVps under argon environment in each of the considered solvents. Electrolytes were prepared in an Argon-filled glove box (MBraun, <0.1 ppm H₂O, <0.1 ppm O₂) and transferred to a second Argon-filled glovebox directly through a shared antechamber (MBraun, <0.1 ppm H₂O, <0.10% O₂). The electrolyte was bubbled with Argon for at least 30 minutes prior to beginning electrochemistry. Due to the volatility of DME, for the DME experiment, the argon was first saturated with DME vapor by bubbling the Argon through pure DME prior to going to the electrolyte. The working macroelectrode was platinum and either a Li metal (G4, DME, DMSO) or lithium titanium oxide (pyridine, DMA, Me-Im) counter electrode was used. A fritted Ag/Ag⁺ reference electrode (0.1M TBAClO₄+10 mM AgNO₃ in MeCN) was used and following collection of CVs, 2 mM Me₁₀Fc was added to the solution and CVs were collected to determine the Me₁₀Fc half-wave potential. Li⁺/Li potentials were determined in G4, DME, DMA and DMSO using a piece of Li metal. See Table 2.

TABLE 2
Estimated half-wave potentials of I⁻/I₃⁻ and I₃⁻/I₂ vs Me₁₀Fc

| Solvent | I⁻/I₃⁻ vs Me₁₀Fc | I₃⁻/I₂ vs Me₁₀Fc |
|---|---|---|
| TEGDME | 0.003 | 0.653 |
| DME | 0.018 | 0.632 |
| Pyridine | 0.286 | 0.496 |
| DMA | 0.069 | 0.648 |
| DMSO | 0.228 | 0.629 |
| Me-Im | 0.299 | 0.748 |

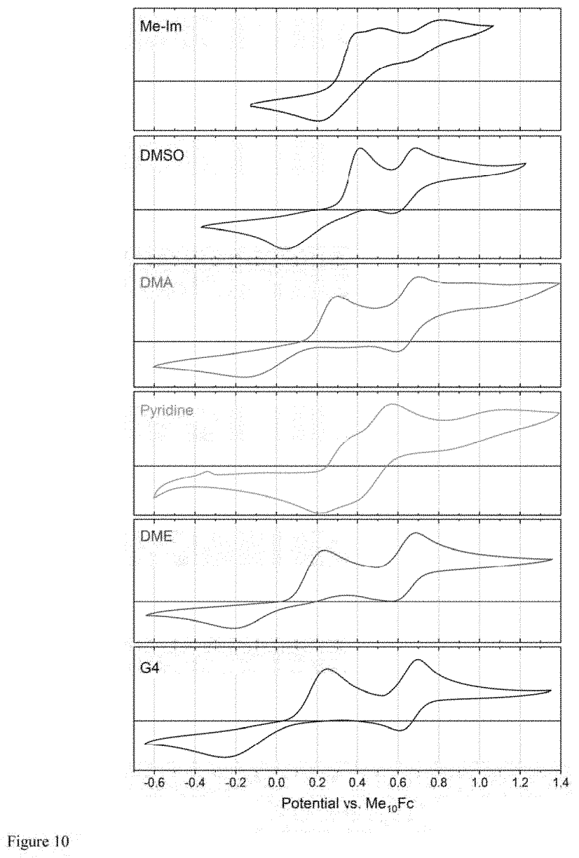

In addition to the two expected peaks associated with the I⁻/I₃⁻ and I₃⁻/I₂ redox transitions, both pyridine and Me-Im exhibit additional redox features (FIG. 10). Pyridine is known to in literature to form stable complexes with oxidized forms of iodide as well as adsorb strongly on platinum surfaces. One can therefore attribute the small peak at ˜−0.35V vs Me₁₀Fc to an adsorption/desorption process (total charge passed ˜1.2×10⁻⁷ C) and the additional features in the I₃⁻/I⁻ and I₂/I₃⁻ redox peaks to the formation of iodine-solvent complexes. Given the similarities in structure between Me-Im and pyridine, we suggest that similar iodine-solvent complexes are also possible in Me-Im and would account for the additional feature observed in the anodic sweep of the Me-Im CV. Since neither pyridine nor Me-Im are likely solvent candidates for lithium oxygen batteries due to instability issues, the precise origin and implications of these additional redox features in the presented CVs was not investigated further.

III. Using I⁻/I⁻ and I₃⁻/I₂ for Chemical Li₂O₂ and LiOH Oxidation

In an argon-filled glovebox (MBraun, O₂, H₂O<0.1 ppm), solutions of I₃⁻ (0.2M LiI+50 mM I₂) and I₂ (50 mM I₂) were first prepared in each solvent and allowed to fully dissolve under stirring. For studies of Li₂O₂, a two times excess of Li₂O₂ was first synthesized through disproportionation using 1 mL of the solvent to be studied and the reaction was allowed to proceed under stirring for ˜1 hour. For studies of LiOH, a two times excess of LiOH powder was added to 1 mL of solvent and allowed to reach equilibrium under stirring for ˜1 hour. Next, 1 mL of the I₃⁻/I₂ solution was added to the vial with Li₂O₂/LiOH and 1 mL of solvent. The reaction was allowed to take place under stirring for 24 hours, following which, the solid product was allowed to settle for 1 hour and the liquid and solid phases were separated. This ex-situ, chemical analog approach has been used extensively previously and has been very effective at isolating a chemical reaction to enable its independent study.

### IV. Physical Characterization of Reaction Liquids, Solids and Gases

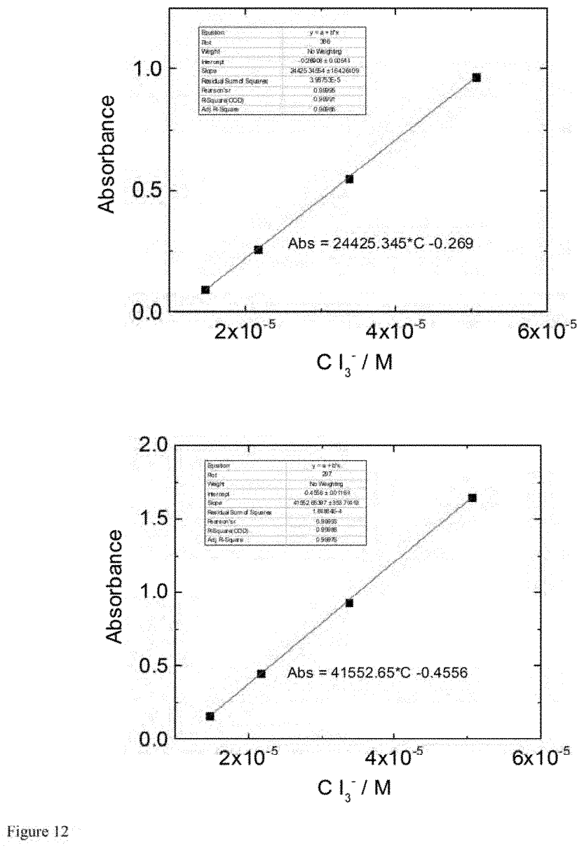

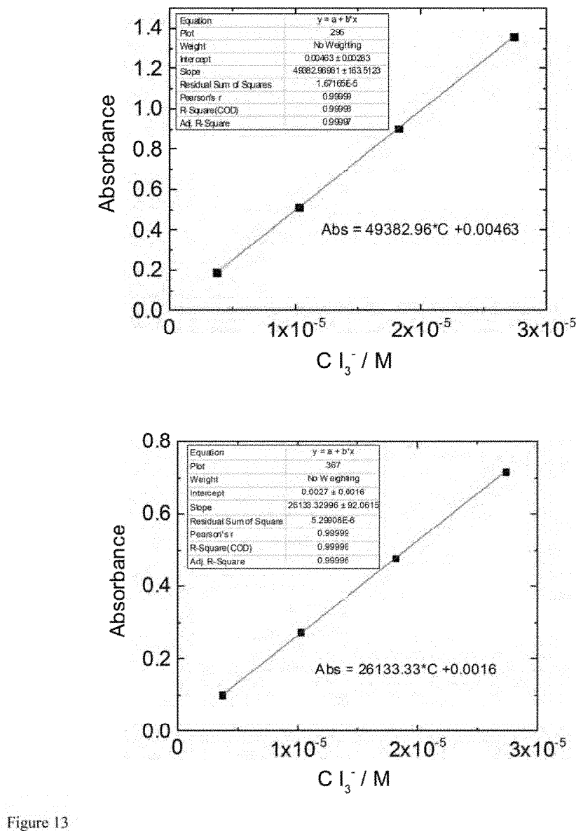

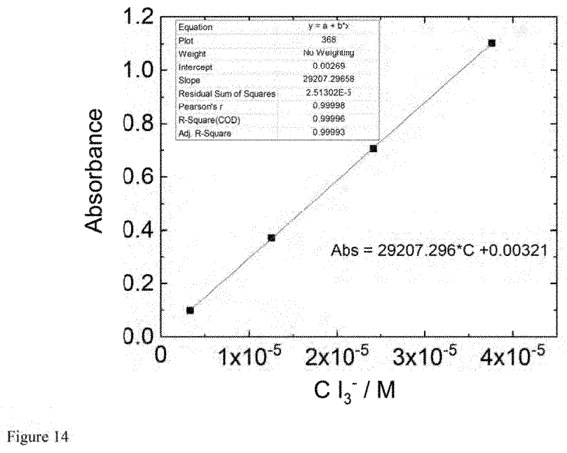

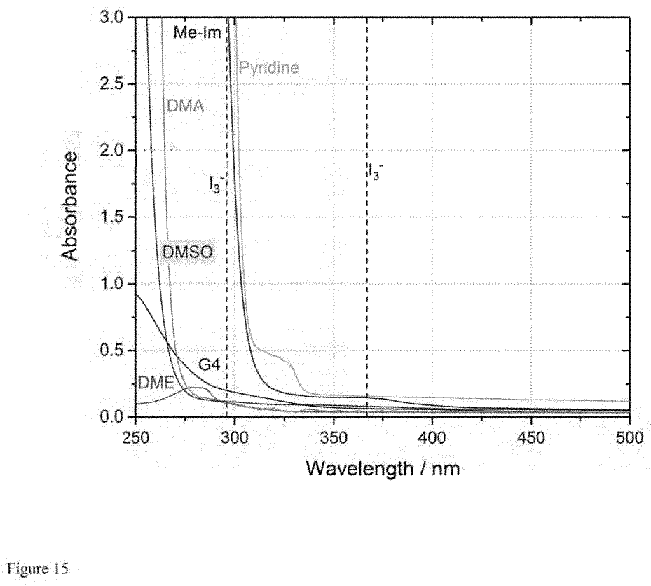

UV-Vis was performed using a Perkin Elmer Lambda 1050 UV/VIS/NIR Spectrophotometer. The pure solvent (e.g. G4, DME, etc.) was used as the blank solution, except in assessments of the pure solvent absorbance where no blank was used. Solutions were prepared in an Argon glovebox and sealed in a quartz cuvette used for data collection, preventing air exposure. Due to high molar absorptivity of I₃⁻, the solutions with I₃⁻ were diluted in pure solvent so that the intensity of I₃⁻ absorption signals (at ˜293 nm and ˜364 nm) were within the calibration range (FIG. 12-14). The concentrations of triiodide were calculated based on the absorption intensity at the wavelength of the peak absorbance of the calibration curves. In the case where both peaks were distinguishable above the solvent's inherent absorbance (FIG. 15), the average of the concentration determined by both peaks was used. The absorption spectra in the figures are rescaled (arbitrary units) in order to visualize the difference in I₃⁻ concentration for different solutions. Thus, a high concentration of I₃⁻ corresponds to high absorption at wavelengths 293 nm and 364 nm and vice versa. The scale factors and the calculation of I₃⁻ concentrations are summarized in Table 1. Dilutions were calculated based on a mass balance of the added solvent and I₃⁻ solution. Error bars for the diluted samples were estimated based on an error of +/−0.5 mg in each weight measurement (+/−0.1 mg from the accuracy of the balance with additional error incurred due to a small amount of evaporation). In the case of determining the concentration of I₂ in solution, the solution was first mixed with a ˜4 times excess of LiI to chemically form I₃⁻ in solution through the association of I₂ and I⁻. The resulting I₃⁻ concentration was then determined using the as described above.

TABLE 1
UV-vis scaling factors applied in manuscript figures

| | | | Scale in |
|---|---|---|---|
| FIG. | Data | Dilutions | FIG. |
| 22 | G4 | D1 - 51.61 mg into 1983.49 mg pure G4 | 1 |
| | before | D2 - 43.98 mg into 2967.27 mg pure G4 | |
| 22 | G4 | D1 - 50.48 mg into 1991.72 mg pure G4 | 1 |
| | after | D2 - 49.75 mg into 2976.53 mg pure G4 | |
| 22 | DME | D1 - 43.71 mg into 1751.37 mg pure DME | 0.955 |
| | before | D2 - 41.1 mg into 2614.28 mg pure DME | |
| 22 | DME | D1 - 90.79 mg into 1750.39 mg pure DME | 0.671 |
| | after | D2 - 69.02 mg into 2611.43 mg pure DME | |
| 22 | Pyridine | D1 - 49.3 mg into 1953.19 mg pure Pyridine | 1.254 |
| | before | D2 - 46.18 mg into 2930.22 mg pure Pyridine | |
| 22 | Pyridine | D1 - 49.26 mg into 1960.9 mg pure Pyridine | 0.762 |
| | after | D2 - 44.68 mg into 2932.65 mg pure Pyridine | |
| 22 | DMA | Starting I₃⁻ concentration from mass balance | 2.34 |
| | before | | |
| 22 | DMA | 0.4 mL into 2.6 mL pure DMA | 0.00417 |
| | after | (scaled to reflect deviation from usual dilution) | |
| 22 | DMSO | Starting I₃⁻ concentration from mass balance | 0.641 |
| | before | | |
| 22 | DMSO | 0.4 mL into 2.6 mL pure DMSO | 0.00417 |
| | after | (scaled to reflect deviation from usual dilution) | |
| 22 | Me-Im | Starting I₃⁻ concentration from mass balance | 1.468 |
| | before | | |
| 22 | Me-Im | 0.4 mL into 2.6 mL pure Me-Im | 0.00417 |
| | after | (scaled to reflect deviation from usual dilution) | |

Iodometric titration was performed with a prepared 5 mM thiosulfate solution (anhydrous 99.99% Sigma-Aldrich, stored in desiccator) using a 50 mL burette (Class A, graduation 0.10 mL, tolerance ±0.05 mL from VWR) and starch indicator (1% w/v of Amylodextrin) in aqueous solution (18.2 MΩ·cm, Millipore). The thiosulfate solution was first standardized with a KIO₃ (99.995% pure from Sigma Aldrich) solution of a known concentration in three separate probes. 10 mL of KOI₃ solution was added to Erlenmeyer flask (250 ml), to which ˜100 mg of KI (Bioultra >99.5% TA from Sigma Aldrich) and 2 mL of 6 M H₂SO₄ was added. The obtained I₃⁻ solution was immediately titrated with thiosulfate solution. Just before the end-point, indicated by a light straw-like color, the starch solution was added, resulting in a change of color to a dark red/brown (this color change is due to branched Amylodextrin rather than blue when using straight chain amylose). The thiosulfate solution was prepared fresh the same day as the titration experiment. Titrations to determine LiIO₃ formed through reactions in I₃⁻ were performed by allowing the reaction to reach completion (indicated by the complete consumption of I₃⁻ based on the solution becoming colorless). The entirety of the solid and liquid phases were then transferred to an Erlenmeyer flask (rinsing the reaction vial three times with DI H₂O) and then titrated as per above.

Raman spectroscopy was performed on a LabRAM HR800 microscope (Horiba Jobin Yvon) using an external 20 mW He:Ne 633 nm laser (Horiba, Jobin Yvon) and, focused with a 50× long working distance objective and a 10-0.3 neutral density filter. A silicon substrate was used to calibrate the Raman shift. An air-tight cell was used for powders, and all samples preparation was done in an argon-filled glovebox. Liquid samples were tightly sealed in a 3 mL vial and assessed using a 10× working length. Reference spectra of Li₂O₂, LiOH, LiOH—H₂O and LiIO₃ are available in FIG. 9.

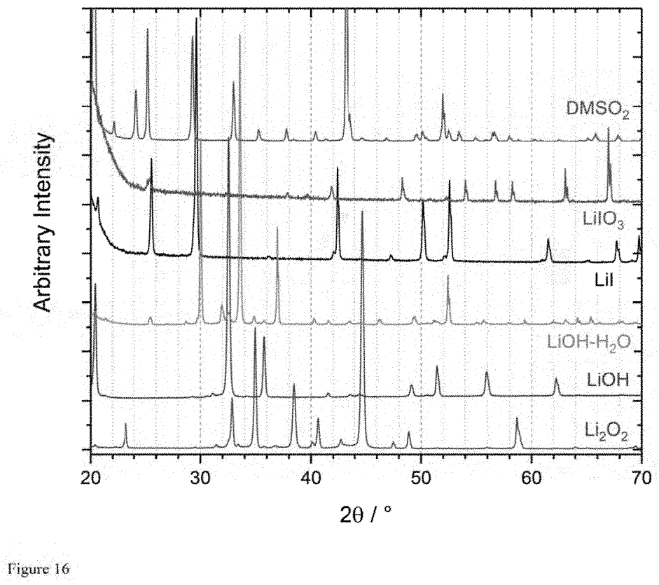

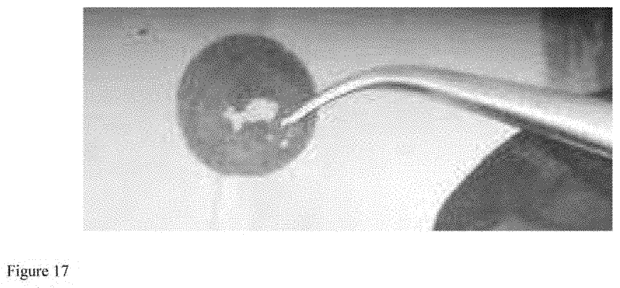

XRD of discharged products and powders was performed on a Rigaku Smartlab diffractometer in Bragg-Brentano geometry. A domed air tight XRD cell holder from Panalytical was used to prevent exposing the electrodes to ambient atmosphere. Reference spectra for LiOH, LiOH—H₂O, Li₂O₂, LiI, DMSO₂ and LiIO₃ are available in FIG. 16.

¹H NMR was performed on a Bruker AVANCE and Bruker AVANCE III-400 MHz nuclear magnetic resonance (NMR) spectrometers. Samples were prepared by mixing 0.5 mL of the sample+0.1 mL of DMSO-D6 (for NMR locking)+10 μL of internal reference (either MeCN (Acetonitrile anhydrous, 99.8%, Sigma-Aldrich dried over molecular sieves) or 1,4-dioxane (anhydrous, 99.8%, Sigma-Aldrich, dried over molecular sieves) chosen to avoid overlap with peaks of interest).

Gas chromatography (GC) was performed using Argon (5.0, Praxair) as a carrier gas flowing at ˜12 sccm, through a glass cell. Cell was purged with Ar for 1 hour, during the last 15 minutes of which, a background spectrum was taken. The reaction compartment contained 15 mL of DMSO with either Li₂O₂ formed from disproportionation or commercial LiOH suspended in solution with active stirring. 2 mL of I₃⁻ solution (0.2 M LiI+50 mM I₂ in DMSO) was injected using a syringe which was sealed onto a port of the glass reaction cell prior to purging without exposure to the ambient. 1 mL of gas sample was injected into a gas chromatograph (GC, SRI 8610C in the Multi-Gas #3 configuration). Samples were injected after 2, 22, 42 and 62 minutes of reaction. GC was calibrated using a 2500 ppm O₂+17000 ppm N₂ in Argon gas mixture.

### V. Li—O₂ Cell Assembly and Tests

Li—O₂ cells consisted of a lithium metal negative electrode (Chemetall, Germany, 15 mm in diameter) and a carbon paper with gas diffusion layer positive electrode (FuelCellsEtc, F2GDL, LOT: TST008, 12.5 mm diameter). The carbon paper was dried for 24 hours at 90° C. under vacuum and transferred to a glove box (H₂O<0.1 ppm, O₂<0.1 ppm, Mbraun, USA) without exposure to ambient air. Glass fiber (Whatman, GF-A/GF-F, 17 mm diameter) was dried at 150° C. under vacuum overnight and was transferred to the glove box without exposure to the ambient. Lithium-ion conducting glass-ceramic electrolyte (19 mm diameter, 150 μm thick, LICGC, Ohara Corp) was dried at 80° C. under vacuum overnight. Cells were constructed by placing a single piece of glass fiber separator on top of the lithium, adding 120 μL of liquid electrolyte, followed by the lithium-ion conducting glass-ceramic electrolyte, another piece of glass fiber separator, another 120 μL of liquid electrolyte and finally the carbon paper positive electrode. No 316 stainless steel current collector was used to avoid a reaction which was observed between the 316 stainless steel and iodine formed during charge in some cells (see FIG. 16). The origin of this corrosion is not fully understood and is worthy of further investigation as it poses challenges for the practical implementation of LiI as a redox mediator, however, adequate performance over a single charging cycle was acquired by simply avoiding the use of the current collector and restricting the electrolyte contact with the 316 stainless steel spring as much as possible. For cells not analyzed using DEMS, following assembly, cells were transferred to a connected second argon glove box (Mbrau₂n, USA, H₂O<0.1 ppm, O₂<1%) without exposure to air and pressurized with dry O₂ (Airgas, 99.999% pure, H₂O/CO/CO₂<0.5 ppm) to 25 psi (gauge) to ensure that an adequate amount of O2 was available. The oxygen pressure in the cell was measured using a pressure gauge during the experiments to confirm proper cell sealing. Electrochemical tests were conducted using a Biologic VMP3.

LiOH preloaded electrodes were prepared by drop casting a slurry (70% wt Vulcan Carbon, 20% wt LiOH, 10% wt PTFE) onto neat carbon paper (Toray TGP-H-60, 12.5 mm diameter). The vulcan carbon (VC), PTFE and carbon paper were dried at 80° C. under vacuum for 24 hours and transferred to a glovebox (Mbraun, USA, H₂O<0.1 ppm, O₂<1%) without exposure to the ambient. The LiOH and VC were ground into a homogenous mixture using a mortar and pestle then added to a suspension of PTFE in DME. After allowing the mixture to stir for 1 hour, the slurry was drop cast 50 μL at a time until the desired mass loading was achieved. Individual 12.5 mm pieces of carbon paper were weighed before and after drop casting to determine the amount of mixture deposited. Typical loadings of the VC/LiOH/PTFE mixture were 3.9-5.0 mg per electrode (1.267 cm²). Electrodes were additionally dried under vacuum for ˜15 minutes to remove residual DME.

### VI. Differential Electrochemical Mass Spectroscopy of Cells During Charging

A custom-made DEMS setup based on a design by McCloskey et al., which has been reported previously, was used for assessing gas evolution during the charging process. O₂, CO, CO₂, H₂ and H₂O evolution during charge was quantified at 20 minute intervals using a mass spectrometer coupled with pressure monitoring. Details of DEMS and cell technical construction are available online. Argon (Airgas, 99.999% pure, O₂, H₂O, CO₂<1 ppm) was used as a carrier gas. In all cells, no detectable quantities of CO, H₂ and H₂O were detected, so these values are omitted from all plots. Cells were prepared as described above. Li—O₂ cells were first discharged under O₂ environment for 20 hours at 0.05 mA/cm². The cell environment was then changed to Argon by evacuating the cell and refilling it with Argon five times and charged at 0.1 mA/cm² to a cut-off voltage of 4.5 V_{Li}. LiOH− preloaded electrodes were charged under argon environment at 0.1 mA/cm² to a cut-off voltage of 4.5 V_{Li}.

### Results and Discussion

VII. Solvent-Dependent Potential of I₃⁻/I⁻

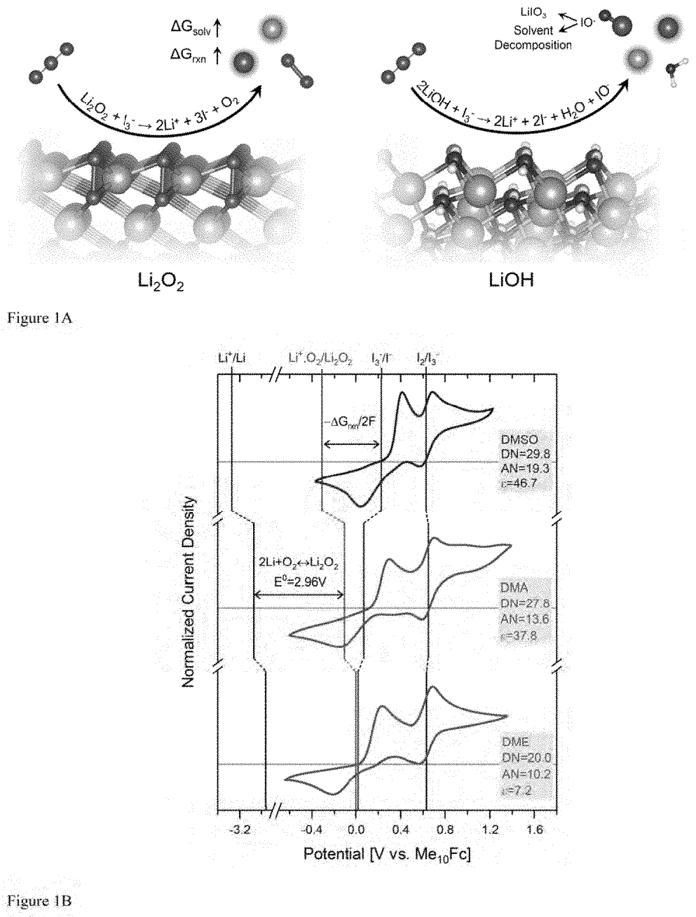

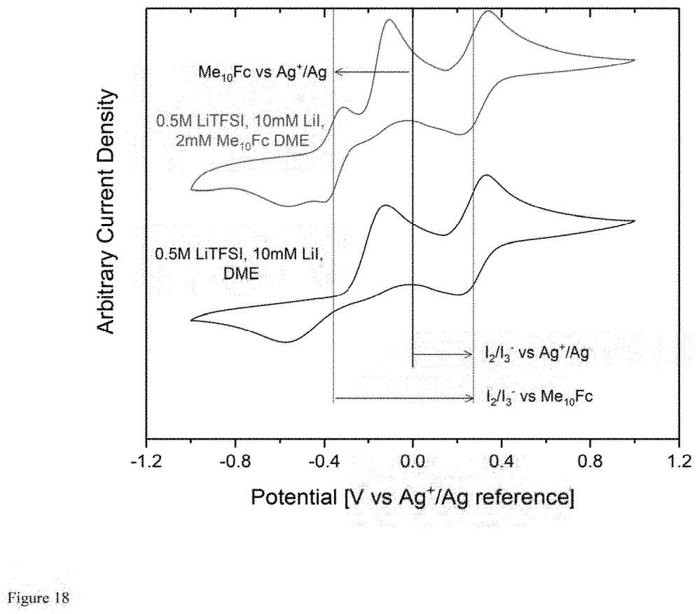

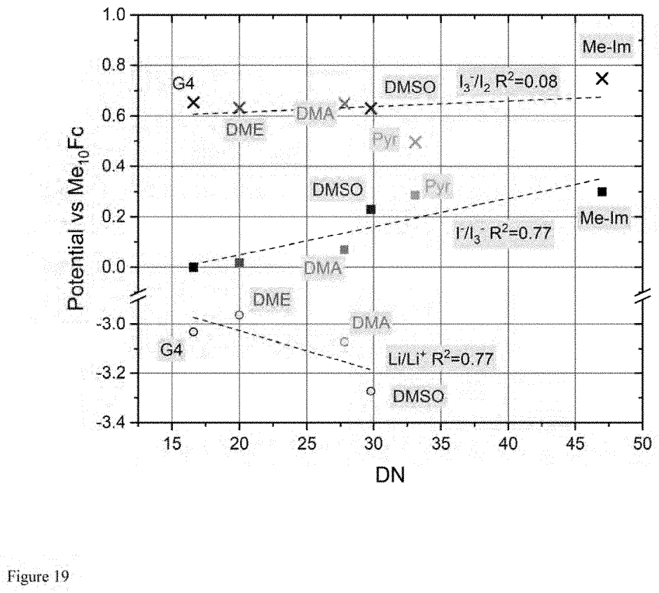

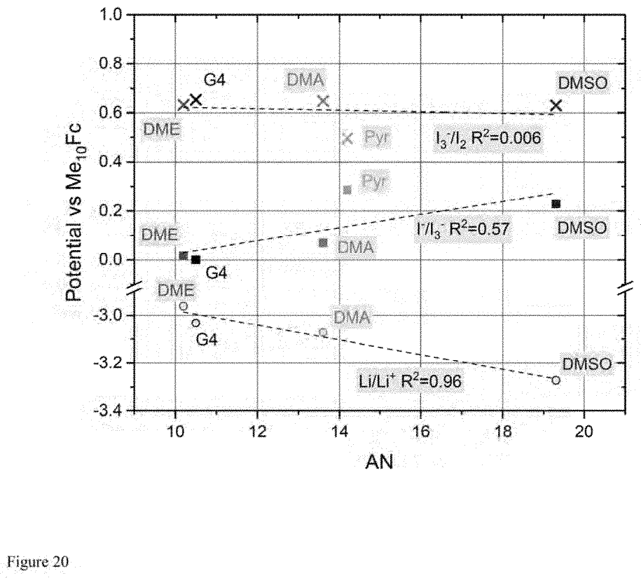

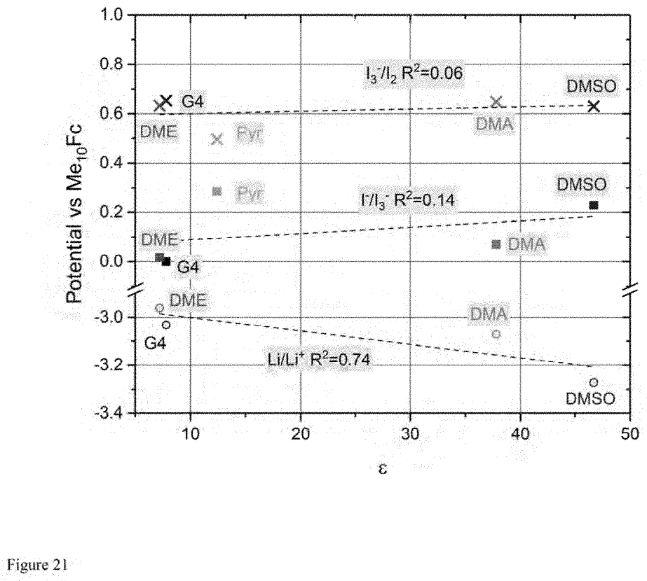

The redox potential of I₃⁻/I⁻ was shown to shift positively against the solvent-insensitive reference potential of decamethylferrocene (Me₁₀Fc) from DME, DMA and DMSO while that of I₃⁻/I₂ remained nearly constant, as shown in FIG. 1B. The reduction and oxidation peaks of the I₃⁻/I⁻ (centered between 0.02 and 0.23 V_{Me10Fc}) and I₃⁻/I₂ (centered at ˜0.64 V_{Me10Fc}) couples were observed in cyclic voltammograms (CVs), from which the redox potential of I₃⁻/I⁻ was obtained by averaging the reduction and oxidation peak centers (FIG. 1, FIG. 10). These measurements were collected using a Pt macroelectrode as the working electrode and Ag⁺/Ag as the reference electrode in solvents containing 10 mM LiI with 0.5 M LiTFSI under an argon environment, where the Ag⁺/Ag reference electrode potential scale was converted to that of Me₁₀Fc following previous work⁻⁶ (FIG. 18) for each solvent. The shifts in the potential of the I₃⁻/I⁻ redox were plotted against reported Guttmann acceptor number (AN), Guttmann donor number (DN) and dielectric constant for these solvents (FIGS. 19-21). Here the positive shift in the potential of I₃⁻/I⁻ can be attributed to increasing thermodynamic stability of the I⁻ ion through solvation via higher Guttmann acceptor number (AN), dielectric constant and possibly through the formation of ion pairs with Li⁺⁴⁷. Solvation effects can more significantly influence I⁻ ions as there are three I⁻ ions for each I₃⁻ and the larger I₃⁻ ions (which are more charge diffuse) might interact with the solvent less. Following the same argument, the solvent-insensitive redox potential of I₂/I₃⁻ can be attributed to the weak solvation of I₃⁻ and I₂ in the considered solvents.

Such positive shifts in the potential of I₃⁻/I⁻ increases its oxidizing power towards Li₂O₂ (or the thermodynamic driving force to oxidize Li₂O₂) to evolve O₂ (Li₂O₂=>2Li++O₂+2e⁻), with a trend of G4<DME<Pyridine<DMA<DMSO<Me-Im. Considering that the Li⁺/Li potential decreases from DME, DMA to DMSO on the Me₁₀Fc scale due to stronger lithium solvation with high Guttmann donor number (DN) and high dielectric constant (the Born model), and that the free energy of O2 and Li₂O₂ are solvent independent, the redox potential of Li⁺,O₂/Li₂O₂ would follow the same trend as the Li⁺/Li potential, decreasing from 0.00 V_{Me10Fc} in DME to −0.11 V_{Me10Fc} in DMA and −0.31 V_{Me10Fc} in DMSO. Therefore, as the potential of I₃⁻/I⁻ shifts to higher values from DME, DMA to DMSO and that of Li⁺,O₂/Li₂O₂ moves to lower values on the Me₁₀Fc scale, the oxidative power of I₃⁻/I⁻ towards Li₂O₂ oxidation increases, from −0.04 eV in DME, to −0.36 eV in DMA and −1.08 eV in DMSO. Using the linear free energy relationship that links thermodynamics and kinetics, one would expect that the kinetics of I₃⁻ against Li₂O₂ oxidation would significantly increase from DME, DMA to DMSO.

VIII. Solvent-Dependent Oxidizing Power of I₃⁻/I⁻ and I₂/I₃⁻ Towards Li₂O₂

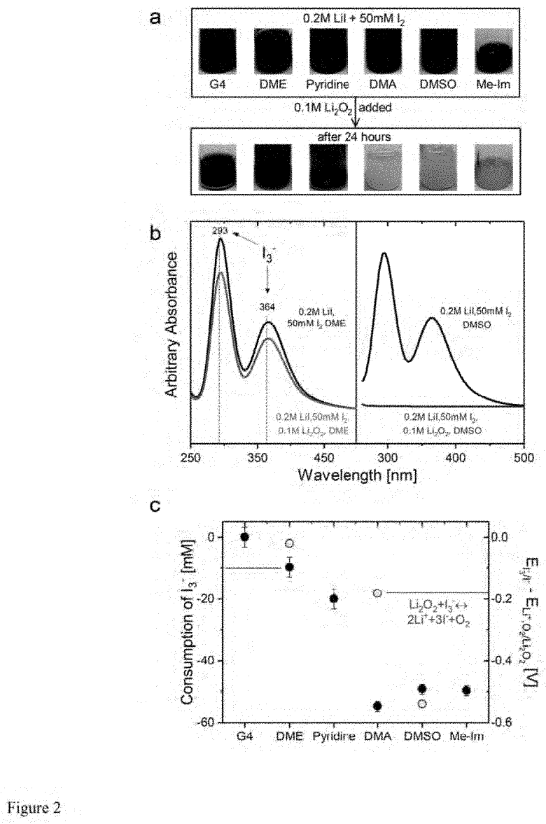

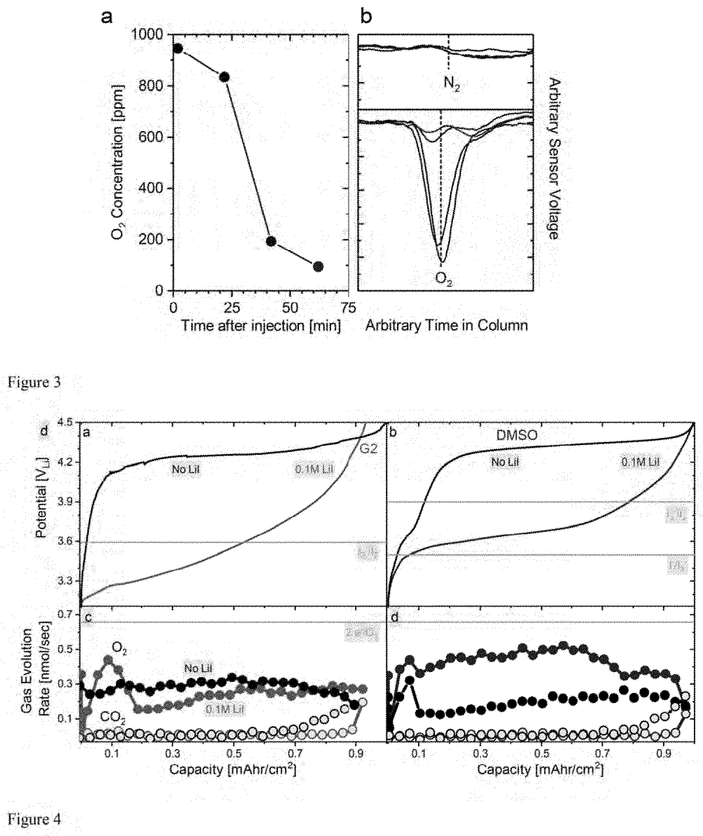

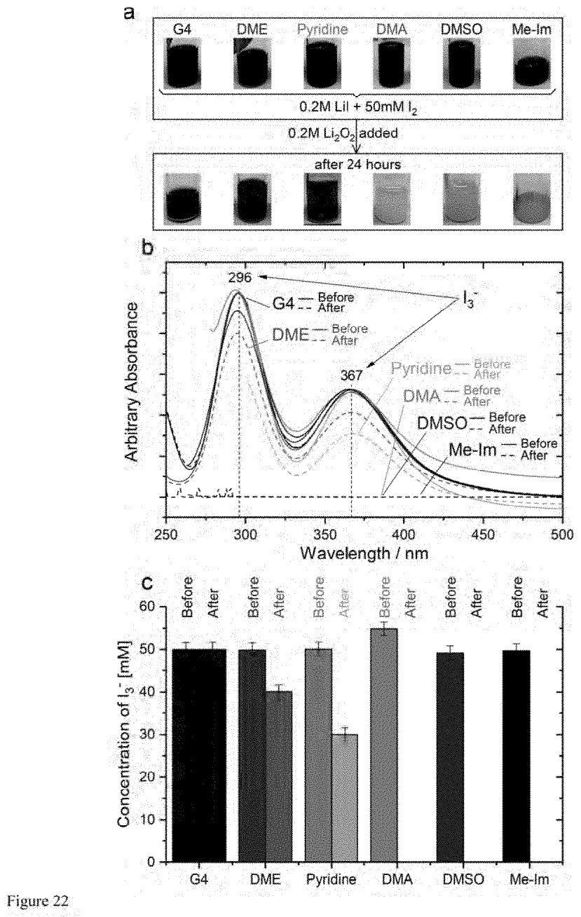

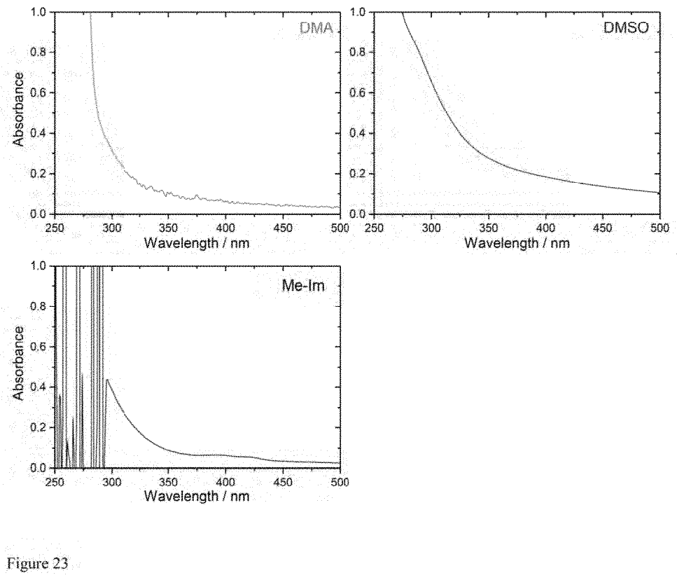

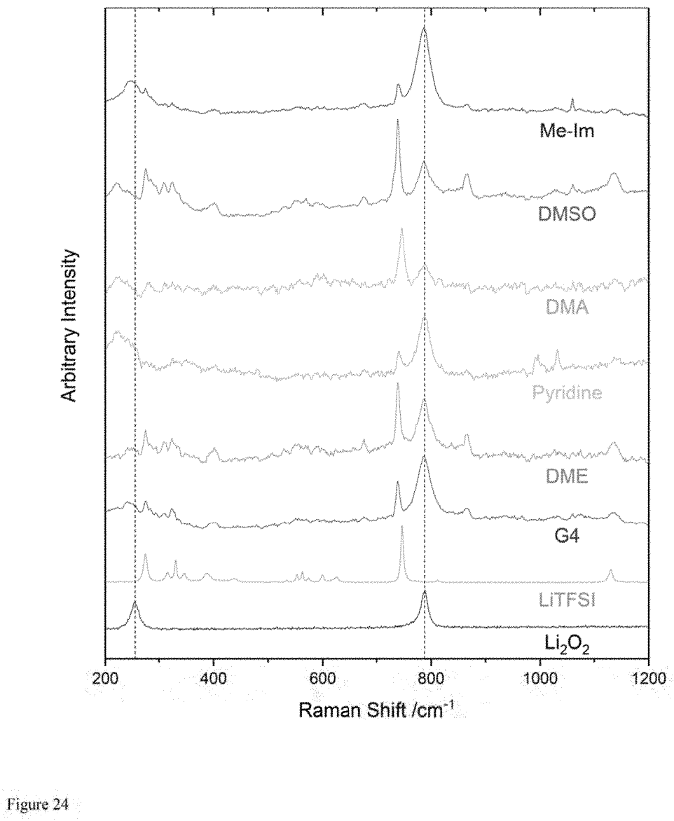

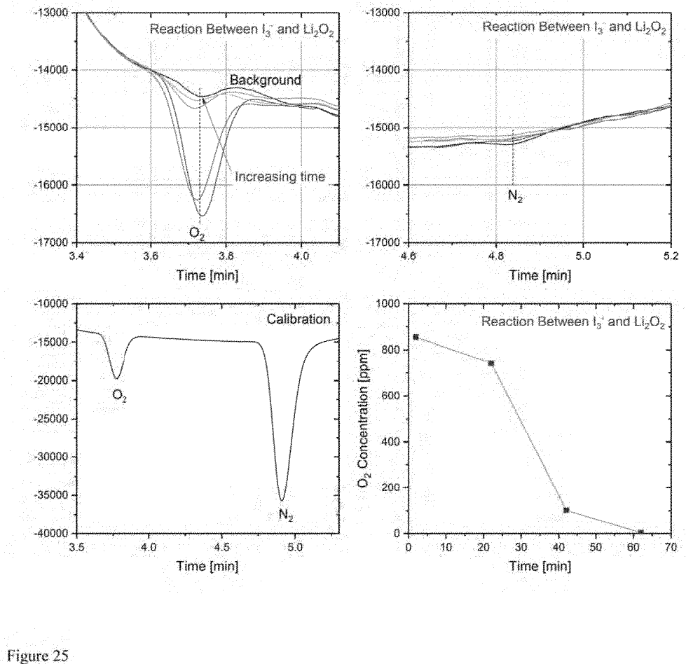

The solvent-dependent oxidizing power of I₃/I⁻ towards Li₂O₂ was examined by adding Li₂O₂ (0.1 M, Li₂O₂:I₃⁻=2:1) to 50 mM I₃⁻ (50 mM of I₂+0.2 M of LiI) in different solvents. The brown-colored solution became clear in DMA (<24 hours), DMSO (˜1 minute) and Me-Im (˜10 seconds), as shown in FIG. 2, panel a. On the other hand, the brown color became less pronounced for pyridine while no visible color change was found for DME and G4 after 24 hours. The color change observed for DMA, DMSO and Me-Im can be attributed to the reduction of I₃⁻ (dark brown) to I⁻ (colorless). This hypothesis is supported by UV-vis spectroscopy of the liquid phase decanted from the reaction mixture after 24 hours, where characteristic peaks for I₃⁻ at 293 nm and 364 nm disappeared for DMA, DMSO and Me-Im while those for DME, G4 and pyridine remained, as shown in FIG. 2, panel b and FIGS. 22 and 23. The concentration changes of I₃⁻ during the reaction (24 hours) quantified using the absorbance of I₃⁻ solutions with known concentration (as detailed in FIGS. 12-14 increased with greater redox potentials of I₃⁻/I⁻ from G4, DME, pyridine to DMA (DMSO or Me-im) in FIG. 2, panel c. All the I₃⁻ was consumed in DMA, DMSO and Me-im and Raman spectra of the solid recovered after the reaction between Li₂O₂ and I₃⁻ revealed Li₂O₂ remained after the reaction as Li₂O₂ was 2 times over stoichiometric (FIG. 24). This trend is in agreement with the greater kinetics of Li₂O₂ oxidation by I₃/I⁻ with higher potentials in solvents such as DMA and DMSO which renders a higher thermodynamic driving force relative to Li⁺,O₂/Li₂O₂(FIG. 1). Further support for Li₂O₂ oxidation by I₃⁻ in DMSO came from oxygen evolution as detected by gas chromatography (GC) accompanied with color changes of the solution after addition of Li₂O₂. GC measurements of oxygen evolution from solutions of DMSO (FIG. 3, FIG. 25) show that the amount of oxygen detected was comparable to that expected for oxidation of I₃⁻ by I₃⁻+Li₂O₂→2Li⁺+3I⁻+O₂. Therefore, having solvents not only with higher AN to increase the potential of I₃⁻/I⁻ but also with higher DN to lower the potential of Li,O₂/Li₂O₂ in solvents such as DMA and DMSO promotes the oxidizing power of I₃⁻/I⁻ towards Li₂O₂ as opposed to solvents like G4 and DME.

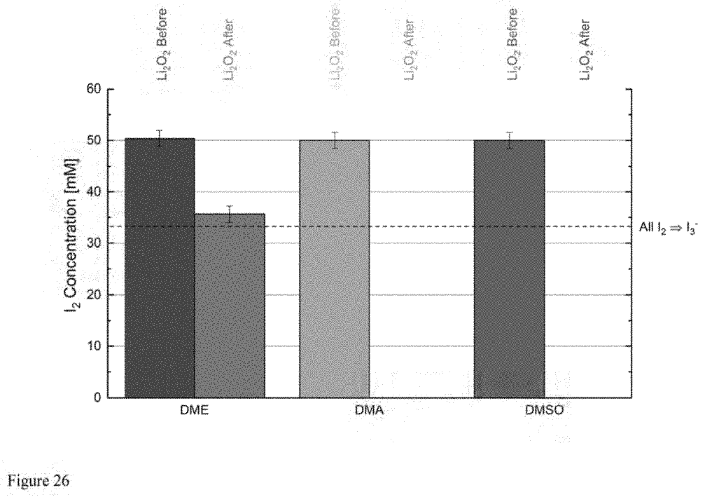

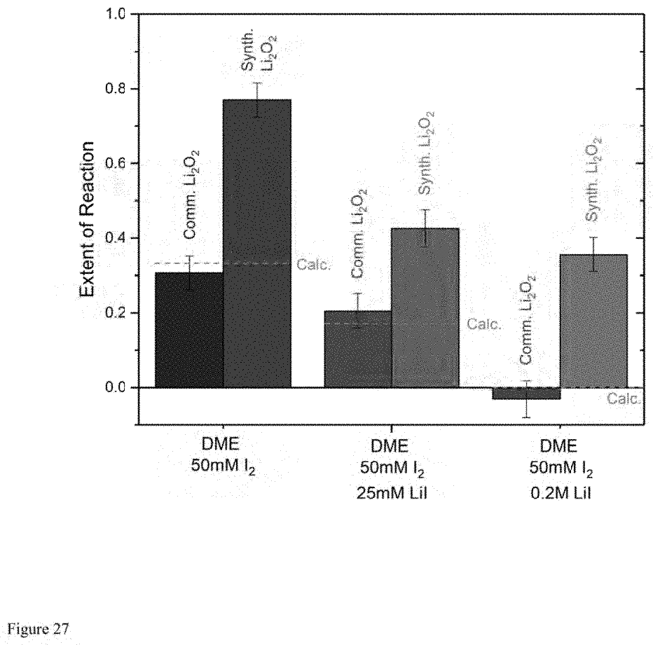

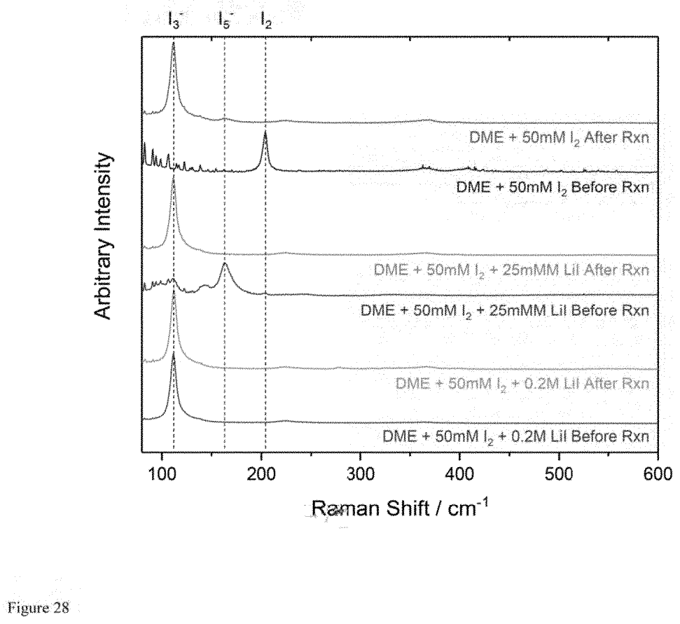

I₃⁻ in DME can oxidize Li₂O₂ in small part considering experimental uncertainty while previous studies showing that I₃⁻ cannot oxidize Li₂O₂^{43,45-47} in DME. The more oxidizing I₂ could fully oxidize synthetic Li₂O₂ in DMA and DMSO and I₂ in DME reacted until all I₂ was reduced to I₃⁻ via I₂+Li₂O₂→2Li⁺+2I⁻+O₂ and I₂+I⁻<I₃⁻ (FIG. 26). Reactions between commercial Li₂O₂ and I₃⁻/I₂ in DME proceeded to a lesser extent than synthetic Li₂O₂ as shown in FIG. 27. I₃⁻ in DME did not react at all with commercial Li₂O₂, whereas solutions of I₂ (50 mM I₂) and I₅⁻ (50 mM I₂+25 mM LiI) proceeded until all higher order polyiodide species were reduced to I₃⁻. Raman on the solution phase after the reaction revealed that only I₃⁻ species remained (FIG. 28). We attribute this difference in oxidizing power of polyiodide species against commercial and synthetic Li₂O₂ to the oxygen-rich, defective surface of Li₂O₂ formed through disproportionation which has been reported previously and is anticipated to be more readily oxidized than bulk Li₂O₂. A discussion of higher-order polyiodide species (such as I₅⁻ and I₇) is presented below.

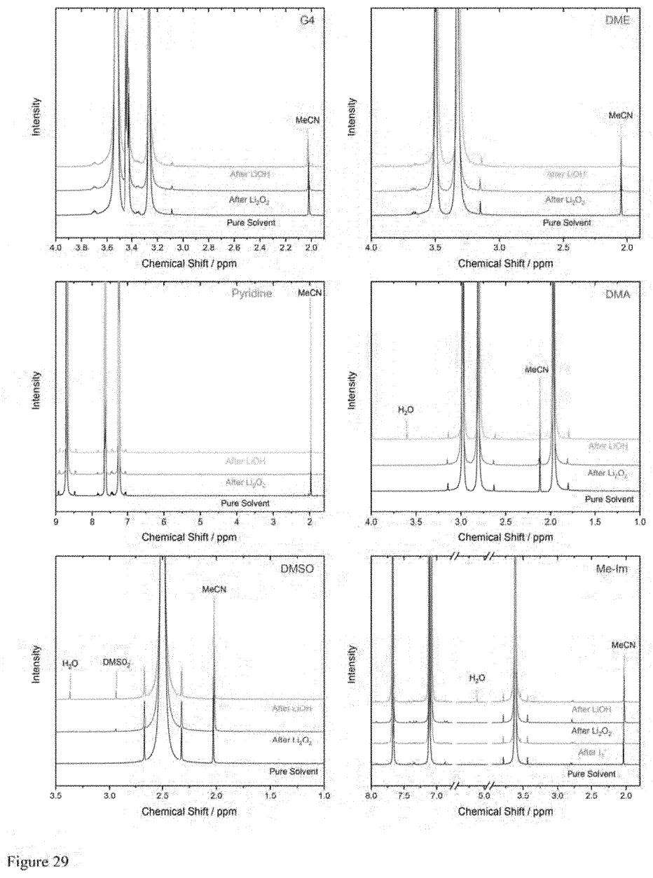

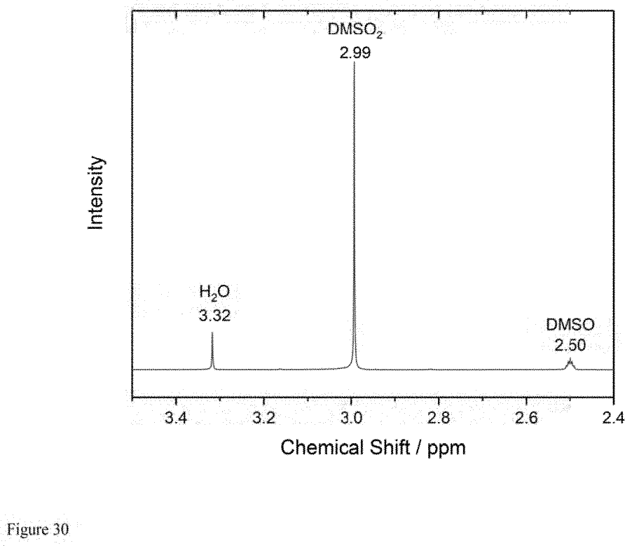

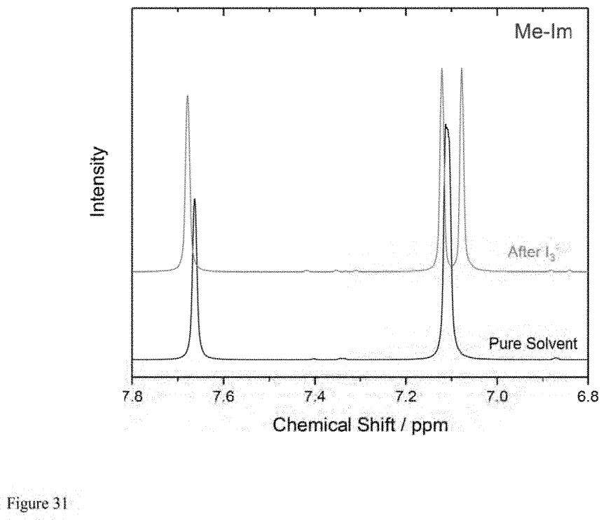

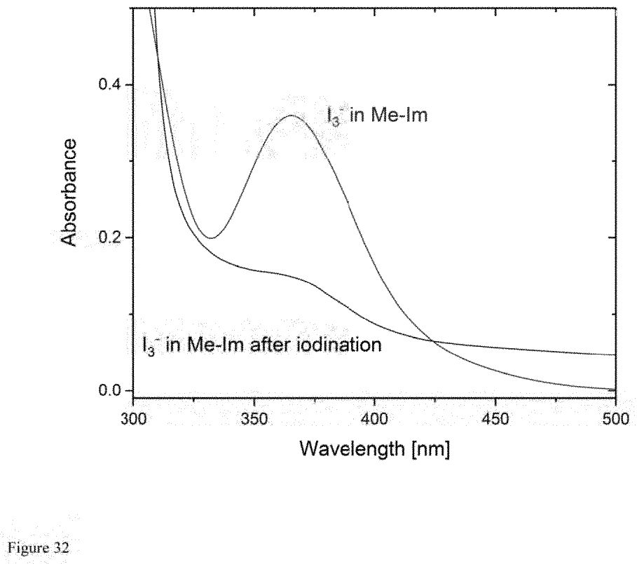

No solvent decomposition was detected for G4, DME and DMA while decomposed species from pyridine, DMSO and Me-Im were found in presence of Li₂O₂ and/or I₃⁻. ¹H NMR measurements of the solution phase decanted from the reaction mixture after 24 hours was used to detect protonated species produced after the addition of synthetic Li₂O₂. No changes were observed in G4, DME and DMA (FIG. 29, indicating no detectable solvent decomposition. On the other hand, a small peak at ˜2.95 ppm appeared for DMSO, which can be attributed to the presence of ˜6 mM dimethyl sulfone (DMSO₂) (FIG. 30). This observation is in agreement with previous work showing that DMSO is chemically unstable in the presence of Li₂O₂-like and LiO₂ species. In addition, changes were found for the ¹H NMR peaks of Me-Im at ˜7.1 ppm and ˜7.7 ppm, splitting into two peaks and shifting downfield, respectively (FIG. 31), As comparable changes were found when a solution of I₃⁻ was prepared in Me-Im (without addition of Li₂O₂), we attribute this to changes in Me-Im proton exchange dynamics caused by the introduction of a Brønsted base (I⁻/I₃⁻). Interactions between iodide species and Me-Im are known to be strong and lead to the iodination of Me-Im, which is supported by observed color-fading of I₃⁻ solutions of Me-Im over time, which was most pronounced in diluted samples for UV-Vis analysis (FIG. 32). Considering that the short duration of Li₂O₂ oxidation (<10 seconds) and long iodination reaction time (>weeks for a 50 mM solution without Li₂O₂) to render colorless solutions, the oxidation of Li₂O₂ by I₃⁻ to form I⁻ dominates.

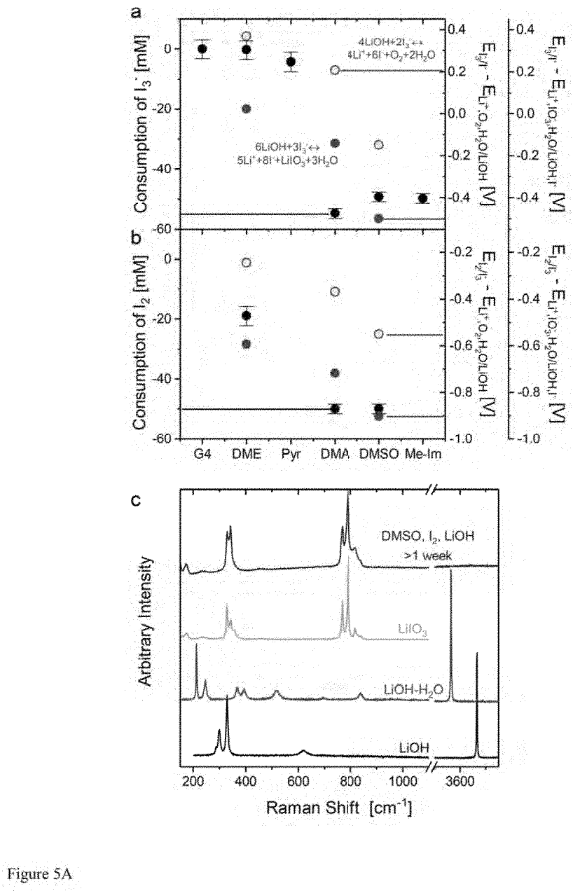

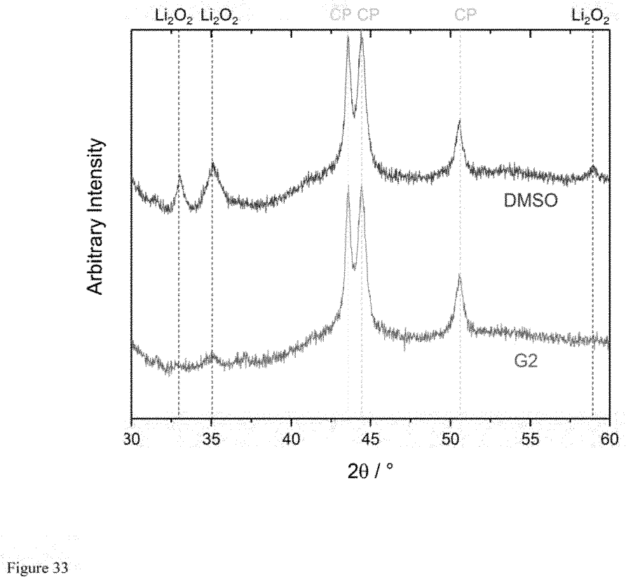

Discharging and charging of a Li—O₂ battery with and without LiI as a redox mediator was performed, where the added I⁻ was electrochemically oxidized to I₃⁻ and/or I₂ during charge. DEMS cells were assembled using 0.5 M LiTFSI in diglyme (G2) or DMSO, with and without 0.1 M LiI, where added 0.1 M LiI could provide a theoretical maximum of 33 mM I₃⁻ and 50 mM I₂, accounting for a maximum of 0.25 mAhr/cm² of capacity. G2 was selected as an analogous solvent to DME with a lower vapor pressure, but lower viscosity than G4. Cells were first discharged at 0.05 mA/cm²_{geo} for 20 hours to yield 1 mAhr/cm² in capacity and only Li₂O₂ was detected by XRD (FIG. 33). While the addition of 0.1 M LiI did not lead to significant changes the discharge voltage, it markedly reduced the charging potential in both solvents. The entire charging voltage profile for G2 was sloped and the reduction of charging voltage can be attributed to electrochemical oxidation of I⁻ to I₃⁻ (>2.98 V_{Li}) and I3⁻ to I2 (>3.59 V_{Li}), with minute oxidation of Li₂O₂ by I₃⁻. This hypothesis is supported by the DEMS measurements in G2, which showed no greater oxygen evolution rate with addition of I⁻ upon charge, as shown in FIG. 4, panel c. On the other hand, the charging voltage profile with DMSO exhibited a plateau below the oxidation potential of I₃⁻ to I₂ (3.90 V_{Li}), which was accompanied with a significantly enhanced (˜two times) rate of oxygen evolution during charging relative to that without I⁻. The result confirmed that having the I₃⁻/I⁻ redox potential equal to or lower than Li⁺,O₂/Li₂O₂ in solvents such as G2 and DME was unable to promote the oxidation of Li₂O₂ while those with greater potentials than that of Li⁺,O₂/Li₂O₂ in solvents such as DMSO can facilitate Li₂O₂ oxidation kinetics to evolve O₂ and lower charging overpotential of Li—O₂ batteries.

IX. Solvent-Dependent Oxidizing Power of I₃⁻/I⁻ and I₂/I₃⁻ Towards LiOH

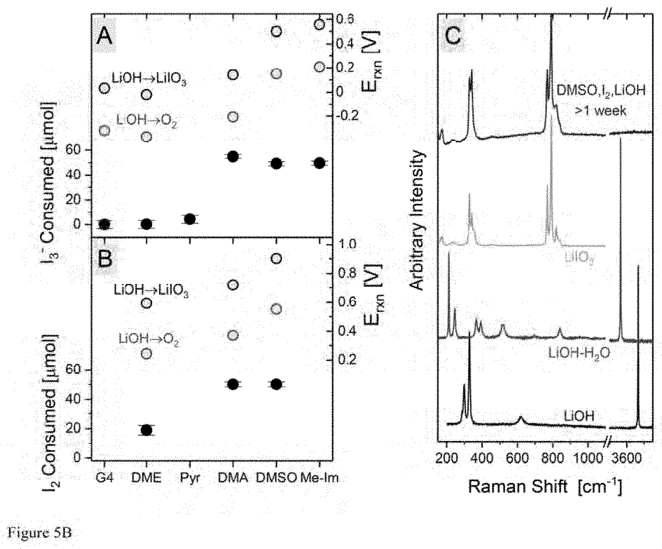

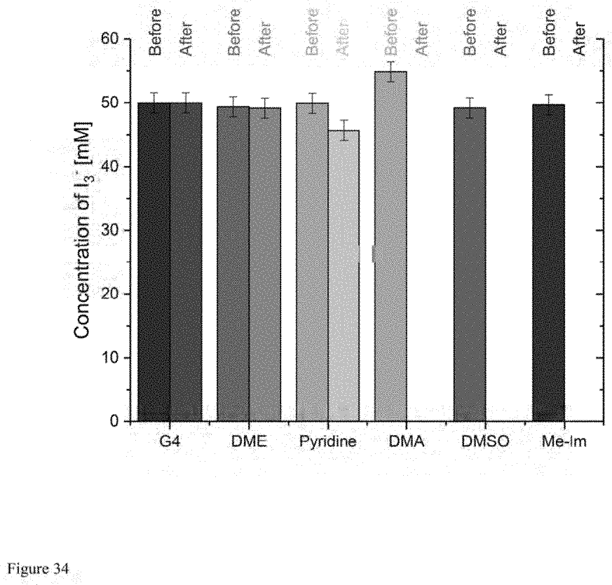

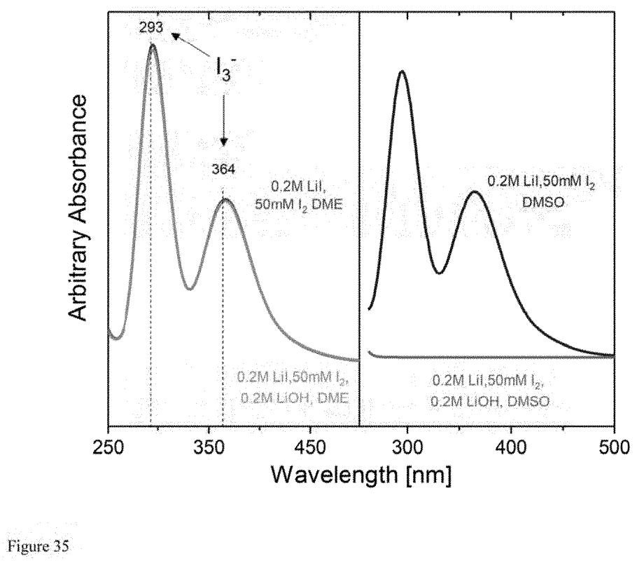

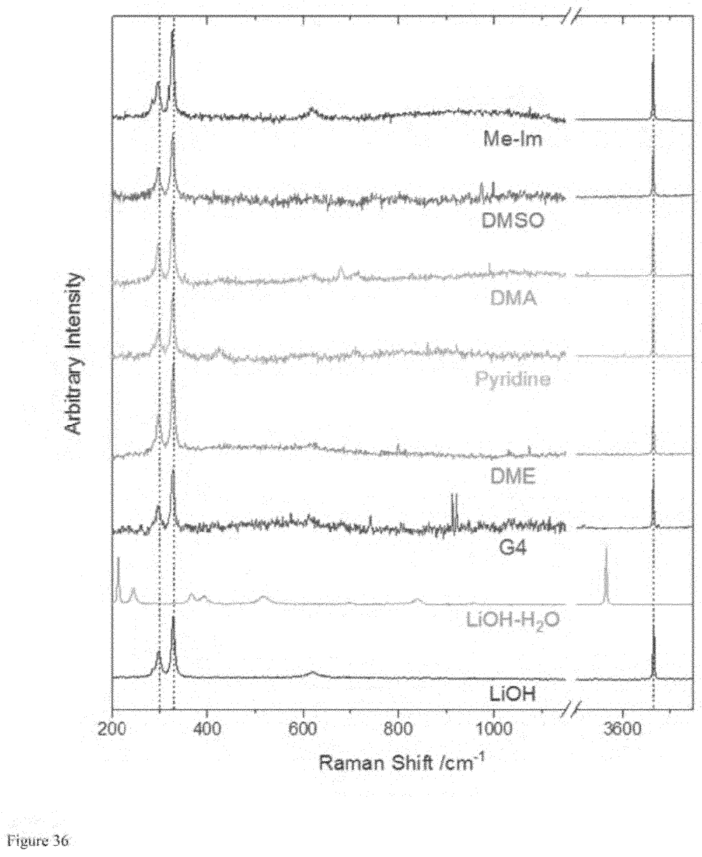

The solvent-dependent oxidizing power of I₃⁻/I⁻ towards LiOH was examined by adding LiOH (2 times excess) to 50 mM I₃⁻ (50 mM of I₂+0.2 M of LiI) in different solvents. The presence of water and I⁻ can lead to the formation of LiOH on discharge, where water is consumed in this reaction. Thus we examine how oxidized iodide species can promote the oxidation of LiOH, beginning from anhydrous conditions. The brown-colored solution became clear in DMA (˜48 hours) and DMSO (<1 hour) (Me-Im with ˜10 minutes). On the other hand, no clearly visible color change was found for pyridine, DME and G4 after 48 hours. The color change observed for DMA, DMSO and Me-Im can be attributed to the reduction of I₃⁻ (dark brown) to I⁻ (colorless). This hypothesis is supported by UV-vis spectroscopy of the liquid phase decanted from the reaction mixture after 48 hours, where characteristic peaks for I₃⁻ at 293 nm and 364 nm disappeared for DMA, DMSO and Me-Im while those for DME, G4 and pyridine remained, as shown in FIG. 5, panel a and FIG. 34 and FIG. 35. The concentration changes of I₃⁻ during the reaction (48 hours) was quantified using the absorbance of I₃⁻ solutions with known concentration (as detailed in FIGS. 12-14) increased with greater redox potentials of I₃⁻/I⁻ from G4, DME, pyridine to DMA (DMSO or Me-im) in FIG. 4, panel a. All the I₃⁻ was consumed in DMA, DMSO and Me-im while nearly no I₃⁻ was consumed in G4, DME and Pyridine. Raman spectra of the solid recovered after the reaction between LiOH and I₃⁻ revealed only LiOH as expected from LiOH being 2 times overstoichiometric (FIG. 36). Similarly, the addition of LiOH to the more oxidizing I₂ in DMA and DMSO led to complete consumption of I₂ while the consumption of I₂ stopped when the reaction had proceeded to a point when all I₂ would be expected to be converted to I₃⁻ in DME, as shown in FIG. 5, panel b.

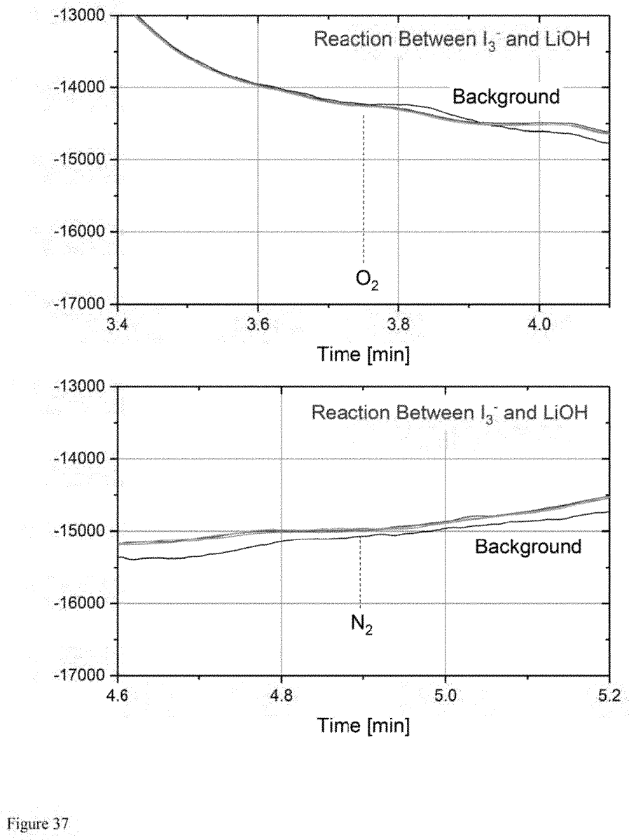

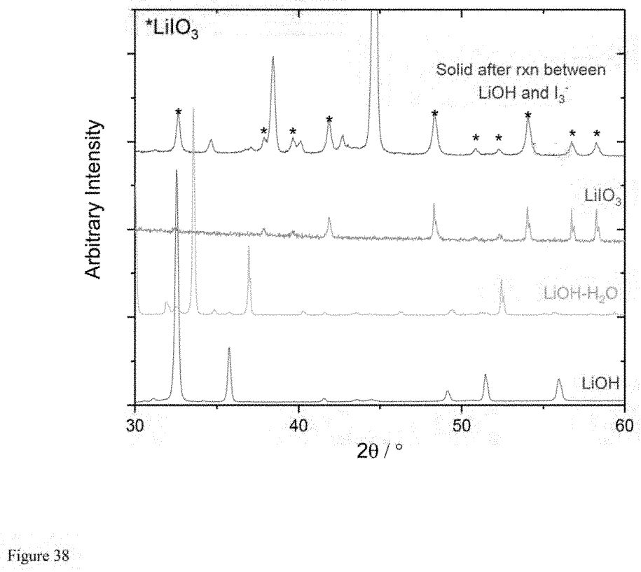

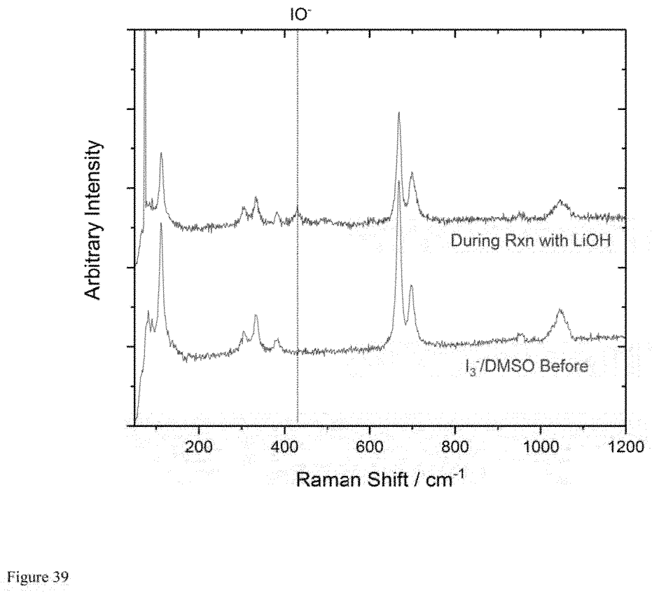

Unfortunately, the consumption of I₃⁻ by reacting with LiOH in solvents such as DMSO did not yield oxygen evolution as shown from GC measurements after the addition of LiOH (FIG. 37). To assess reaction products generated during the reaction between I₃⁻ and LiOH, the reaction between an excess of I₃⁻ (2 times) and LiOH in DMSO was allowed to carry out for more than one week. Raman (FIG. 5, panel c) and XRD (FIG. 38) revealed LiIO₃ without LiOH and LiOH—H₂O. The formation of LiIO₃ can come from the following reaction: 3I₃⁻+6LiOH→8I⁻+5Li⁺+3H₂O+LiIO₃. The reaction between I₃⁻ and LiOH (I₃⁻+2LiOH→2I⁻+2Li⁺+H₂O+IO⁻) has been well studied in aqueous systems as well as the disproportionation of hypoiodite (IO⁻) to IO₃⁻⁷¹⁻⁷³ (3IO⁻→2I⁻+IO₃⁻). In-situ Raman spectroscopy revealed a vibration at 430 cm⁻¹ previously attributed to IO⁻⁷⁴ (FIG. 39), which provided support to the proposed mechanism involving IO⁻. The formation of LiIO₃ is also supported by previous observations by Burke et al.⁴³ based on charging of a cell with LiI in DME with LiOH formed during discharge. The trend in FIG. 5, panel a can be attributed to the greater kinetics of LiOH oxidation by I₃⁻/I⁻ with higher potentials in solvents such as DMA and DMSO to render higher thermodynamic driving force relative to Li⁺,IO₃⁻,H₂O/LiOH,I⁻ (FIG. 5, panel a).

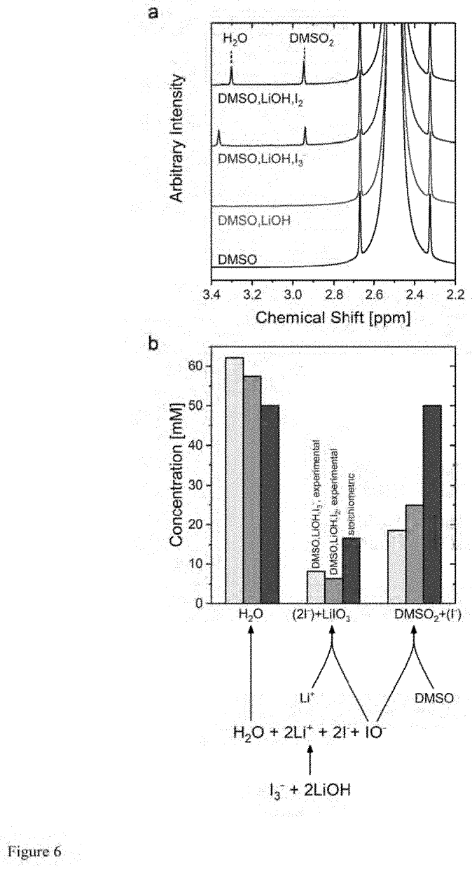

¹H NMR analysis and iodometric titration of the solution phase before and after reaction with 50 mM I₃⁻/I₂ further confirmed the proposed reaction mechanism for the formation of LiIO₃. A H₂O peak became visible following the addition of LiOH to DMA (FIG. 27), DMSO (FIG. 6, panel a, FIG. 27) and Me-Im (FIG. 27) with 50 mM I₃⁻ for 48 hours. No H₂O was detected in the liquid solution from mixing DMSO (without oxidized iodide species) with LiOH for 48 hours while an H₂O peak at 3.36 and 3.30 ppm was detected after reacting LiOH with 50 mM I₃⁻ and 50 mM I₂ in DMSO, respectively. The upfield shift of H₂O found for I₂ compared to I₃⁻ can be attributed to the larger quantity of LiI in the I₃⁻ solution as shown previously for ¹H NMR chemical shift of H₂O induced by interaction with I⁻ in DME⁴⁴. In contrast, no H₂O and other changes were observed in the ¹H NMR spectra of G4 and DME (FIG. 27) following the reaction between Li₂O₂ and I₃⁻ while pyridine showed the emergence of some small peaks (FIG. 27) which we attribute to solvent decomposition. The concentration of H₂O was quantified (±5 mM) using an internal MeCN reference, where ˜80 mM was found in DMA and ˜60 mM was found in DMSO and Me-Im. The amount of water detected was greater than that (50 mM) expected from the proposed reaction, 3I₃⁻+6LiOH→8I⁻+5Li⁺+3H₂O+LiHO₃, where the difference might be attributed to solvent decomposition. DMSO₂ at 2.95 ppm of ˜18 mM was found for DMSO and the peak changes of Me-Im (FIG. 27, FIG. 29) can be attribute to the previously discussed interactions with I⁻/I₃⁻⁷⁰. The amount of the iodate species detected with iodometric titration (8.2 mM and 6.4 mM for reactions with I₃⁻ and I₂ in DMSO, respectively) was close to that (16.7 mM) expected for 3I₃⁻+6LiOH→8I⁻+5Li⁺+3H₂O+LiHO₃, as shown in FIG. 6, panel b. The difference can be attributed to the decomposition of DMSO by IO⁻ via IO⁻+(CH₃)₂SO→I⁻+(CH₃)₂SO₂, having 18.5 mM and 24.9 mM DMSO₂ (18.5/24.9 mM IO⁻ consumed) in this decomposition reaction for reactions with I₃⁻ and I₂, respectively. A similar oxidation of DMSO to DMSO₂ was reported by Liu et al. in the ruthenium-catalyzed oxidation of LiOH. Therefore, combined spectroscopic data from ¹H NMR, Raman, GC and iodometric titration show that the oxidation of LiOH by oxidized iodide species such as I₃⁻ leads to the formation of an IO⁻ intermediate, which can disproportionate to form LiIO₃ as the major product and attack solvent molecules to form species such as DMSO₂. This reaction mechanism does not lead to the formation of O₂ gas as some have reported previously.

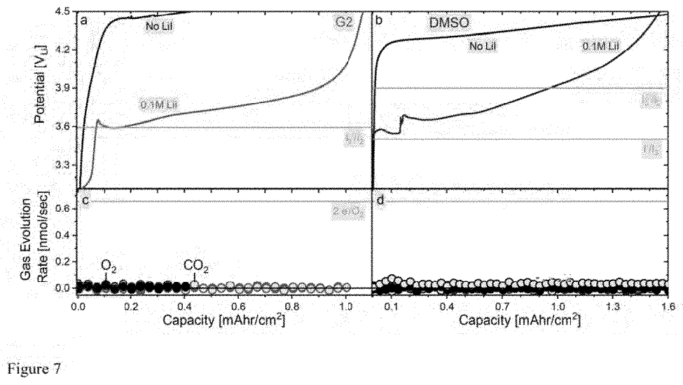

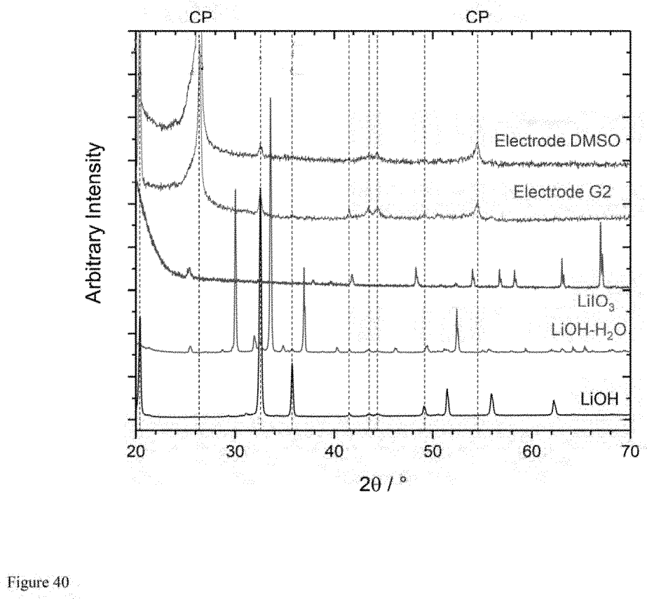

The proposed oxidation mechanism of LiOH in the presence of oxidized iodide species is supported by galvanostatic charging and DEMS measurements (FIG. 7) of preloaded LiOH electrodes with a solid Li-conducting separator to eliminate shuttling, charged in 0.5 M LiTFSI G2 (FIG. 7, panel a, panel c) and DMSO (FIG. 7 panel b, panel d) with and without 0.1 M LiI addition (in cases where no LiI was added, an additional 0.1 M LiTFSI was added to fix the total Li⁺ concentration at 0.6 M). Of significance, there was no observable oxygen generation in either G2 or DMSO, which supports the proposed oxidation of LiOH by oxidized iodide species to form lithium iodate. The majority of the charging plateau took place above the I₃⁻/I₂ redox transition in G2 (comparable to that in DME), indicating that I₃⁻ could not oxidize LiOH in glymes but I₂ could (FIG. 5, panel a, panel b). On the other hand, significant capacity was noted below the I₃⁻/I₂ redox transition in DMSO, corresponding to the formation of LiIO₃ from I₃⁻. XRD of the electrodes after charging (FIG. 40) indicated that not all LiOH was removed, which is consistent with the calculated charging capacity based on the mass of deposited LiOH (7.3 and 5.2 mAhr/cm² for G2 and DMSO, respectively). However, the observed capacity is significantly larger than the maximum calculated capacity based on the oxidation of LiI (˜0.25 mAhr/cm²), indicating consumption of LiOH during charge. We postulate the incomplete oxidation of LiOH in-situ may relate to either slow kinetics of oxidation of LiOH by iodide species (shown to be much slower than the oxidation of Li₂O₂ in ex-situ experiments) and/or the passivation of the LiOH surface by insoluble LiIO₃. Leftover LiOH after charging is consistent with the observations of Qiao et al., however, using ex-situ reactions and a solid Li-conducting separator to eliminate shuttling, we are able to demonstrate that LiOH is still active during the charging process and not inactive as suggested by Qiao et al.

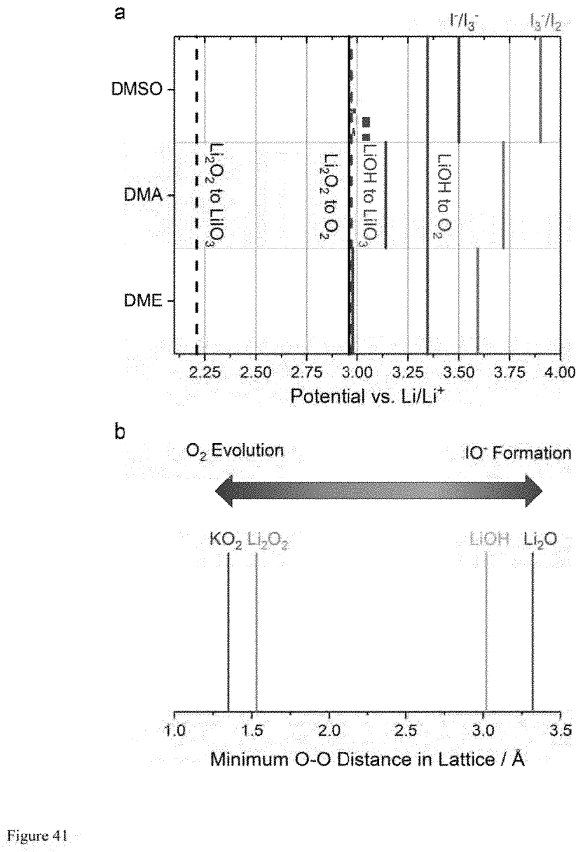

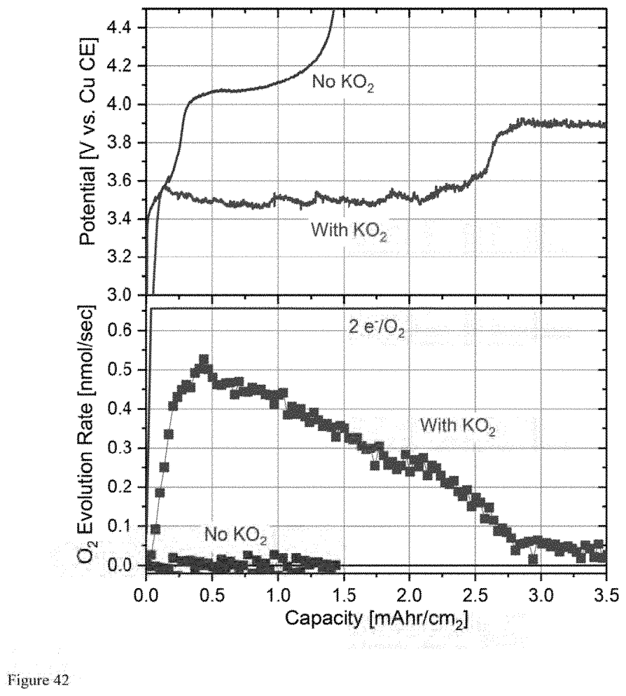

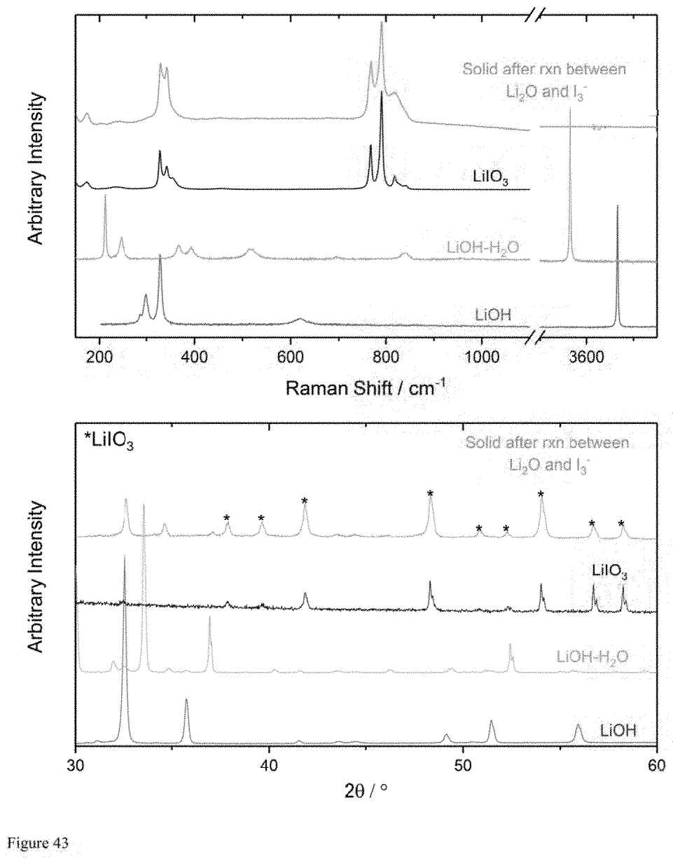

The reaction of Li₂O₂ by oxidized iodide species leads to O₂ gas evolution whereas LiOH is oxidized to IO⁻, which can then either disproportionate to form LiIO₃ or attack solvent molecules. We estimated the free energy of formation for LiIO₃ by combining the computed enthalpy of LiIO₃ formation from Huang et al. with approximated entropy estimated from KIO₃, where full derivation is available in the Supporting Information. The formation of LiIO₃ from Li₂O₂ and LiOH was found thermodynamically at 2.21 and 2.97 V_{Li}, respectively as shown in FIG. 41. The oxidation of Li₂O₂ to O₂ in the presence of oxidized iodide species is anticipated to occur when the polyiodide equilibrium potential is higher than 2.96 V_{Li}. Similarly, LiOH is expected to be oxidized to O₂ by polyiodide species with redox potentials above 3.35 V_{Li}. The estimated thermodynamics predicting oxidation of LiOH to LiIO₃ at voltages greater than ˜3 V_{Li} is in good agreement with measured values in this work. Since I₃⁻ is unable to oxidize LiOH in DME, but is able to oxidize LiOH in DMA, we would anticipate the formation of LiIO₃ from LiOH to occur in the range of 2.98-3.14 V_{Li}. Since LiIO₃ is thermodynamically favorable to form from both Li₂O₂ and LiOH, it is proposed that the evolution of O₂ without the formation of LiIO₃ upon oxidation of Li₂O₂ by oxidized iodide species can be attributed to slow kinetics of O—O dissociation needed to form IO⁻ and subsequently LiIO₃. Further support to this hypothesis came from the experiments with KO₂ and Li₂O. The oxidation of KO₂ by I₃⁻ in G2 was found to readily evolve O₂ using DEMS, and have a color change from brown to colorless in the ex situ chemical reaction (FIG. 42) while the chemical reactions between Li₂O and I₃⁻ in DMSO led to LiIO₃ (FIG. 43).

The formation of LiIO₃ from the oxidation of LiOH by I₃⁻/I₂ indicates a significant incompatibility between LiI as a redox mediator for Li—O₂ batteries and any water present in the electrolyte. As previous demonstrated, the presence of LiI in DME-based electrolytes decreases the deprotonation energy of water, leading to the formation of LiOH (even with H₂O content <40 ppm). In this work, we have demonstrated that the oxidation of LiOH leads to the formation of LiIO₃, and not the reversible formation of O₂, as well as the regeneration of water. Therefore, with cycling in the presence of any water (even contaminate levels of water), through the action of consuming water to form LiOH on discharge and oxidizing it to LiIO₃ and reforming water on charge, LiI will be converted to LiIO₃, leading to the irreversible loss of the redox mediator. The full implication of this reaction on the cycle life of cells with LiI as a redox mediator is beyond the scope of this work, but this work highlights a significant issue that needs to be addressed in order for LiI to be practically implemented as a redox mediator in a Li—O₂ battery.

The role of LiI on the charging process of Li—O₂ batteries was examined by systemically studying the solvent-dependent oxidizing power of I₃⁻/I⁻ and I₂/I₃⁻ towards Li₂O₂ and LiOH. The oxidizing power of I₃⁻/I⁻ and I₂/I₃⁻ towards Li₂O₂ and LiOH was examined chemically by examining the consumption of I₃⁻ upon addition of synthetic Li₂O₂, where the liquid reaction product was examined using UV-vis spectroscopy and ¹H NMR, the solid reaction products were studied by Raman spectroscopy and XRD and the gaseous products were assessed using gas chromatography. In addition, the role of I⁻ on the charging of Li—O₂ batteries and LiOH pre-loaded cells was examined using DEMS, where the amount of oxygen generated was quantified. We have shown that I₃⁻/I⁻ shifts towards higher potentials in solvents with higher dielectric constant and AN, suggesting stronger solvation of I⁻ ions, whereas the I₂/I₃⁻ potential was observed to be largely solvent independent in the considered solvents. This strong solvation of I⁻ ions, coupled with a strong solvation of Li⁺ ions in solvents like DMA, DMSO and Me-Im was found to increase the oxidizing power of I₃⁻/I⁻, allowing I₃⁻ to effectively oxidize Li₂O₂ to generate O2, which was supported by chemical and electrochemical experiments. In solvents with weaker solvation of I⁻ and Li⁺ (such as DME and G4), the more oxidizing I₂/I₃⁻ redox couple was needed before Li₂O₂ could be fully oxidized to O₂. The oxidation of LiOH by I₃⁻ was also found to be solvent dependent, where no reaction was observed in G4, DME and pyridine while the reaction proceeded to completion in DMA, DMSO and Me-Im where the I₃⁻/I⁻ redox potential was above ˜3.1 VW. No O₂ was detected from the oxidation of LiOH by I₃⁻ using gas chromatography and the charging of pre-loaded LiOH electrodes in DEMS, but instead, the oxidation of LiOH was found to produce water and a hypoiodite (IO⁻) intermediate, which could either disproportionate to form LiIO₃ or attack solvent molecules and result in decomposition products such as dimethyl sulfone (DMSO₂). The selectivity between O₂ and the thermodynamically preferred LiIO₃ can be governed by a kinetic barrier relating to O—O bond dissociation and this kinetic barrier prevents IO⁻ formation, allowing for the evolution of gaseous O₂ when oxidizing Li₂O₂, which was supported by reactions between oxidized iodide species and KO₂/Li₂O. This work highlights a significant incompatibility between LiI as a redox mediator for Li—O₂ batteries and even trace amounts of water in the electrolyte, which may lead to the consumption of the LiI redox mediator to form LiIO₃ with cycling.

Demonstrating the Charging Reaction of the Proposed Chemistry

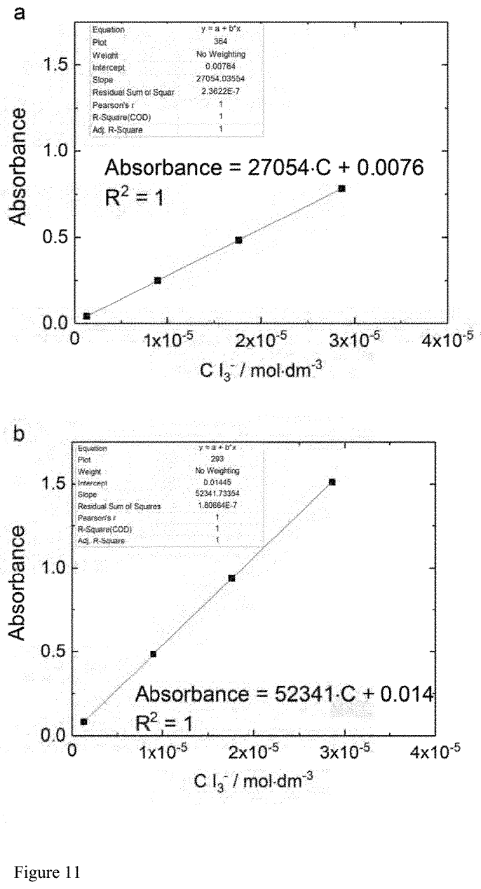

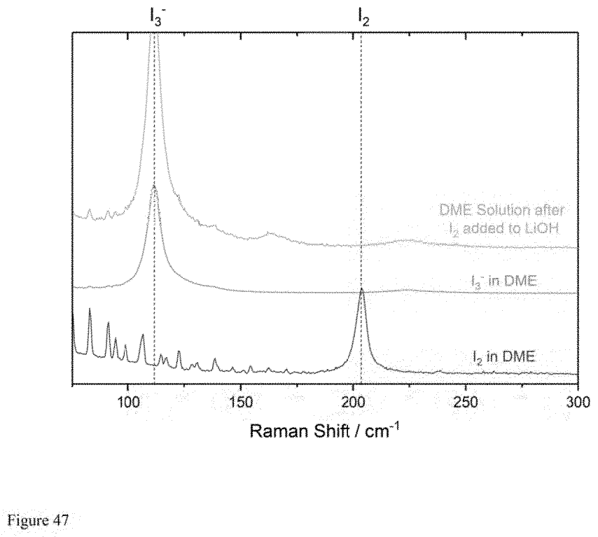

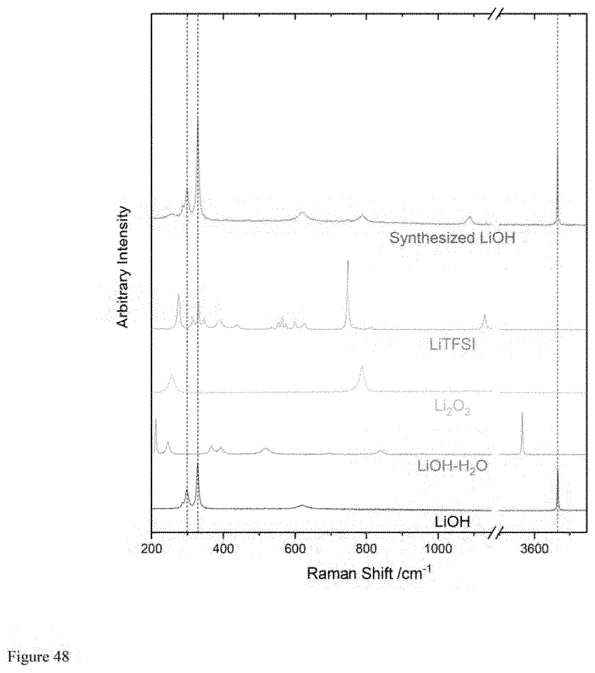

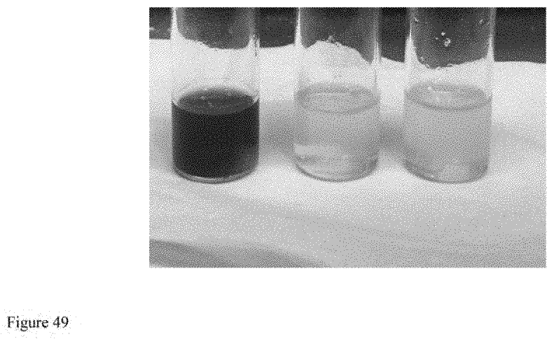

The reaction between I₃⁻ and LiOH was found to be solvent-dependent, with I₃⁻ being fully consumed in DMA, DMSO and Me-Im but little to no reaction occurring in G4, DME and pyridine. The solvent-dependent oxidizing power of I₃⁻/I⁻ towards LiOH was examined by adding commercial LiOH (0.2 μmol, LiOH:I₃⁻=4:1) to 1 mL of 50 mM I₃⁻ (50 mM of I₂+0.2 M of LiI, I⁻:I₂=4:1) in different solvents. The brown-colored solution became clear in DMA (˜48 hours), DMSO (˜1 hour) and Me-Im (˜10 minutes). This color change could be attributed to the reduction of I₃⁻ (dark brown) to I⁻ (colorless) as revealed by UV-vis spectroscopy of the liquid phase decanted from the reaction mixture after 48 hours (FIG. 5B, panel a, FIG. 35). On the other hand, no color change was found for pyridine, DME and G4 after 48 hours as evidenced by the characteristic peaks for I₃⁻ at 293 nm and 364 nm remaining after the reaction with LiOH (FIG. 5B, panel a, FIG. 35). The consumption of I₃⁻ after the reaction for 48 hours was quantified using the absorbance of I₃⁻ with known concentrations (FIGS. 11-14). All the I₃⁻ was consumed in DMA, DMSO and Me-Im while nearly no I₃⁻ was consumed in G4, DME and Pyridine, as shown in FIG. 1A. Similarly, as shown in FIG. 1B, the addition of LiOH to the more oxidizing I₂ in DMA and DMSO led to complete consumption of I₂ while in DME, the reaction stopped after only I₃⁻ remained (FIGS. 5B, panel b, FIG. 47), resulting from the previously discussed association between I⁻ generated by the reaction and the remaining I₂ via I₂+I⁻↔I₃⁻. Anhydrous LiOH synthesized via the disproportionation of KO₂ in a two times excess of LiTFSI in MeCN with added water (FIG. 48) was found to exhibit similar reactivity to commercial anhydrous LiOH in the presence of I₃⁻, with a brown-colored 50 mM I₃⁻ solution becoming clear in DMA (˜96 hours) and DMSO (˜4 hour), but no visible color change in DME after 96 hours (FIG. 49).

The reaction between I₃⁻ and anhydrous LiOH in solvents such as DMSO did not yield oxygen evolution as shown from GC measurements with commercial LiOH (FIG. 37). As expected due to the excess of LiOH (LiOH:I₃⁻=4:1), Raman spectra of the solid recovered after the reaction between LiOH and I₃⁻ in all solvents revealed anhydrous LiOH as the dominant phase remaining after the reaction (FIG. 36). To further probe potential solid reaction products between I₃⁻ and LiOH, the I₃⁻ excess reaction with commercial anhydrous LiOH (LiOH:I₃⁻=1:1) in DMSO was performed for more than one week. Raman (FIG. 5B, panel C) and XRD (FIG. 38) of the solid recovered revealed LiIO₃ only without LiOH remaining. The presence of LiIO₃ has been previously reported by Burke et al., Implications of 4e⁻ Oxygen Reduction via Iodide Redox Mediation in Li—O₂ Batteries. ACS Energy Letters 2016; 1:747-56, which is incorporated by reference in its entirety. upon charging of cells having LiOH formed during discharge with LiI in DME. The formation of LiIO₃ can come from the following reaction: 3I₃⁻+6LiOH→8I⁻+5Li⁺+3H₂O+LiIO₃, which can include the reaction between I₃⁻ and LiOH to generate hypoiodite (I₃⁻+2LiOH→2I⁻+2Li⁺+H₂O+IO⁻) and the disproportionation of hypoiodite (IO⁻) to iodate IO₃⁻ (3IO⁻→2I⁻+IO₃⁻). See, Gerritsen C M, Gazda M, Margerum D W. Non-metal redox kinetics: hypobromite and hypoiodite reactions with cyanide and the hydrolysis of cyanogen halides. Inorganic Chemistry 1993; 32:5739-5748, Lengyel I, Epstein I R, Kustin K. Kinetics of iodine hydrolysis. Inorganic Chemistry 1993; 32:5880-5882; and Xie Y, McDonald M R, Margerum D W. Mechanism of the Reaction between Iodate and Iodide Ions in Acid Solutions (Dushman Reaction). Inorganic Chemistry 1999; 38:3938-40, each of which is incorporated by reference in its entirety. The presence of IO⁻ is supported by the presence of a vibration at 430 cm⁻¹ previously attributed to IO⁻ (FIG. 39) by in-situ Raman spectroscopy of a solution of commercial anhydrous LiOH with I₃⁻ in DMSO. See, Wren J C, Paquette J, Sunder S, Ford B L. Iodine chemistry in the +1 oxidation state. II. A Raman and uv-visible spectroscopic study of the disproportionation of hypoiodite in basic solutions. Canadian Journal of Chemistry 1986; 64:2284-96, which is incorporated by reference in its entirety. The thermodynamic driving force to form LiIO₃ from LiOH (3I₃⁻+6LiOH→8I⁻+5Li⁺+3H₂O+LiIO₃) is much greater than that for oxygen evolution (2I₃⁻+4LiOH→₆I⁻+4Li⁺+2H₂O+O₂), and increases with greater redox potentials of I₃⁻/I⁻ on the Li⁺/Li scale from G4/DME, to DMA, to DMSO, to Me-Im (FIG. 10, FIG. 18). Of particular significance is the case of DMA, where full consumption of I₃⁻ was observed and the reaction to form LiIO₃ is predicted to be spontaneous (Eᵣₓₙ=−ΔGᵣₓₙ/6F=+0.17V) whereas the reaction to form O₂ is not (Eᵣₓₙ=−ΔGᵣₓₙ/4F=−0.21V), which further supports the preference for LiIO₃ formation instead of O₂ evolution. Similar trends were found for I₂/I₃⁻ where increased thermodynamic driving force correlated with increased consumption of I₂ in DME, DMA and DMSO (FIG. 5B, panel b).

Quantifications through ¹H NMR analysis of the solution phase and iodometric titration after reaction with 50 mM I₃⁻/I₂ further confirmed the proposed reaction mechanism for the formation of LiIO₃. A H₂O peak became visible following the addition of LiOH to DMA (FIG. 30), DMSO (FIG. 6, panel a, FIG. 16) and Me-Im (FIG. 29) with 50 mM I₃⁻ for 48 hours. No H₂O was detected in the liquid phase from mixing DMSO (without oxidized iodide species) with LiOH while an H₂O peak at 3.36 and 3.30 ppm was detected after reacting LiOH with 50 mM I₃⁻ and 50 mM I₂ in DMSO, respectively (FIG. 6, panel a). The upfield shift of H₂O found for 12 compared to I₃⁻ can be attributed to the larger quantity of I⁻ in the solution following the reaction with I₃⁻, as shown previously for changes in the ¹H NMR chemical shift of H₂O induced by interactions with I⁻ in DME. See, for example, Tulodziecki M, Leverick G M, Amanchukwu C V, Katayama Y, Kwabi D G, Barde F, et al. The role of iodide in the formation of lithium hydroxide in lithium-oxygen batteries. Energy Environ Sci 2017; 10:1828-42, which is incorporated by reference in its entirety. In contrast, no H₂O or other changes were observed in the ¹H NMR spectra of G4 and DME (FIG. 29) following the reaction between LiOH and I₃⁻ while pyridine showed the emergence of some small peaks (FIG. 29) which we attribute to solvent decomposition. In addition to the formation of H₂O, reactions between LiOH and I₃⁻/I₂ in DMSO resulted in DMSO₂ (˜2.95 ppm, FIG. 30) with quantity of 18 μmol and 25 μmol for reactions with I₃⁻ and I₂, respectively (FIG. 6, panel a and panel b) while Me-Im experienced peak changes (FIG. 29) which can be attributed to the previously discussed interactions with I⁻/I₃⁻. See, for example, Schutte L, Kluit P P, Havinga E. The substitution reaction of histidine and some other imidazole derivatives with iodine. Tetrahedron 1966; 22:295-306, which is incorporated by reference in its entirety. The amount of iodate species detected with iodometric titration (8.2 μmol and 6.4 μmol for reactions with I₃⁻ and I₂ in DMSO, respectively) was close to that expected (16.7 μmol) for 3I₃⁻+6LiOH→8I⁻+5Li⁺+3H₂O+LiIO₃, as shown in FIG. 6, panel b. The difference can be attributed to the decomposition of DMSO by a IO⁻ intermediate via IO⁻+(CH₃)₂SO→I⁻+(CH₃)₂SO₂ which accounts for 18.5/24.9 μmol of IO⁻ consumed in reactions with I₃⁻ and I₂, respectively, which otherwise could have disproportionated to form LiIO₃. A similar oxidation of DMSO to DMSO₂ from intermediates of LiOH oxidation was reported by Liu et al. in a ruthenium-catalyzed Li—O₂ battery system. See, for example, Liu T, Liu Z, Kim G, Frith J T, Garcia-Araez N, Grey C. Understanding LiOH Chemistry in a Ruthenium Catalyzed Li—O2 Battery. Angewandte Chemie International Edition 2017; 56:16057-62, which is incorporated by reference in its entirety. Therefore, combined spectroscopic data from ¹H NMR, Raman, GC and iodometric titration show that the reaction between LiOH and oxidized iodide species such as I₃⁻ leads to the formation of an IO⁻ intermediate, which can disproportionate to form LiIO₃ as the major product and attack solvent molecules to form species such as DMSO₂. This reaction mechanism does not lead to the formation of O2 gas as some have reported previously. See, for example, Liu T, Leskes M, Yu W, Moore A J, Zhou L, Bayley P M, et al. Cycling Li—O₂ batteries via LiOH formation and decomposition. Science 2015; 350:530-3; and Zhu Y G, Liu Q, Rong Y, Chen H, Yang J, Jia C, et al. Proton enhanced dynamic battery chemistry for aprotic lithium-oxygen batteries. Nature Communications 2017; 8:14308, each of which is incorporated by reference in its entirety.

Without being bound to any specific theory, the proposed reaction mechanism of LiOH in the presence of oxidized iodide species is supported by galvanostatic charging and DEMS measurements (FIG. 7) of pre-loaded commercial, anhydrous LiOH electrodes with a solid Li-conducting separator to eliminate shuttling, charged in 0.5 M LiTFSI G2 (FIG. 7, panel a and panel c) and DMSO (FIG. 7, panel B and panel D) with and without 0.1 M LiI addition (in cases where no LiI was added, an additional 0.1 M LiTFSI was added to fix the total Li⁺ concentration at 0.6 M). Of significance, there was no observable oxygen generation in either G2 or DMSO, which supports the proposed reaction with LiOH by oxidized iodide species to form LiIO₃. The majority of the charging plateau took place above the I₃⁻/I₂ redox transition in G2 (comparable to DME/G4), indicating that I₃⁻ could not react with LiOH in glymes but I₂ could, which is consistent with ex-situ chemical reactions (FIG. 5B, panel a and panel b). On the other hand, significant capacity was noted below the I₃⁻/I₂ redox transition in DMSO, corresponding to the formation of LiIO₃ from I₃⁻. XRD of the electrodes after charging (FIG. 40) indicated that not all LiOH was removed, which is consistent with the calculated charging capacity based on the mass of deposited LiOH (7.3 and 5.2 mAhr/cm² for G2 and DMSO, respectively) being considerably higher than the achieved charging capacity (1.0 and 1.6 mAhr/cm² for G2 and DMSO, respectively). However, the observed capacity is significantly larger than the maximum calculated capacity based on the oxidation of LiI (˜0.25 mAhr/cm²), indicating consumption of LiOH during charge. We postulate the incomplete oxidation of LiOH in-situ may relate to either slow kinetics of reaction with LiOH by oxidized iodide species and/or the passivation of the LiOH surface by insoluble LiIO₃. Leftover LiOH after charging is consistent with the observations of Qiao et al., however, using ex-situ reactions and a solid Li-conducting separator to eliminate shuttling, we are able to demonstrate that LiOH is still active during the charging process and not inactive as suggested by Qiao et al. See, for example, Qiao Y, Wu S, Sun Y, Guo S, Yi J, He P, et al. Unraveling the Complex Role of Iodide Additives in Li—O₂ Batteries. ACS Energy Letters 2017; 2:1869-78, which is incorporated by reference in its entirety.

Demonstrating the Discharge Process

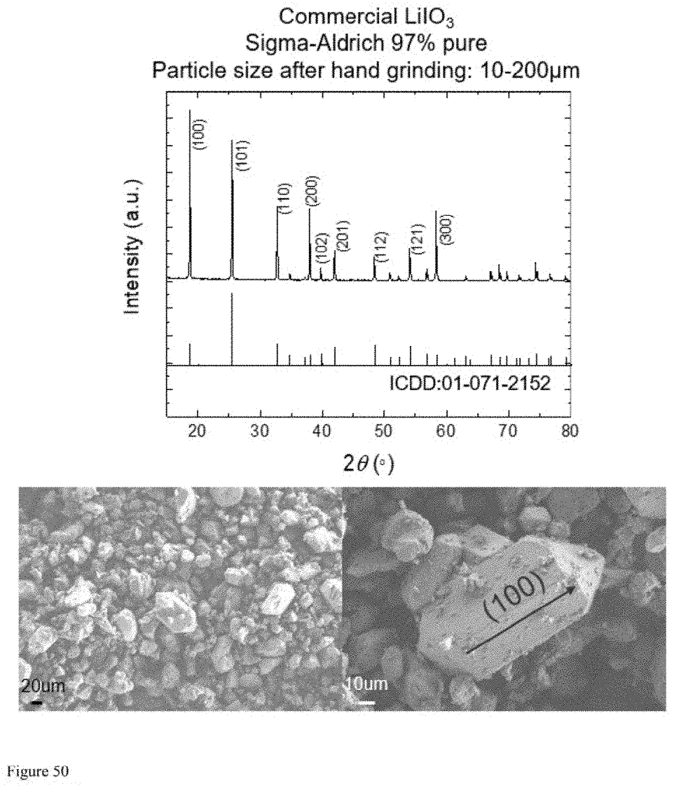

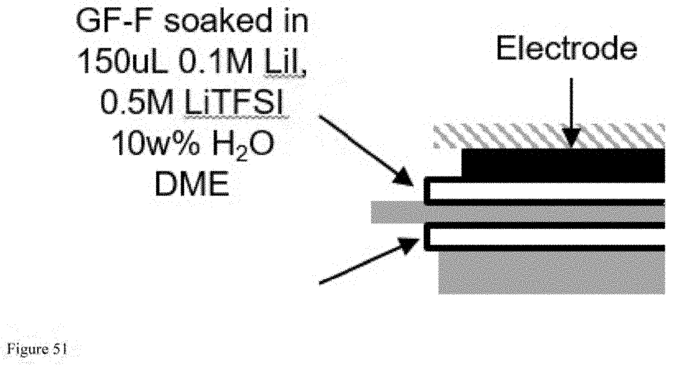

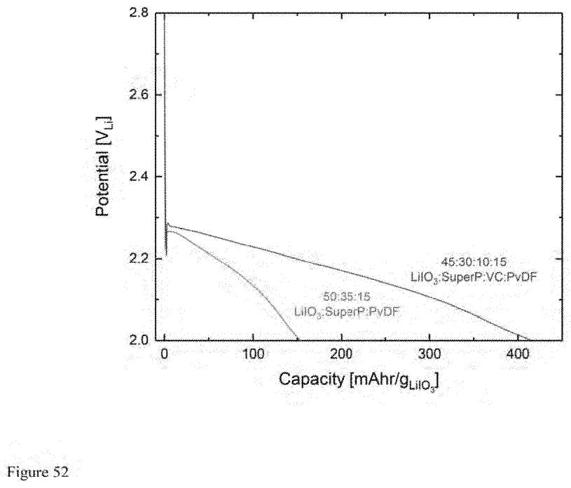

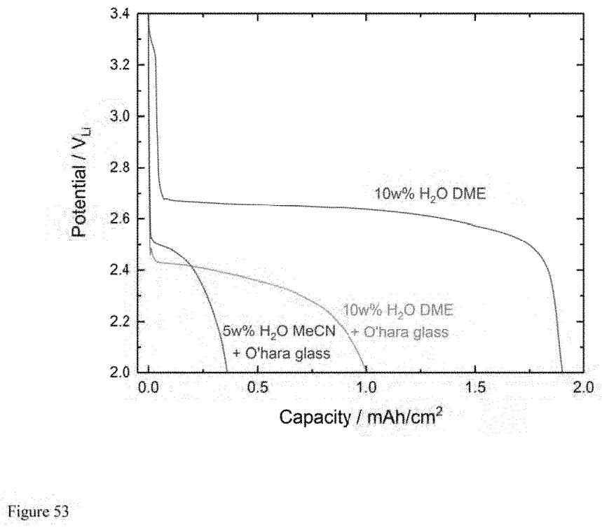

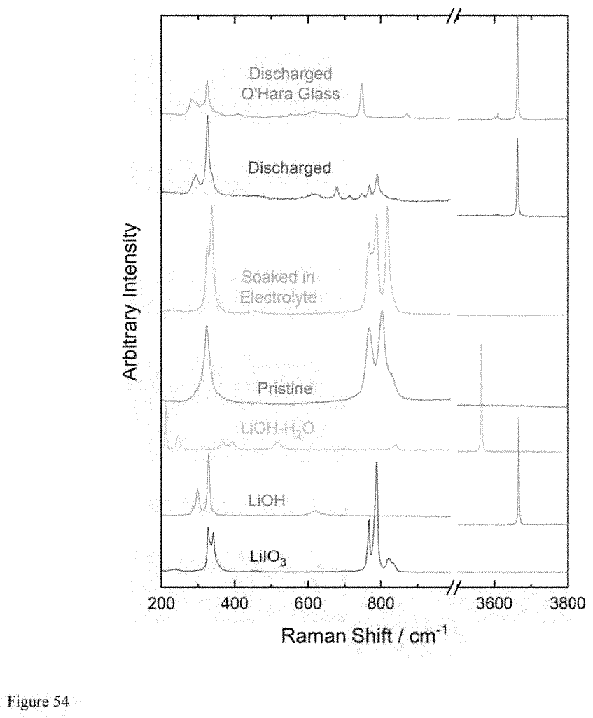

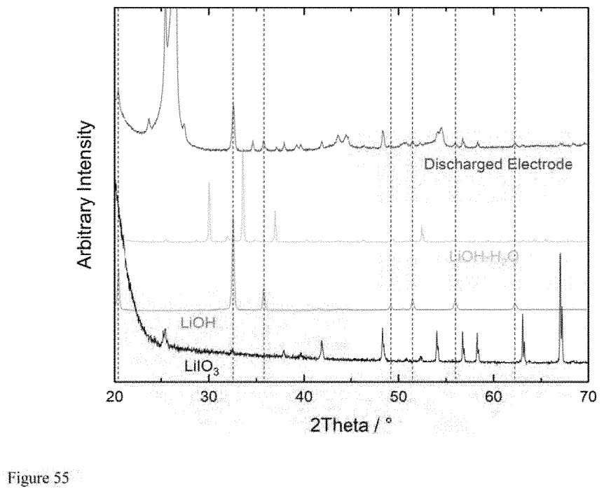

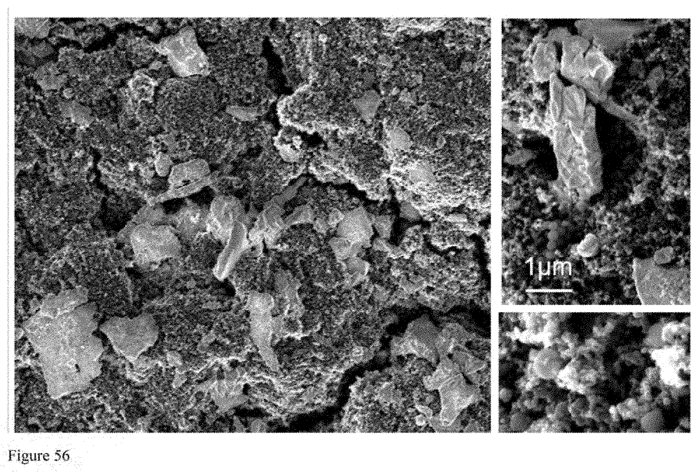

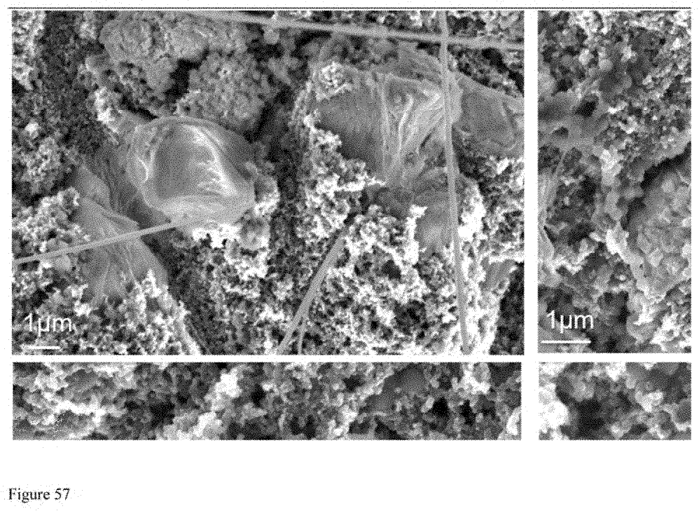

Electrodes were prepared using commercially available LiIO₃ from Sigma-Aldrich which was received and maintained in an α crystal structure (FIG. 50). After grinding by hand, the particle size obtained was 10-200 um (FIG. 50). Cells were constructed using a lithium iron phosphate (LFP) counter electrode and potentials were converted to a Li scale using the LFP potential of 3.45V_{Li}. O'hara glass was using as a solid li-ion conducting membrane to prevent shuttling of iodide species between the electrodes (FIG. 51). Discharges were performed using both composite electrodes (FIG. 52) and drop cast electrodes (FIG. 53). Composite electrodes were prepared by grinding LiIO₃ with carbon (SuperP and/or Vulcan carbon (VC)) and a polymer binder (PvDF) (FIG. 52) and deposited onto aluminum foil using a solvent (such as dimethoxymethane or NMP). Other electrodes were prepared by drop casting a slurry of LiIO₃ and Vulcan carbon with a PTFE binder onto a carbon paper substrate (Toray 60). Electrodes were discharged under Argon environment in an electrolyte consisting of 5-10 w % H₂O in 1,2-dimethoxyethane or acetonitrile. 0.5M LiTFSI was added as a conducting salt with an additional 0.1M LiI added to some electrolytes. Discharge profiles consisted of a sloped voltage profile from 2.2-2.7V vs Li (FIG. 52, FIG. 53). Electrodes recovered following discharge were analyzed using Raman (FIG. 54) and XRD (FIG. 55) and show the clear formation of anhydrous LiOH during the discharge process. Additional SEM images of pristine electrodes (FIG. 56) and discharged electrodes (FIG. 57) demonstrate clear morphological differences following discharge.

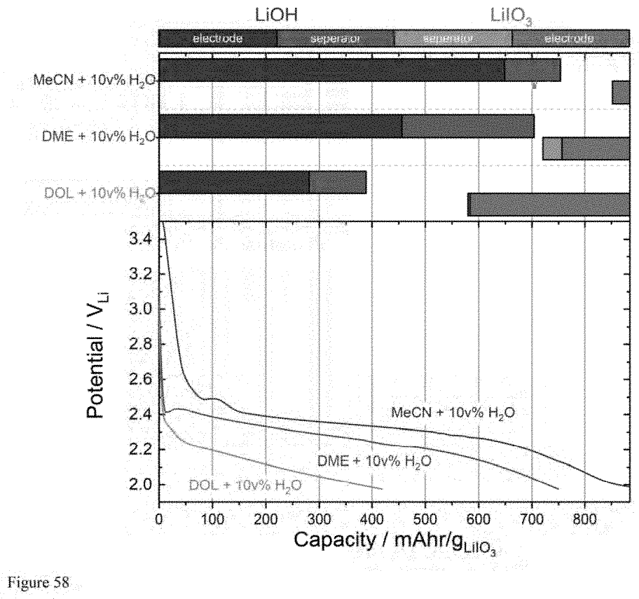

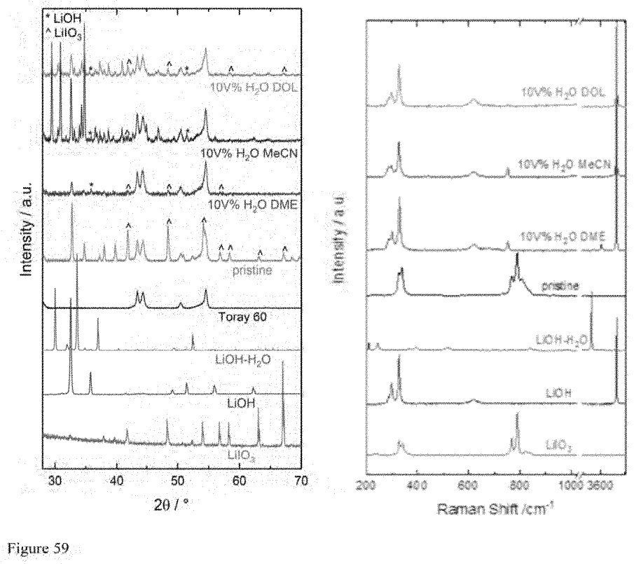

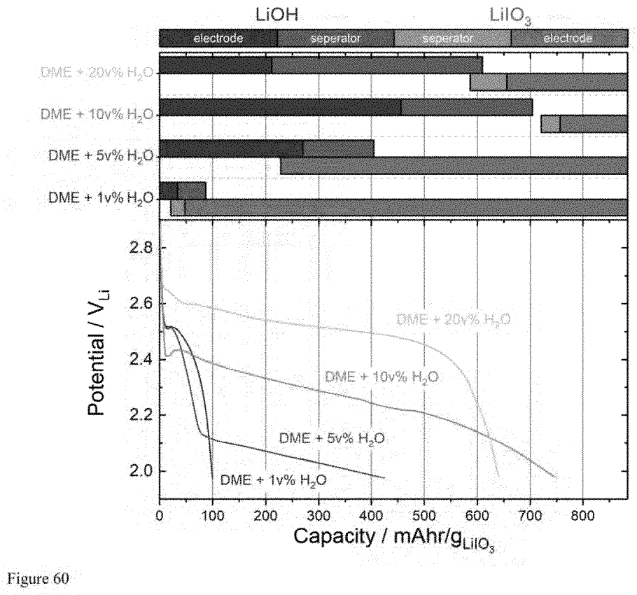

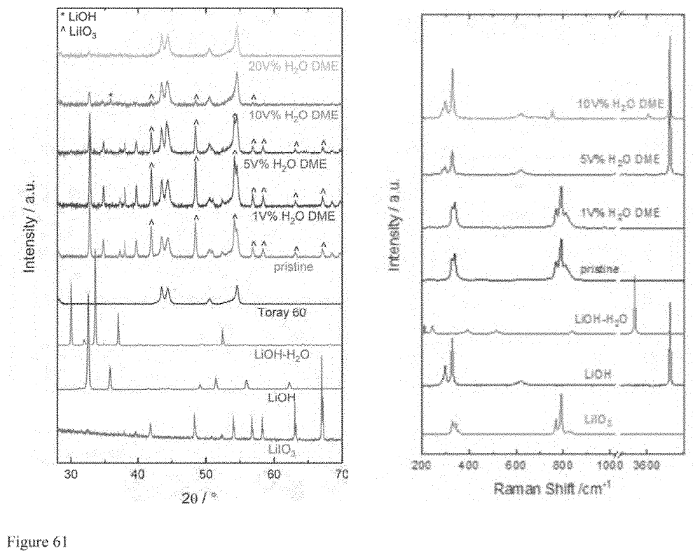

Additional work was carried out to understand the role of the electrolyte and water content on the discharge process. Discharges were carried out using drop cast LiIO₃ electrodes in 1,2-dimethoxyethane (DME), acetonitrile (MeCN) and 1,4-dioxane (DOL), all with added 10 v % H₂O. Discharge capacity and voltage increased from DOL, to DME, to MeCN, reaching the full anticipated discharge capacity of 880 mAhr/g_{LiIO3} (FIG. 58). Both XRD and Raman were performed on the discharged electrodes and support the anticipated removal of LiIO₃ and formation of LiOH (FIG. 59). Acid base titrations were performed to quantify the amount of LiOH formed during discharged by adding 5 mL DI water to a 20 mL vial container either the discharged electrode or separator and allowing all LiOH to dissolve for 30 minutes. Titration was performed using 10 mM HCl and a phenolphthalein indicator. Immediately following the acid-base titration, ˜50 mg KI and 0.5 mL 5M H₂SO₄ was added to the vial and an iodometric titration was performed using 10 mM Na₂S₂O₃ solution, adding a 1 w %/V starch solution near the end point. The iodometric titration results enabled the quantification of the remaining LiIO₃ after the discharge process. The consumption of LiIO₃ and formation of LiOH during the discharge process in the different solvents supports the proposed 6e⁻ reduction of LiIO₃ to LiOH (FIG. 58). Similar discharges were performed in DME with 1 v %, 5 v %, 10 v % and 20 v % H₂O added (FIG. 60). Titrations (FIG. 60) and XRD/Raman characterization (FIG. 61) again support the proposed discharge mechanism.

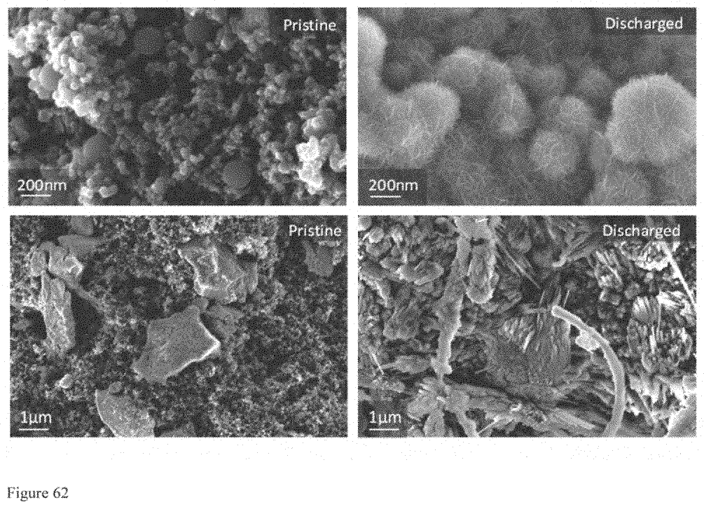

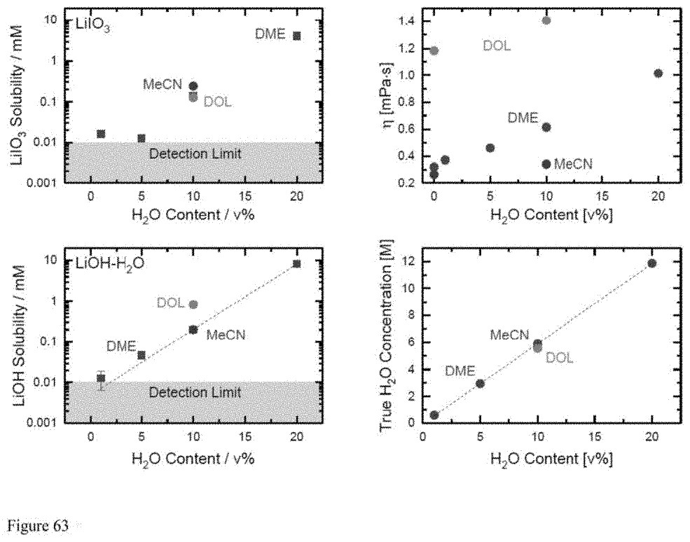

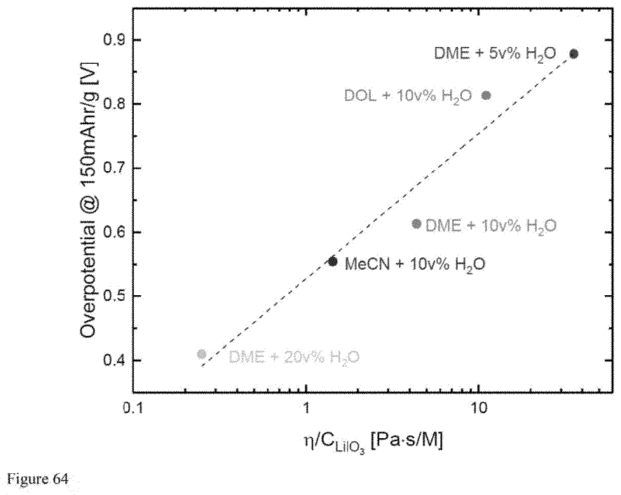

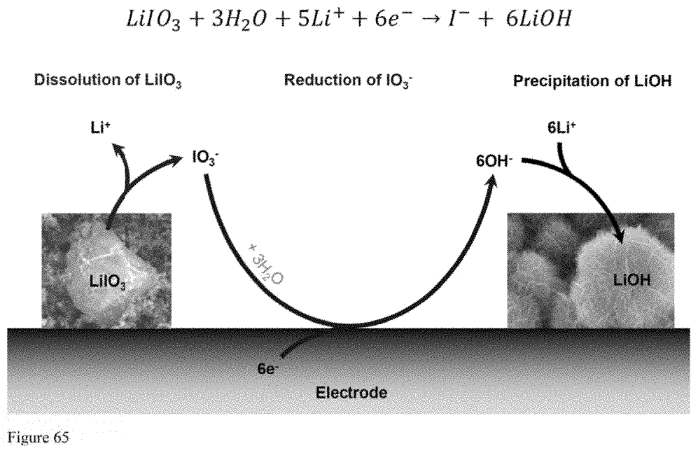

Substantial morphological changes in the electrode were observed with SEM (FIG. 62), suggesting that LiIO₃ and/or LiOH may be soluble in the electrolyte. In order to assess the solubility of LiIO₃ and LiOH in the electrolytes, mixtures of DME, DOL and MeCN with added water were allowed to saturate with LiOH or LiIO₃ under stirring for 3 days. The resulting mixtures were centrifuged and the decanted liquid was assessed using an inductively couple plasma technique to quantify the amount of dissolved lithium (FIG. 63). It was observed that upon the addition of water at 10 v % and 20 v %, both LiOH and LiIO₃ could be solubilized up to ˜10 mM. The high overpotential during the discharge process are believed to stem from mass transport limitations. This hypothesis is supported by a linear trend between the overpotential on discharged (where the thermodynamic potential is 2.97V vs Li⁺/Li) and the logarithm of viscosity divided by the solubility of LiIO₃ in the electrode (FIG. 64). Overall, the titration, SEM and discharge profile results are all consistent with a mechanism which starts with dissolution of LiIO₃, then a 6e⁻ reduction of IO₃⁻ to OH⁻ and I⁻, followed by precipitation of LiOH onto the electrode surface and separator (FIG. 65).

### REFERENCES (EACH OF THE FOLLOWING REFERENCES IS INCORPORATED BY REFERENCE IN ITS ENTIRETY)

1. Aurbach, D., McCloskey, B. D., Nazar, L. F. & Bruce, P. G. Advances in understanding mechanisms underpinning lithium-air batteries. Nat. Energy 1, 16128 (2016).
2. Bruce, P. G., Freunberger, S. A., Hardwick, L. J. & Tarascon, J.-M. Li—O₂ and Li—S batteries with high energy storage. Nat. Mater. 11, 19-29 (2011).
3. Kwabi, D. G. et al. Materials challenges in rechargeable lithium-air batteries. MRS Bull. 39, 443-452 (2014).
4. Lu, Y.-C. et al. Lithium-oxygen batteries: bridging mechanistic understanding and battery performance. Energy Environ. Sci. 6, 750 (2013).
5. Viswanathan, V. et al. Li—O₂ Kinetic Overpotentials: Tafel Plots from Experiment and First-Principles Theory. J. Phys. Chem. Lett. 4, 556-560 (2013).
6. Kwabi, D. G. et al. Experimental and Computational Analysis of the Solvent-Dependent O₂/Li⁺—O₂⁻ Redox Couple: Standard Potentials, Coupling Strength, and Implications for Lithium-Oxygen Batteries. Angew. Chem. Int. Ed. 55, 3129-3134 (2016).
7. Johnson, L. et al. The role of LiO2 solubility in O2 reduction in aprotic solvents and its consequences for Li—O2 batteries. Nat. Chem. 6, 1091-1099 (2014).
8. Sharon, D. et al. Mechanistic Role of Li⁺ Dissociation Level in Aprotic Li—O₂ Battery. ACS Appl. Mater. Interfaces 8, 5300-5307 (2016).
9. Burke, C. M., Pande, V., Khetan, A., Viswanathan, V. & McCloskey, B. D. Enhancing electrochemical intermediate solvation through electrolyte anion selection to increase nonaqueous Li—O₂ battery capacity. Proc. Natl. Acad. Sci. 112, 9293-9298 (2015).
10. Kwabi, D. G. et al. Controlling Solution-Mediated Reaction Mechanisms of Oxygen Reduction Using Potential and Solvent for Aprotic Lithium-Oxygen Batteries. J. Phys. Chem. Lett. 7, 1204-1212 (2016).
11. Mitchell, R. R., Gallant, B. M., Shao-Horn, Y. & Thompson, C. V. Mechanisms of Morphological Evolution of Li₂O₂ Particles during Electrochemical Growth. J. Phys. Chem. Lett. 4, 1060-1064 (2013).
12. McCloskey, B. D. et al. Combining Accurate O2 and Li₂O₂ Assays to Separate Discharge and Charge Stability Limitations in Nonaqueous Li—O₂ Batteries. J. Phys. Chem. Lett. 4, 2989-2993 (2013).
13. Lim, H.-D. et al. Rational design of redox mediators for advanced Li—O₂ batteries. Nat. Energy 1, 16066 (2016).
14. Lim, H.-D. et al. Superior Rechargeability and Efficiency of Lithium-Oxygen Batteries: Hierarchical Air Electrode Architecture Combined with a Soluble Catalyst. Angew. Chem. Int. Ed. 53, 3926-3931 (2014).
15. Liu, T. et al. Cycling Li—O2 batteries via LiOH formation and decomposition. Science 350, 530-533 (2015).
16. Bergner, B. J., Schurmann, A., Peppler, K., Garsuch, A. & Janek, J. TEMPO: A Mobile Catalyst for Rechargeable Li—O2 Batteries. J. Am. Chem. Soc. 136, 15054-15064 (2014).
17. Kwak, W.-J. et al. Li—O₂ cells with LiBr as an electrolyte and a redox mediator. Energy Env. Sci 9, 2334-2345 (2016).
18. Kwak, W.-J. et al. Understanding the behavior of Li-oxygen cells containing LiI. J Mater Chem A 3, 8855-8864 (2015).
19. Chen, Y., Freunberger, S. A., Peng, Z., Fontaine, O. & Bruce, P. G. Charging a Li—O2 battery using a redox mediator. Nat. Chem. 5, 489-494 (2013).
20. Sun, D. et al. A Solution-Phase Bifunctional Catalyst for Lithium-Oxygen Batteries. J. Am. Chem. Soc. 136, 8941-8946 (2014).
21. Feng, N., He, P. & Zhou, H. Enabling Catalytic Oxidation of Li₂O₂ at the Liquid-Solid Interface: The Evolution of an Aprotic Li—O₂ Battery. ChemSusChem 8, 600-602 (2015).
22. Kundu, D., Black, R., Adams, B. & Nazar, L. F. A Highly Active Low Voltage Redox Mediator for Enhanced Rechargeability of Lithium-Oxygen Batteries. ACS Cent. Sci. 1, 510-515 (2015).
23. Torres, W. R., Herrera, S. E., Tesio, A. Y., Pozo, M. del & Calvo, E. J. Soluble TTF catalyst for the oxidation of cathode products in Li—Oxygen battery: A chemical scavenger. Electrochimica Acta 182, 1118-1123 (2015).
24. Wu, S., Tang, J., Li, F., Liu, X. & Zhou, H. Low charge overpotentials in lithium-oxygen batteries based on tetraglyme electrolytes with a limited amount of water. Chem Commun 51, 16860-16863 (2015).
25. Zhu, Y. G. et al. Dual redox catalysts for oxygen reduction and evolution reactions: towards a redox flow Li—O₂ battery. Chem Commun 51, 9451-9454 (2015).
26. Pande, V. & Viswanathan, V. Criteria and Considerations for the Selection of Redox Mediators in Nonaqueous Li—O2 Batteries. ACS Energy Lett. 2, 60-63 (2016).
27. Yao, K. P. C. et al. Utilization of Cobalt Bis(terpyridine) Metal Complex as Soluble Redox Mediator in Li—O₂ Batteries. J. Phys. Chem. C 120, 16290-16297 (2016).
28. Zeng, X. et al. Enhanced Li—O2 battery performance, using graphene-like non-derived carbon as the cathode and adding LiI in the electrolyte as a promoter. Electrochimica Acta 200, 231-238 (2016).
29. Zhang, W. et al. Promoting Li₂O₂ oxidation via solvent-assisted redox shuttle process for low overpotential Li—O2 battery. Nano Energy 30, 43-51 (2016).
30. Zhang, T., Liao, K., He, P. & Zhou, H. A self-defense redox mediator for efficient lithium-O₂ batteries. Energy Env. Sci 9, 1024-1030 (2016).
31. Xu, J.-J. et al. Synthesis of Perovskite-Based Porous La_{0.75}Sr_{0.25} MnO₃ Nanotubes as a Highly Efficient Electrocatalyst for Rechargeable Lithium-Oxygen Batteries. Angew. Chem. Int. Ed. 52, 3887-3890 (2013).
32. Yao, K. P. C. et al. Solid-state activation of Li₂O₂ oxidation kinetics and implications for Li—O₂ batteries. Energy Environ. Sci. 8, 2417-2426 (2015).
33. Yin, Y.-B., Xu, J.-J., Liu, Q.-C. & Zhang, X.-B. Macroporous Interconnected Hollow Carbon Nanofibers Inspired by Golden-Toad Eggs toward a Binder-Free, High-Rate, and Flexible Electrode. Adv. Mater. 28, 7494-7500 (2016).
34. Li, L. & Manthiram, A. O- and N-Doped Carbon Nanowebs as Metal-Free Catalysts for Hybrid Li-Air Batteries. Adv. Energy Mater. 4, 1301795 (2014).
35. Shui, J. et al. Nitrogen-Doped Holey Graphene for High-Performance Rechargeable Li—O₂ Batteries. ACS Energy Lett. 1, 260-265 (2016).
36. Xu, J.-J., Wang, Z.-L., Xu, D., Zhang, L.-L. & Zhang, X.-B. Tailoring deposition and morphology of discharge products towards high-rate and long-life lithium-oxygen batteries. Nat. Commun. 4, (2013).
37. Kwon, H.-M. et al. Effect of Anion in Glyme-based Electrolyte for Li—O₂ Batteries: Stability/Solubility of Discharge Intermediate. Chem. Lett. 46, 573-576 (2017).
38. Wong, R. A. et al. Critically Examining the Role of Nanocatalysts in Li—O₂ Batteries: Viability toward Suppression of Recharge Overpotential, Rechargeability, and Cyclability. ACS Energy Lett. 3, 592-597 (2018).
39. Radin, M. D. & Siegel, D. J. Charge transport in lithium peroxide: relevance for rechargeable metal-air batteries. Energy Environ. Sci. 6, 2370 (2013).
40. Bergner, B. J. et al. Understanding the fundamentals of redox mediators in Li—O₂ batteries: a case study on nitroxides. Phys. Chem. Chem. Phys. 17, 31769-31779 (2015).
41. Bergner, B. J. et al. How To Improve Capacity and Cycling Stability for Next Generation Li—O₂ Batteries: Approach with a Solid Electrolyte and Elevated Redox Mediator Concentrations. ACS Appl. Mater. Interfaces 8, 7756-7765 (2016).
42. Lee, D. J., Lee, H., Kim, Y.-J., Park, J.-K. & Kim, H.-T. Sustainable Redox Mediation for Lithium-Oxygen Batteries by a Composite Protective Layer on the Lithium-Metal Anode. Adv. Mater. 28, 857-863 (2016).
43. Burke, C. M. et al. Implications of 4e⁻ Oxygen Reduction via Iodide Redox Mediation in Li—O₂ Batteries. ACS Energy Lett. 1, 747-756 (2016).
44. Tulodziecki, M. et al. The role of iodide in the formation of lithium hydroxide in lithium-oxygen batteries. Energy Env. Sci (2017). doi:10.1039/C7EE00954B
45. Qiao, Y. et al. Unraveling the Complex Role of Iodide Additives in Li—O₂ Batteries. ACS Energy Lett. 1869-1878 (2017). doi:10.1021/acsenergylett.7b00462
46. Li, Y. et al. Li—O₂ Cell with LiI (3-hydroxypropionitrile)₂ as a Redox Mediator: Insight into the Working Mechanism of I⁻ during Charge in Anhydrous Systems. J. Phys. Chem. Lett. 4218-4225 (2017). doi:10.1021/acs.jpclett.7b01497
47. Zhu, Y. G. et al. Proton enhanced dynamic battery chemistry for aprotic lithium-oxygen batteries. Nat. Commun. 8, 14308 (2017).
48. Kwabi, D. G. et al. The effect of water on discharge product growth and chemistry in Li—O₂ batteries. Phys Chem Chem Phys 18, 24944-24953 (2016).
49. Torres, A. E. & Balbuena, P. B. Exploring the LiOH Formation Reaction Mechanism in Lithium-Air Batteries. Chem. Mater. (2018). doi:10.1021/acs.chemmater.7b04018
50. Viswanathan, V. et al. Comment on ‘Cycling Li—O2 batteries via LiOH formation and decomposition’. Science 352, 667-667 (2016).
51. Shen, Y., Zhang, W., Chou, S.-L. & Dou, S.-X. Comment on ‘Cycling Li—O₂ batteries via LiOH formation and decomposition’. Science 352, 667-667 (2016).
52. Liu, T. et al. Response to Comment on “Cycling Li—O₂ batteries via LiOH formation and decomposition”. Science 352, 667-667 (2016).
53. Bentley, C. L., Bond, A. M., Hollenkamp, A. F., Mahon, P. J. & Zhang, J. Voltammetric Determination of the Iodide/Iodine Formal Potential and Triiodide Stability Constant in Conventional and Ionic Liquid Media. J. Phys. Chem. C 119, 22392-22403 (2015).
54. Nakanishi, A. et al. Electrolyte Composition in Li/O₂ Batteries with LiI Redox Mediators: Solvation Effects on Redox Potentials and Implications for Redox Shuttling. J. Phys. Chem. C (2018). doi:10.1021/acs.jpcc.7b11859
55. Reid, C. & Mulliken, R. S. Molecular compounds and their spectra. IV. The pyridine-iodine System1. J. Am. Chem. Soc. 76, 3869-3874 (1954).
56. Kolthoff, I. M. & Jordan, J. Voltammetry of iodine and iodide at rotated platinum wire electrodes. J. Am. Chem. Soc. 75, 1571-1575 (1953).
57. Grassian, V. H. & Muetterties, E. L. Electron energy loss and thermal desorption spectroscopy of pyridine adsorbed on platinum (111). J. Phys. Chem. 90, 5900-5907 (1986).
58. Black, R. et al. Screening for Superoxide Reactivity in Li—O₂ Batteries: Effect on Li₂O₂/LiOH Crystallization. J. Am. Chem. Soc. 134, 2902-2905 (2012).
59. McCloskey, B. D., Bethune, D. S., Shelby, R. M., Girishkumar, G. & Luntz, A. C. Solvents' Critical Role in Nonaqueous Lithium-Oxygen Battery Electrochemistry. J. Phys. Chem. Lett. 2, 1161-1166 (2011).
60. Harding, J. R. Investigation of oxidation in nonaqueous lithium-air batteries. (Massachusetts Institute of Technology, 2015).
61. Harding, J. R., Amanchukwu, C. V., Hammond, P. T. & Shao-Horn, Y. Instability of Poly(ethylene oxide) upon Oxidation in Lithium-Air Batteries. J. Phys. Chem. C 119, 206947-6955 (2015).
62. Noviandri, I. et al. The Decamethylferrocenium/Decamethylferrocene Redox Couple: A Superior Redox Standard to the Ferrocenium/Ferrocene Redox Couple for Studying Solvent Effects on the Thermodynamics of Electron Transfer. J. Phys. Chem. B 103, 6713-6722 (1999).
63. Matsumoto, M. & Swaddle, T. W. The Decamethylferrocene(+/0) Electrode Reaction in Organic Solvents at Variable Pressure and Temperature. Inorg. Chem. 43, 2724-2735 (2004).
64. Born, M. Volumen und hydratationswarme der ionen. Z. Für Phys. 1, 45-48 (1920).
65. Atkins, P. W. & MacDermott, A. J. The Born equation and ionic solvation. J. Chem Educ 59, 359 (1982).
66. ADAMSON, A. W. Physical Chemistry of Surfaces. 12
67. Gallant, B. M. et al. Influence of Li2O2 morphology on oxygen reduction and evolution kinetics in Li—O2 batteries. Energy Environ. Sci. 6, 2518 (2013).
68. Sharon, D. et al. Oxidation of Dimethyl Sulfoxide Solutions by Electrochemical Reduction of Oxygen. J. Phys. Chem. Lett. 4, 3115-3119 (2013).
69. Kwabi, D. G. et al. Chemical Instability of Dimethyl Sulfoxide in Lithium-Air Batteries. J. Phys. Chem. Lett. 5, 2850-2856 (2014).
70. Schutte, L., Kluit, P. P. & Havinga, E. The substitution reaction of histidine and some other imidazole derivatives with iodine. Tetrahedron 22, 295-306 (1966).
71. Gerritsen, C. M., Gazda, M. & Margerum, D. W. Non-metal redox kinetics: hypobromite and hypoiodite reactions with cyanide and the hydrolysis of cyanogen halides. Inorg. Chem. 32, 5739-5748 (1993).
72. Lengyel, I., Epstein, I. R. & Kustin, K. Kinetics of iodine hydrolysis. Inorg. Chem. 32, 5880-5882 (1993).
73. Xie, Y., McDonald, M. R. & Margerum, D. W. Mechanism of the Reaction between Iodate and Iodide Ions in Acid Solutions (Dushman Reaction). Inorg. Chem. 38, 3938-3940 (1999).
74. Wren, J. C., Paquette, J., Sunder, S. & Ford, B. L. Iodine chemistry in the +1 oxidation state. II. A Raman and uv-visible spectroscopic study of the disproportionation of hypoiodite in basic solutions. Can. J. Chem. 64, 2284-2296 (1986).
75. Liu, T. et al. Understanding LiOH Chemistry in a Ruthenium Catalyzed Li—O2 Battery. Angew. Chem. Int. Ed. (2017). doi: 10.1002/anie.201709886
76. Huang, C., Kristoffersen, H. H., Gong, X.-Q. & Metiu, H. Reactions of Molten LiI with I₂, H₂O, and O₂ Relevant to Halogen-Mediated Oxidative Dehydrogenation of Alkanes. J. Phys. Chem. C 120, 4931-4936 (2016).
77. Lide, D. R. CRC Handbook of Chemistry and Physics.
   Derivation of the Role of Solvation Energy on Li₂O₂ Oxidation by I₃⁻: For the reaction:

Li₂O₂+I₃⁻→2Li⁺+3I⁻+O₂

Using the same approach as Kwabi et al²:

ΔGᵣₓₙ=2Δ_{f}G⁰_{Li}_{⁺}+Δ_{f}G⁰_{O}_{₂}+3Δ_{f}G⁰_{I}_{^{−}}−Δ_{f}G⁰_{Li}_{₂}_{O}_{₂}−Δ_{f}G_{I}_{₃}_{^{−}}+2ΔG_{Li}_{⁺}^{solv}+ΔG_{O}_{₂}^{solv}+3ΔG_{I}_{^{−}}^{solv}−ΔG_{I}_{₃}_{^{−}}^{solv}

Assuming ΔG⁰_{O}_{₂}^{solv}≈0 and collecting all formation energy terms as Δ_{f}G⁰ᵣₓₙ:

ΔGᵣₓₙ=Δ_{f}G⁰ᵣₓₙ+2ΔG_{Li}_{⁺}^{solv}+3ΔG_{I}_{^{−}}^{solv}−ΔG_{I}_{₃}_{^{−}}^{solv}

### Approximation of LiIO₃ Formation Energy

From Huang et al³, the following reaction:

LiI+3/2O₂→LiIO₃

Has a reaction enthalpy of −3.0 eV. From Lide⁴, the S⁰ of KIO₃ is 1.57 meV/° K and the Δ_{f}G⁰ of LiI is −2.80 eV. Based on approximating the S° of LiIO₃ to be the same as KIO₃, at 298.15° K, the Δ_{f}G⁰ of LiIO₃ is calculated to be −5.05 eV.

### Discussion of Polyiodide Species

While shifts in thermodynamics caused by changes in Li⁺ and I⁻ solvation energy provide a clear explanation as to why the ability of I₃⁻ species to chemically oxidize Li₂O₂ can change with solvent, the dissociation of I₃⁻ into I₂ species given by equilibrium (5), is also solvent dependent⁵ and must also be considered.

In addition to this equilibrium, there also exists higher order polyiodide species such as pentaiodide (I₅⁻) and heptaiodide (I₇⁻) that exist in other equilibriums caused by the association of I₂ to Iₓ⁻ (x=1, 3, 5)⁶⁻⁸:

I₅⁻ [symbol] I₂+I₃⁻ (1)

I₇⁻ [symbol] I₂+I₅⁻

To further complicate matters, iodine-solvent complexes can also cause the dissociation of I₂ into I⁻ and I⁺ leading to further still equilibria to consider⁹:

I₂ [symbol] Solvent·I⁺+I⁻ (3)

where the I⁻ formed from this dissociation would then associate with another I₂ to form I₃⁻ via reaction (5). The existence of these chemical equilibria considerably complicates the interpretation of reactions involving oxidized forms of iodide, as a large number of different species can be present in the solution at any given time. This begs the question; which polyiodide species are responsible for the observed oxidation of Li₂O₂?

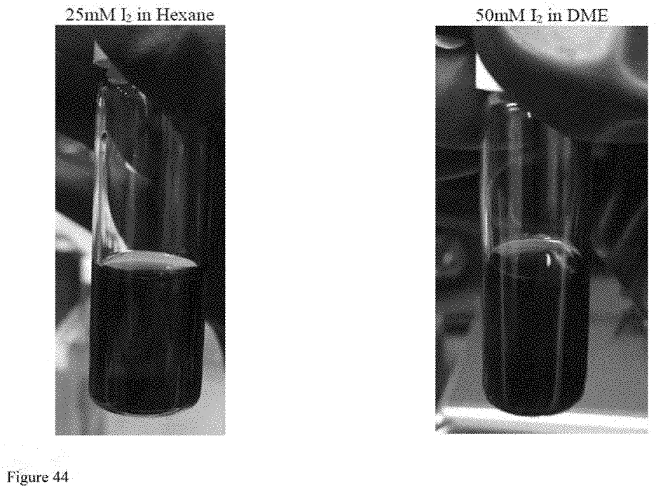

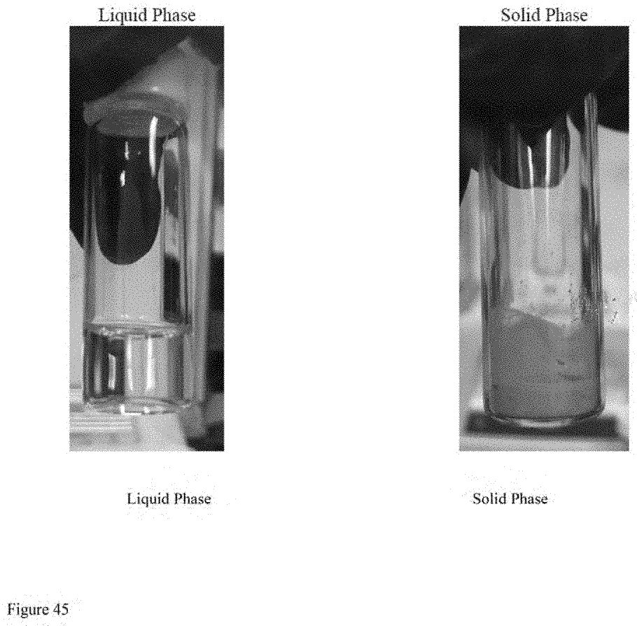

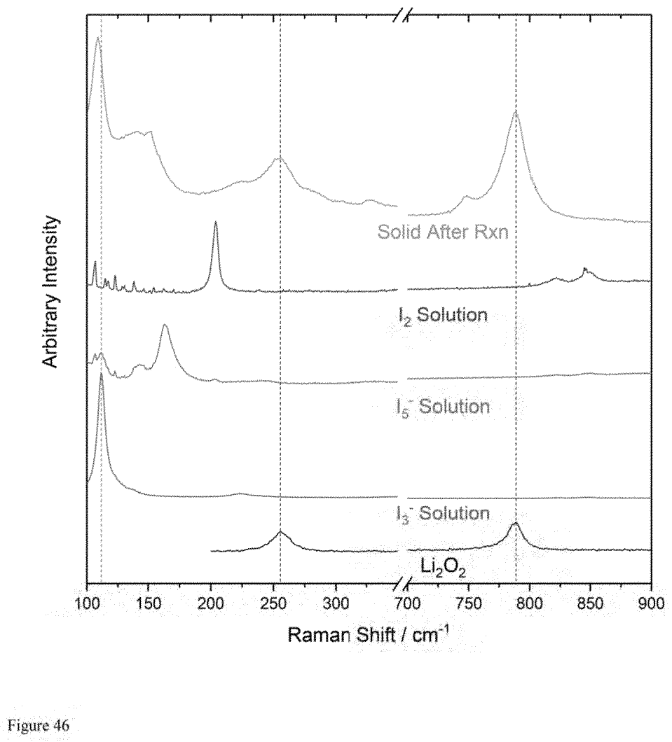

In order to examine the possible role of highly oxidizing I⁺ species, the reaction between Li₂O₂ and 12 in hexane (a solvent which does not support the formation of Solvent-I⁺ complexes as indicated by its purple color in FIG. 44) was conducted. After reacting with commercial Li₂O₂, the originally purple 50 mM I₂ hexane solution became clear and an orange/brown solid remained (FIG. 45). Raman spectroscopy on this solid reveals Li₂O₂, in addition to peaks consistent with LiI₃ (FIG. 46). While stable triiodide salts can be formed with larger cations, such as Cesium¹⁰, such complexes are not typically stable with Li⁺. However, due to hexane's very low solubility for most salts¹¹, the I₃⁻ remaining after the reaction of I₂ with Li₂O₂ is likely more stable as a solid precipitate than in solution. Over time, this precipitate was found to lose its color, which would be consistent with the sublimation of I₂ gas and formation of LiI. Since I₂ is able to react with Li₂O₂ in hexane, we can conclude that the formation of I⁺ is not necessary for the oxidation of Li₂O₂.

The equilibria between I₂, I₃⁻ and higher order polyiodide species cannot be untangled as effectively as there isn't an equivalent model solvent which eliminates these equilibria. Experiments were performed using solutions of 50 mM 12, I₅⁻ (50 mM I₂+25 mM LiI) and I₃⁻ (50 mM I₂+0.2M LiI) in DME and both commercial Li₂O₂ and Li₂O₂ formed through disproportionation (see FIG. 27). In all cases, the reaction with commercial Li₂O₂ was observed to stop once the reaction proceeded enough such that the solution contained 50 mM Iₓ (within experimental error). Raman spectra on the solution before and after the reaction (FIG. 28) indicated that while initially, the dominant species were I₂, I₅⁻ and I₃⁻, respectively, following the reaction, only the signal from I₃⁻ was visible in all solutions. Despite these results which suggest that some polyiodide species, like I₅⁻, may be reactive with Li₂O₂, we note that these experiments do not clarify whether the reaction proceeds directly from I₅⁻, or whether I₅⁻ first dissociates to I₂ via reaction (1) and then the formed I₂ reacts with Li₂O₂. In fact, the dissociation equilibria responsible for the formation of a more oxidizing and less oxidizing species (for example I₃⁻ dissociates to the more oxidizing I₂ and I⁻), are actually unequivocally linked to the oxidizing power of the associated complex. Considering I₃⁻, we recall from above that the increased solvation energy of I⁻ ions increases the potential of the I⁻/I₃⁻ redox transition vs Me₁₀Fc. However, the dissociation of I₃⁻ into I₂ and I⁻ will also be promoted by stronger solvation of I⁻. Furthermore, since this dissociation is in equilibrium, the thermodynamic driving force for the oxidation of Li₂O₂ by either I₃⁻ or the I₂ formed from dissociation will be identical due to Nemstian shifts associated with the I₂, I₃⁻ and I⁻ concentrations present in this equilibrium. We therefore suggest that the distinction between the various polyiodide species which exist in all of the existing equilibria in solution is only relevant in discussion of reaction kinetics (and even here may not prove important unless the dissociation step is rate limiting) and that whether a reaction will occur or not is governed simply by the thermodynamic driving force for the reaction between Li₂O₂ and any of the polyiodide species which are in equilibria, which can be effectively understood with the framework presented above.

### REFERENCES (EACH OF THE FOLLOWING REFERENCES IS INCORPORATED BY REFERENCE IN ITS ENTIRETY)

1. Burke, C. M. et al. Implications of 4e⁻ Oxygen Reduction via Iodide Redox Mediation in Li—O₂ Batteries. ACS Energy Lett. 1, 747-756 (2016).
2. Kwabi, D. G. et al. Experimental and Computational Analysis of the Solvent-Dependent O₂/Li⁺—O₂⁻ Redox Couple: Standard Potentials, Coupling Strength, and
Implications for Lithium-Oxygen Batteries. Angew. Chem. Int. Ed. 55, 3129-3134 (2016).
3. Huang, C., Kristoffersen, H. H., Gong, X.-Q. & Metiu, H. Reactions of Molten LiI with I₂, H₂O, and O₂ Relevant to Halogen-Mediated Oxidative Dehydrogenation of Alkanes. J. Phys. Chem. C 120, 4931-4936 (2016).
4. Lide, D. R. CRC Handbook of Chemistry and Physics.
5. Bentley, C. L., Bond, A. M., Hollenkamp, A. F., Mahon, P. J. & Zhang, J. Voltammetric Determination of the Iodide/Iodine Formal Potential and Triiodide Stability Constant in Conventional and Ionic Liquid Media. J. Phys. Chem. C 119, 22392-22403 (2015).
6. Popov, A. I., Rygg, R. H. & Skelly, N. E. Studies on the Chemistry of Halogens and of Polyhalides. IX. Electrical Conductance Study of Higher Polyiodide Complex Ions in Acetonitrile Solutions^{1,2.} J. Am. Chem. Soc. 78, 5740-5744 (1956).
7. Parrett, F. W. & Taylor, N. J. Spectroscopic studies on some polyhalide ions. J. Inorg. Nucl. Chem. 32, 2458-2461 (1970).
8. Svensson, P. H. & Kloo, L. Synthesis, Structure, and Bonding in Polyiodide and Metal Iodide-Iodine Systems. Chem. Rev. 103, 1649-1684 (2003).
9. Palomares, E., Clifford, J. N., Haque, S. A., Lutz, T. & Durrant, J. R. Control of charge recombination dynamics in dye sensitized solar cells by the use of conformally deposited metal oxide blocking layers. J. Am. Chem. Soc. 125, 475-482 (2003).
10. Li, Y. et al. Li—O₂ Cell with LiI (3-hydroxypropionitrile)₂ as a Redox Mediator: Insight into the Working Mechanism of I⁻ during Charge in Anhydrous Systems. J. Phys. Chem. Lett. 4218-4225 (2017). doi:10.1021/acs.jpclett.7b01497
11. Markus von Pilgrim, Mihail Mondeshki & Jan Klett. [Bis(Trimethylsilyl)Methyl]Lithium and -Sodium: Solubility in Alkanes and Complexes with O- and N-Donor Ligands. Inorganics 5, 39 (2017).

Other embodiments are within the scope of the following claims.

1. An electrode comprising a halogen oxyanion salt and a conductive material.

2. The electrode of claim 1, wherein the halogen is chlorine, bromine or iodine.

3. The electrode of claim 1, wherein the halogen is iodine.

4. The electrode of claim 1, wherein the halogen oxyanion salt is an alkali metal salt.

5. The electrode of claim 4, wherein the alkali metal salt is a lithium salt, a sodium salt or a potassium salt.

6. The electrode of claim 1, wherein the halogen oxyanion salt is a lithium iodate, a sodium iodate or a potassium iodate.

7. The electrode of claim 1, wherein the halogen oxyanion salt is formed by oxidation of a metal hydroxide salt in the presence of a halogen or halide.

8. The electrode of claim 1, wherein the conductive material is a conductive carbon material.

9. The electrode of claim 1, wherein the conductive carbon material includes carbon black, graphene, carbon nanotubes, or graphite.

10. The electrode of claim 1, wherein the halogen oxyanion is lithium iodate.

11. A battery comprising:
a metal electrode;
a halogen oxyanion electrode; and
a separator between the metal electrode and the halogen oxyanion electrode.

12. The battery of claim 11, wherein the halogen oxyanion electrode includes a halogen oxyanion salt and a conductive material.

13. The battery of claim 11, wherein the halogen is chlorine, bromine or iodine.

14. The battery of claim 11, wherein the halogen is iodine.

15. The battery of claim 11, wherein the halogen oxyanion salt is an alkali metal salt.

16. The battery of claim 15, wherein the alkali metal salt is a lithium salt, a sodium salt or a potassium salt.

17. The battery of claim 11, wherein the halogen oxyanion salt is a lithium iodate, a sodium iodate or a potassium iodate.

18. The battery of claim 11, wherein the halogen oxyanion salt is formed by oxidation of a metal hydroxide salt in the presence of a halogen or halide.

19. The battery of claim 11, wherein the conductive material is a conductive carbon material.

20. The battery of claim 19, wherein the conductive carbon material includes carbon black, graphene, carbon nanotubes, or graphite.

21. The battery of claim 11, wherein the halogen oxyanion electrode further comprises a binder.

22. The battery of claim 11, wherein the halogen oxyanion is lithium iodate.

23. The battery of claim 11, wherein the metal electrode includes an alkali metal or metal ion negative electrode.

24. The battery of claim 23, wherein the alkali metal includes lithium, sodium or potassium.

25. A method of generating electricity, comprising:
creating an electronic connection to a battery of claim 11.

26. The electrode of claim 8, wherein the metal electrode includes an alkali metal or metal ion negative electrode.
